(19) United States
(12) Patent Application Publication
(10) Pub. No.: US 2019/0002787 A1
(43) Pub. Date: Jan. 3, 2019

(54) HYPER-BRANCHED MACROMOLECULAR ARCHITECTURES AND METHODS OF USE

(71) Applicant: The Regents of the University of California, Oakland, CA (US)

(72) Inventors: Bas van Ravensteijn, Goleta, CA (US); Raghida Bou Zerdan, Goleta, CA (US); Watanabe Takumi, Tokyo (JP); Dongjin Seo, Goleta, CA (US); Nicholas Cadirov, Goleta, CA (US); Jeffrey Gerbec, Oxnard, CA (US); Craig J. Hawker, Santa Barbara, CA (US); Jacob Israelachvili, Santa Barbara, CA (US); Matthew E. Helgeson, Santa Barbara, CA (US)

(73) Assignee: The Regents of the University of California, Oakland, CA (US)

(21) Appl. No.: 16/025,741

(22) Filed: Jul. 2, 2018

Related U.S. Application Data
(60) Provisional application No. 62/527,543, filed on Jun. 30, 2017.

(51) Int. Cl. C10M 155/02; C08G 83/00; C10M 169/04; C10M 101/02

(52) U.S. Cl. CPC C10M 155/02; C08G 83/006; C10M 169/04; C10N 2230/06; C10M 2203/1006; C10M 2229/046; C10N 2230/02; C10M 101/02

(57) ABSTRACT

Disclosed herein are star-shaped macromolecular structures comprising a hyper-branched silicon containing core grafted with a well-defined and controllable number of alkyl (methyl)acrylate (co)polymer arms. The presence of the robust inorganic core provides additional resilience against mechanical degradation and therefore enhanced additive life time. Control over the additive architecture was complemented by tunability of the length of the grafted polymers by making use of controlled radical based polymerization techniques. The performance of these novel inorganic-organic star-shaped hybrids were compared to traditional fully organic lubricant additives. Detailed analysis revealed the multi-functional character of the hybrids by simultaneously performing as bulk viscosity modifiers, boundary lubricant, and wear protectants while being dispersed in a commercially available base oil for automotive lubrication purposes.

### CROSS REFERENCE TO RELATED APPLICATIONS

This application claims the benefit under 35 U.S.C. Section 119(e) of the following co-pending and commonly-assigned U.S. Provisional Patent Application No. 62/527,543, filed Jun. 30, 2017, by Bas van Ravensteijn, Dongjin Seo, Raghida Bou Zerdan, Matthew E. Helgeson, Nicholas Cadirov, Jeffrey Gerbec, Jacob Israelachvili, Craig J. Hawker, entitled “HYPER-BRANCHED MACROMOLECULAR ARCHITECTURES AND METHODS OF USE,” Attorney's Docket No. 30794.650-US-P1 (2016-316);

which application is incorporated by reference herein.

### BACKGROUND OF THE INVENTION

### 1. Field of the Invention

The present invention relates to a method of producing star-shaped polymeric architectures having hyper-branched silicon containing cores as multifunctional lubricant additives that perform as bulk viscosity improver, friction reducer, and wear protectant simultaneously.

### 2. Description of the Related Art

(Note: This application references a number of different publications as indicated throughout the specification by one or more reference numbers in brackets, e.g., [x]. A list of these different publications ordered according to these reference numbers can be found below in the section entitled “References.” Each of these publications is incorporated by reference herein.)

Lubricants play a pivotal role in enhancing the durability and efficiency of automotive engines and industrial machinery. Commercial, fully formulated lubricants employed in automotive (engine) environments are highly complex fluids composed of a base oil containing a variety of additives including, anti-wear agents, friction reducers, antioxidants, detergents, pour point depressants and viscosity improvers. [1-4] To enhance oil performance, longevity and meeting ever-rising industrial and environmental demands regarding fuel consumption and pollution reduction, development of improved viscosity modifiers and boundary lubricants has attracted significant industrial and academic attention. [1-4]

Viscosity improving additives are required to decrease the temperature dependence of the viscosity of pure base oils, commonly referred to as the ‘natural thinning effect’. [2, 5-7] These polymeric additives safeguard sufficient load bearing characteristics of the formulated lubricant at elevated operating temperatures. In the ideal case, the polymers are designed such that the increase in viscosity is not significant at low temperatures, which facilitates cold start-up procedures. The mechanisms by which polymers modulate the temperature dependence of the viscosity varies between different classes of viscosity improving polymers. Nevertheless, a vast body of literature suggests that the most efficient (polymethacrylate-based) viscosity improving additives rely on a reversible, temperature-induced chain expansion, where the expanded chains contribute significantly more to the solution viscosity compared to their collapsed state analogues at low temperatures. [2, 7-10]. Linear polymeric chains are theoretically the most efficient viscosity improving additives since these macromolecules are topologically unconstrained allowing for the most pronounced dimensional differences between the collapsed and expanded states. However, in typical application environments, these polymers are subjected to high shear conditions (10⁵−10⁶ s⁻¹), leading to flow-induced chain stretching and even irreversible scission. [11, 12] Since viscosity modifiers rely on their coil volume and hence molecular weight for their performance, irreversible chain scission is detrimental. To increase the resilience against shear-induced degradation, polymers with a branched architecture are preferred. The viability of this strategy has been verified both experimentally and by simulation studies, where polymers with varying architectures (linear, star, ring, H-, and comb-shaped) were subjected to high shear conditions. [11, 13-16] Although the presence of branch points enhances mechanical stability, they also introduce conformational constraints on the swelling behavior. The viscosity improving performance of a given additive is, therefore, a trade-off between thickening efficiency and resilience against mechanical degradation or additive lifetime.

In contrast to the macromolecular structures used in bulk viscosity modification, state-of-the-art boundary lubricants are organo-metallic compounds including, zinc dialkyldithiophosphates (ZDDP) and molybdenum dithiocarbamate (MoDTC) or molybdenum dithiophosphate (MoDTP). [17-19] ZDDP is known to react with metal surfaces to form thin protective coatings, suppressing surface wear. The molybdenum compounds efficiently reduce friction by forming molybdenum sulfide (MoS₂) sheets under shear. Despite their excellent performance, these additives are associated with adverse environmental side effects, e.g., elevated sulfur emissions and damaging the active catalytic species in automotive exhaust gas filtering systems.

Although bulk and boundary lubricants are traditionally different classes of materials, there has been a push toward multi-functional additives to address previously mentioned environmental issues and to decrease the complexity of lubricant formulations. [21, 22] Previously, it has been reported that (star) polymers are able to form highly viscous boundary films when confined and sheared between two solids. [23, 24] As a result of attractive surface forces between the polymer and the solid surface, these films could contribute positively to the surface protection since the formed polymer layer prevents hard contact between the two shearing solid surfaces. In addition to surface protection, the adsorbed polymers may also aid in friction reduction, wherein, the effect of polymer topology plays a crucial role as well. At comparable molecular weights, distributing the monomer in a branched structure lowers the tendency toward chain entanglement in the absorbed film. In the absence of any chain entanglement, ordering in the polymeric layer is suppressed, and the freely moving polymer arms or branches behave as molecular brushes, impeding frictional losses. [24, 25] Therefore, by employing star-shaped polymers having defined molecular weights and dimensions, lubricity enhancement and surface protective properties can be expected.

Based on these considerations, Cosimbescu et al. recently developed polymeric additives combining bulk viscosity improvement with friction reducing properties. The (hyper-) branched structures based on poly(alkyl methacrylate) and poly(ethylene) chemistries were evaluated, and the authors suggested the beneficial effect of branched architecture for (boundary) lubrication purposes. [16, 21, 22, 27].

### SUMMARY OF THE INVENTION

The present disclosure describes the synthesis of hybrid macromolecular architectures comprised of silicon-containing hyper-branched inorganic cores functionalized with polymeric brushes. Functionalization of the inorganic core is achieved via highly scalable and reproducible techniques, e.g., living radical polymerization (LRP) and hydrosilylation reactions. Leveraging the hallmarks of controlled polymerization enabled the synthesis of macromolecular structures with tunable arm chemistry, arm length, architecture, and grafting density while maintaining the nature of the inorganic core constant. The synthesized additives were screened for their performance as lubricant additives in commercial base oils, with a primary focus on Yubase 4. Macromolecular structures based on statistical copolymers of stearyl methacrylate (SMA) and methyl methacrylate (MMA) were found to be the most promising candidates. Based on this chemistry and benefitting from architectural control of the developed synthetic strategies, a topological library of lubricant additives, including the aforementioned hybrid star-shaped polymers, organic stars, and linear polymers was prepared. Structure-performance relations for bulk viscosity improvement, friction reduction, and were protections were assessed by a combination of high-speed surface force apparatus (HS-SFA) experiments, wear track profilometry, quartz crystal microbalance (QCM) analysis, and viscometry/rheology, and neutron/light scattering experiments (DLS, SANS). The SFA high-speed attachment provided a unique experimental environment to measure the boundary lubrication performance under extreme shear rates (≈10⁷ s⁻¹) for prolonged times (24 h). Smooth steel specimens were used to eliminate the non-trivial effect of surface roughness when measuring the friction coefficient.

The performance of the additives as boundary lubricants and wear protectants was found to increase with increasing degree of branching and was highest for the star polymers carrying the silicon containing inorganic core. This enhanced performance compared to conventional additives was found to be related to a thicker absorbed boundary layer that behaves like a polymer brush. Furthermore, the branched architectures prohibited the ordering of the additives in thin films under high load conditions, enhancing the film fluidity and therefore lubricity.

Besides being efficient boundary lubricants, the (hybrid) star polymers also qualified as bulk viscosity modifiers, reflected by a significant increase in the viscosity index (VI) compared to the commercial base oil. Underlying this increase in VI is a reversible temperature-induced coil expansion, which was identified using temperature-dependent viscosmetry, SANS, and DLS measurements. Although outperformed by linear polymers for bulk viscosity improvement, three distinct lubricant additive functions, namely friction reduction, wear protection, and bulk viscosity improvement, were successfully combined in a single polymeric architecture. The mechanical resilience of the synthesized additives was assessed using high-shear homogenization experiments. The star-shaped additives showed superior performance compared to the unbranched polymers, indicative for a prolonged life-time of these multi-functional lubricant additives. Therefore, the organic-inorganic hybrid materials present a unique class of macromolecular architectures that minimizes future lubricant formulation complexity by surprisingly and unexpectedly unifying multiple functions within one polymeric additive.

Thus, to overcome the limitations in the art described above, and to overcome other limitations that will become apparent upon reading and understanding this specification, the present disclosure describes a star-shaped polymer comprising polymer chains grafted to or from an organic or inorganic core (e.g., a densely cross-linked silicon-containing hyper-branched core, e.g., comprising a silicate functionalized with one or more organic groups).

The star shaped polymer can be embodied in many ways including, but not limited to the following.
1. In a first example, the core comprises an inorganic core (e.g., silicon).
2. In a second example, the core comprises an organic core.
3. In a third example, the composition of example 1 or 2 includes the polymer chains each comprising at least one compound selected from an acrylate and/or a methacrylate.
4. In a fourth example, the composition of examples 1, 2, or 3 has 4-16 (e.g., 6-12) polymer chains.
5. In a fifth example, the composition of examples 1, 2, 3, or 4 includes polymer chains each having between 25-200 monomer units.
6. In a sixth example, the monomer unit of example 5 includes an acrylate or a methacrylate.
7. In a seventh example, the composition of examples 1, 2, 3, 4, 5, or 6 includes the polymer chains wherein each polymer chain is a copolymer.
8. In an eighth example, the copolymer in example 7 comprises a first alkyl acrylate or alkyl methacrylate having a first pendant C8-C18 alkyl chain bonded to a second alkyl acrylate or alkyl methacrylate having a second pendant C1-C4 alkyl chain.
9. In a ninth example, the copolymer in example 7 comprises a first alkyl acrylate or alkyl methacrylate having a first pendant C8-C12 alkyl chain bonded to a second alkyl acrylate or alkyl methacrylate having a second pendant C1-C4 alkyl chain.
10. In a tenth example, the polymer chains of examples 1, 2, 3, 4, 5, or 6 are each a homopolymer.
11. In an eleventh example, the homopolymer of the tenth example comprises an alkyl acrylate having a pendant C8-C18 alkyl chain.

The composition of matter can be included in a lubricant. In one example, the lubricant comprises the composition of matter of embodiments 7, 8, or 9 combined with a lubricant oil (e.g., Yubase 4). In one or more examples, the lubricant comprises between 1-3 wt % of the composition of matter of embodiments 7, 8, or 9 is combined with the lubricant oil (e.g., Yubase 4).

In another example, the lubricant comprises the composition of matter of embodiments 10 or 11 combined with a lubricant oil (e.g., Nexbase 3043).

In yet another example, the lubricant is petroleum derived, the composition of matter forms coils.

In yet another embodiment, the composition of matter (e.g., comprising p(SMA-co-MMA)) behaves/performs simultaneously as a bulk viscosity modifier, a friction reducer, and a wear protectant.

A method of making the composition of matter is also disclosed, comprising grafting polymer chains to or from a polymer core comprising an organic core or a densely cross-linked silicon-containing hyper-branched core. In one or more examples, the polymer chains each have an arm length and the method comprises efficiently controlling a ratio of the arm length with respect to a size of the core. In one or more further examples, the polymer chains are attached to the core at arm attachment points and the method comprises controlling or tuning a density of the arm attachment points depending on a composition of the core.

In one or more examples, the core comprises at least one material selected from —H, vinyl, and OMe on its surface.

### BRIEF DESCRIPTION OF THE DRAWINGS

Referring now to the drawings in which like reference numbers represent corresponding parts throughout:

FIG. 1. General scheme for grafting (co)polymers from the inorganic and the organic cores by controlled radical polymerizations: ruthenium-catalyzed atom transfer radical polymerization (ATRP) for alkyl methacrylates, Cu(0)-mediated controlled radical polymerization mainly for alkyl acrylates, and traditional ATRP for both alkyl acrylates and alkyl methacrylates.

FIGS. 2a-2c. General synthetic strategies for grafting polymers to: FIG. 2a: the silane-terminated inorganic core by [Pt]-catalyzed hydrosilylation or B(C₆F₅)₃-catalyzed condensation; FIG. 2b: the vinyl-terminated inorganic core by thiol-ene chemistry and [Pt]-catalyzed hydrosilylation; FIG. 2c: the methoxy-terminated inorganic core by B(C₆F₅)₃-catalyzed condensation.

FIG. 3. Photocatalyzed thiol-ene chemistry of the vinyl-terminated inorganic core with three different alkyl thiols, HS—C₆H₁₃, HS—C₁₂H₂₅, and HS—C₁₈H₃₇, using DMPAP as a photo-initiator; size exclusion chromatograms (SEC) obtained for the starting material and the corresponding products in chloroform with polystyrene standards.

FIG. 4. Synthesis of cross-linked inorganic cores, star polymers, and cross-linked star polymers by photocatalyzed thiol-ene chemistry with 1,10-decanedithiol, 1-hexylthiol, and the combination of the two, respectively, using DMPAP as a photo-initiator; size exclusion chromatograms (SEC) obtained for the starting material and the corresponding products in chloroform with polystyrene standards.

FIG. 5. Synthesis of alkene-terminated poly(lauryl acrylate) p(LA) (DPₙ=8 and 20) by Cu(0)-mediated controlled radical polymerization, followed by grafting to the silane-terminated silicon-containing hyperbranched core; size exclusion chromatograms (SEC) obtained before and after grafting in chloroform with polystyrene standards.

FIG. 6. Grafting polydimethylsiloxane to the methoxy-terminated inorganic core via the B(C₆F₅)₃-catalyzed condensation; size exclusion chromatograms (SEC) obtained before and after grafting in chloroform with polystyrene standards.

FIG. 7. Synthetic strategies followed to prepare inorganic and organic-based star initiators.

FIGS. 8a-8e. FIG. 8a: Grafting poly(tert-butyl acrylate) p(TBA) polymers from the 9-arms star-initiator, synthesized by [Pt]-catalyzed hydrosilylation, by traditional ATRP; FIG. 8b: FT-IR of the silane-terminated inorganic core (top) and its corresponding inorganic star-initiator (bottom); FIG. 8c: size exclusion chromatograms (SEC) of the silane-terminated inorganic core, its corresponding inorganic star-initiator, and the IC₉-p(TBA) star-polymer obtained in chloroform with polystyrene standards; FIG. 8d: monomer conversion and polydispersity index (PDI) as function of the polymerization time; Size exclusion chromatograms as a function of reaction time for the polymerization of TBA using IC₉-Br as initiator in acetone; FIG. 8e: ¹H NMR spectra of the silane-terminated inorganic core, its corresponding inorganic star-initiator, and the IC₉-p(TBA) star-polymer obtained in CDCl₃.

FIG. 9. Synthesis of star polymers with homopolymer arms by grafting different alkyl (meth)acrylates: lauryl methacrylate (LMA), lauryl acrylate (LA), tent-butyl acrylate (TBA), 2-ethylhexyl acrylate (2-EHA), from the inorganic core using Cu(0)-mediated controlled radical polymerization; size exclusion chromatograms (SEC) of the corresponding hybrid inorganic-organic stars obtained in chloroform with polystyrene standards.

FIG. 10. Grafting copolymers from the inorganic core comprised of acrylates, methacrylates, and the combination of both using Cu(0)-mediated CRP; size exclusion chromatograms (SEC) of the corresponding hybrid inorganic-organic stars obtained in chloroform with polystyrene standards.

FIG. 11. Grafting poly(alkyl methacrylates) homopolymers from the inorganic core by ruthenium-mediated controlled radical polymerization in toluene; size exclusion chromatograms (SEC) of the corresponding hybrid stars obtained in chloroform with polystyrene standards.

FIG. 12. Grafting poly(lauryl acrylate) p(LA) homopolymers of different degree of polymerization (DPₙ=25, 50, and 100) from the inorganic core using the Cu(0)-mediated controlled radical polymerization; size exclusion chromatograms (SEC) of the corresponding hybrid stars obtained in chloroform with polystyrene standards.

FIG. 13. Grafting poly(lauryl methacrylate) p(LA) homopolymers of different degree of polymerization (DPₙ=25, 50, and 100) from the inorganic core using the ruthenium-mediated controlled radical polymerization; size exclusion chromatograms (SEC) of the corresponding hybrid stars obtained in chloroform with polystyrene standards.

FIG. 14. Grafting poly(stearyl methacrylate-co-methyl methacrylate) p(SMA-co-MMA) copolymers of different degree of polymerization (DPₙ=50, 100, and 200) from the inorganic core using the ruthenium-mediated controlled radical polymerization; size exclusion chromatograms (SEC) of the corresponding hybrid stars obtained in chloroform with polystyrene standards.

FIG. 15. Grafting poly(stearyl methacrylate-co-methyl methacrylate) p(SMA-co-MMA) copolymers of different degree of polymerization (DPₙ=50, 100, and 200) from the organic core using the ruthenium-mediated controlled radical polymerization; size exclusion chromatograms (SEC) of the corresponding hybrid stars obtained in chloroform with polystyrene standards.

FIG. 16. General strategies for the synthesis of cross-linked star-polymers with alkyl methacrylate arms by ruthenium-mediated controlled radical polymerization or alkyl acrylate arms by Cu(0)-mediated controlled radical polymerization.

FIG. 17. Synthesis of cross-linked star-polymers with poly(stearyl methacrylate-co-methyl methacrylate) p(SMA-co-MMA) arms by ruthenium-mediated controlled radical polymerization at different concentrations. 1,6-hexanediol dimethacrylate was employed as bi-functional cross-linker; size exclusion chromatograms (SEC) of the corresponding cross-linked hybrid stars obtained in chloroform with polystyrene standards.

FIG. 18. Synthesis of cross-linked star-polymers with poly(lauryl acrylate) p(LA) arms by Cu(0)-mediated controlled radical polymerization with different equivalents of cross-linker (ethylene glycol diacrylate); size exclusion chromatograms (SEC) of the corresponding cross-linked hybrid stars obtained in chloroform with polystyrene standards.

FIG. 19. Schematic overview of synthesized poly(stearyl methacrylate-co-methyl methacrylate) p(SMA-co-MMA) based additives by ruthenium-catalyzed Atom Transfer Radical Polymerization (Ru-ATRP) of methyl methacrylate (MMA) and stearyl methacrylate (SMA) to generate well-defined lubricant additives with linear or star-shaped topologies. In addition to the organic stars with 8 arms (0C-Stars) and hybrid organic-inorganic stars carrying an average of 6 (IC-Star₆) and 9 (IC-Star₉) arms, cross-linked hybrid stars (Oligo-star9) were prepared by adding minuscule amounts of 1,6-hexanediol dimethacrylate into the reaction mixture during polymerization.

FIGS. 20a-20c. FIG. 20a: The dynamic viscosity (η_{dyn}) measured for Yubase 4 containing 0.5-3 wt % of MB-7980 benchmark additive as function of temperature; FIG. 20b: Huggins plots constructed using the data presented in panel a for temperatures between 25-90° C.; FIG. 20c: Temperature dependence of the intrinsic viscosity ([η]) for MB-7980 (black squares), linear p(SMA-co-MMA) (dark grey triangles), silicon-containing hyper-branched cores grafted with 9 arms of p(SMA-co-MMA) with a degree of polymerization of 100 and 50 (IC-Star₉, green triangles, blue circles), organic star polymers carrying 8 p(SMA-co-MMA) arms (OC-Star₈, purple diamonds), IC-Star₉ grafted with poly(lauryl acrylate) arms (light grey triangles), and IC₉ cores linked via C₁₃ spacers (IC-C13-linked, yellow).

FIGS. 21a-21b. Intrinsic viscosities ([η]) vs. temperature for FIG. 21a (MB-7980 benchmark polymer) and FIG. 21b, IC-Star₉ grafted with p(LA) arms (DPₙ=25) in n-hexadecane (grey squares), Yubase 4 (blue triangles), and Nexbase 3043 (red circles). Dotted lines are drawn to guide the eyes.

FIGS. 22a-22d. FIG. 22a: Shear rate vs. shear stress as function of temperature for a 1 wt % solution of linear p(SMA-co-MMA) in Yubase 4. FIG. 22b: Solution viscosity for the same solution calculated using the data plotted in panel a. FIG. 22c: Macroscopic appearance of (i) pure Yubase 4, (ii) linear p(SMA-co-MMA), (iii) OC-Star₈ and (iv) IC-Star₉ in Yubase 4 after the high temperature rheological measurements. Concentration=1 wt % for all depicted samples. FIG. 22d: Determination of zero shear dynamic viscosities (η₀) by extrapolation (dotted line) of the shear rate vs. shear stress curves. η₀ at 40 and 100° C. are used to calculate the viscosity index (VI; Eq. S1 and S2).

FIG. 23. Viscosity indices (VIs) determined for pure Yubase 4 and its solutions containing poly(stearyl methacrylate-co-methyl methacrylate) (p(SMA-co-MMA)) derived additives. Grey: linear p(SMA-co-MMA), black: MB-7980, green: hybrid stars carrying and average of 6 arms (IC-Star₆), purple: organic stars carrying 8 arms (OC-Star₈), red: hybrid stars carrying an average of 9 arms (IC-Star₉), and orange: hybrid, cross-linked stars (Oligo-IC-Star₉).

FIGS. 24a-24b. Kinematic viscosities (ηₖᵢₙ) at 40° C. (filled bars, lefty-axis) and 100° C. (stripped bars, right y-axis) of pure Yubase 4 (blue) and its solution containing 1 wt % (FIG. 24a) or 2 wt % (FIG. 24b) poly(stearyl methacrylate-co-methyl methacrylate) (p(SMA-co-MMA)) derived additives. Grey: linear p(SMA-co-MMA), black: MB-7980, green: hybrid stars carrying an average of 6 arms (IC-Star₆), purple: organic stars carrying 8 arms (OC-Star₈), red: hybrid stars carrying an average of 9 arms (IC-Star₉), and orange: hybrid, cross-lined stars (Oligo-IC-Star₉).

FIGS. 25a-25d. Small angle neutron scattering (SANS) profiles obtained for FIG. 25a: IC-Star₉, FIG. 25b: OC-Star₈, FIG. 25c: MB-7980, and FIG. 25d: linear p(SMA-co-MMA). Scattering was performed in deuterated n-hexadecane (HD). All additives show a decrease in scattering intensity (I(q)) with increasing temperature, indicative of coil expansion. The star-shaped additives show a structural feature at approximately q=0.1 Å⁻¹ confirming their star shaped topology. The excessive scattering at low q observed for the linear polymers (panel c, highlighted in red) might indicate clustering of individual polymer coils.

FIG. 26a: Scattering profiles over the full q-range probed with small angle neutron scattering (SANS) profiles for p(SMA-co-MMA) based IC-Star_{9.} FIG. 26b: Enlarged view of the Guinier regime plotted in accordance to Eq. 1, revealing temperature-induced coil expansion. FIG. 26c: Enlarged view of the Porod regime revealing two distinct regions in the scattering profiles: a moderately low q, the slope is again indicative for the coil volume and therefore solvent quality. At higher q, the slope of the scattering profile changes as a result of scattering from the cores of the star polymers.

FIG. 27a: Radius of gyration (R_{g}) as a function of temperature for OC-Star₈ (purple), IC-Star₉ (green), and linear p(SMA-co-MMA) (grey). Data was obtained via a Guinier analysis of small angle neutron scattering experiments on the additives dissolved in deuterated n-hexadecane. FIG. 27b: Calculated swelling percentage from the SANS derived R_{g} values.

FIG. 28a: Normalized correlation function for MB-7980 dissolved in n-hexadecane as determined with dynamic light scattering (DLS). Measurements were performed at polymer concentrations ranging from 10 to 1.25 mg/mL. FIG. 28b: Lognormal intensity size distributions obtained from the correlograms shown in panel a.

FIGS. 29a-29c. Normalized correlation functions for linear p(SMA-co-MMA) in FIG. 29a: n-hexadecane and FIG. 29b: Yubase 4 at 25, 50 and 75° C. measured with dynamic light scattering (DLS). Lognormal intensity size distributions as function of temperature for the linear polymer in FIG. 29c: n-hexadecane and FIG. 29d: Yubase 4. The dotted lines indicate the maxima of the size distributions.

FIGS. 30a-30d. Normalized correlation functions for p(SMA-co-MMA)-based OC-Star₈ in FIG. 30a: n-hexadecane and FIG. 30b: Yubase 4 at 25, 50 and 75° C. measured with dynamic light scattering (DLS). Lognormal intensity size distributions as function of temperature for the linear polymer in FIG. 30c: n-hexadecane and FIG. 30d: Yubase 4. The dotted lines indicate the maxima of the size distributions.

FIGS. 31a-31d. Normalized correlation functions for p(SMA-co-MMA)-based IC-Star₉ in FIG. 31a: n-hexadecane and FIG. 31b: Yubase 4 at 25, 50 and 75° C. measured with dynamic light scattering (DLS). Lognormal intensity size distributions as function of temperature for the linear polymer in FIG. 31c: n-hexadecane and FIG. 31d: Yubase 4. The dotted lines indicate the maxima of the size distributions.

FIGS. 32a-32d. Normalized correlation functions for MB-7980 in FIG. 32a: n-hexadecane and FIG. 32b: Yubase 4 at 25, 50 and 75° C. measured with dynamic light scattering (DLS). Lognormal intensity size distributions as function of temperature for the linear polymer in FIG. 32c: n-hexadecane and FIG. 32d: Yubase 4. The dotted lines indicate the maxima of the size distributions.

FIGS. 33a-33b. Change in the friction coefficient (μ) as a function of time for the base oil (Yubase 4, blue) and Yubase solutions containing 2 wt % linear p(SMA-co-MMA) (grey), branched p(SMA-co-MMA) (black), IC-star₆ (green), OC-stars (purple), IC-star9 (red), and Oligo-IC-star₉ (orange). Shearing conditions consist of a constant shear rate of approximately 10⁷ s⁻¹ and an applied load of 150 mN for the duration of FIG. 33a: 24 h or FIG. 33b: 30 min. FIG. 33c: Average friction coefficients from 24 h (full bars) and 1 h (stripped bars) shearing experiments.

FIG. 34a: The root mean square (RMS) roughness of the wear tracks after shearing experiments. The grey shaded area depicts the average RMS roughness of the smooth surfaces before shearing. FIG. 34b: Measured RMS roughness of wear tracks after shearing experiments plotted against the obtained friction coefficients.

FIG. 35a: Adsorbed layer thickness formed by the polymeric additives on iron oxide surfaces measured using a quartz crystal microbalance (QCM). The thickness was calculated assuming an adsorbed layer density of 0.885 kg/m³ and a rigid adsorbed layer. This last assumption justified the use of the Sauerbrey equation (Eq. S4). FIG. 35b: Schematic representation of the hypothesized chain configurations for adsorbed polymers with a linear (left) and star-shaped (right) topologies. Binding to the surface via the ester moieties of the pendent side groups of the polymer chains.

FIG. 36. Schematic overview of high pressure homogenizer and its use to measure shear stability of polymer solutions.

FIGS. 37a-37d Gel permeation chromatograms (GPC) as a function of cycle number for linear polystyrene (p(St)) having an initial molecular weight of FIG. 37a: 200 kDa and FIG. 37b: 400 kDa. FIG. 37c: Evolution of the molecular weight distributions for MB-7980 as determined by GPC. Shearing of 3 wt % solutions of these polymers was performed using a homogenizer equipped with dynamic valve attachment; 1500 bar back pressure. FIG. 37d: Schematic representation of stress (a) distribution along the polymer backbone as a function of chain length.

FIGS. 38a-38e. Gel permeation chromatograms (GPC) as a function of cycle number for FIG. 38a: linear p(SMA-co-MMA) with a molecular weight of 128 kDa, FIG. 38b: linear p(SMA-co-MMA) with a molecular weight of 200 kDa, FIG. 38c: OC-Star₈ (DPₙ=100), and FIG. 38d: IC-Star₉ (DPₙ=100) Shearing of 3 wt % solutions in chloroform of these polymers was performed using a homogenizer equipped with dynamic valve attachment; 1500 bar back pressure. FIG. 38e: Number average molecular weight (Ma) versus estimated shearing time for the linear p(SMA-co-MMA) (panel b), OC-Star₈, and IC-Star₉.

FIG. 39. Schematic of the high-speed SFA (HS-SFA). A rotating disk attachment to the SFA was used to perform tribological (friction and wear) measurements. The configuration consists of a spherical cap top surface (radius of cap, R_{cap}=7.85 mm) and a rotating disk bottom surface (R_{disk}=20 mm). The spherical cap is mounted with force sensing springs that separately detect the (normal) vertical force, or the load (L), and the parallel shearing force, or the friction force F∥, perpendicular to L. The disk rotates at 632 revolutions per minute (RPM) with the spherical cap positioned at a radius at contact (R_{c}) of 15 mm, resulting in a velocity at contact v_{c} of 1 m·s⁻¹.

FIG. 40a: Reaction scheme depicting the synthesis of the inorganic star-initiator (<f>=6) starting from Ex1001 subjected to a thiol-ene reaction with 2-mercaptoethanol, followed by a reaction with BIBB, and FIG. 40b: the corresponding ¹H NMR spectra of the starting material, the intermediate and the product in CDCl₃ (displayed from bottom to top), showing integration per arm; FIG. 40c: FT-IR of Ex1001 (bottom), the intermediate (middle), and the inorganic star-initiator (top).

FIG. 41a: Reaction scheme depicting the synthesis of but-3-en-1-yl 2-bromo-2-methylpropanoate. FIG. 41b: ¹H, ¹³C NMR spectra in CDCl₃ and FIG. 41c: FT-IR of but-3-en-1-yl 2-bromo-2-methylpropanoate.

FIG. 42a: Reaction scheme depicting the synthesis of the inorganic star-initiator (<f>=9). FIG. 42b: ¹H NMR spectra of Ex901 (bottom) and its corresponding inorganic star-initiator (top) in CDCl₃, showing integration per arm. FIG. 42c: FT-IR of Ex901 (bottom) and its corresponding inorganic star-initiator (top).

FIG. 43a: Reaction scheme depicting the synthesis of the organic star-initiator starting from tripentaerythritol. FIG. 43b: ¹H and ¹³C NMR spectra of the organic star-initiator in CDCl₃. FIG. 43c: FT-IR of tripentaerythritol (bottom), and OC-8 (top).

FIG. 44a: Synthesis of linear p(SMA-co-MMA) via ruthenium-catalyzed Atom Transfer Radical Polymerization (Ru-ATRP). FIG. 44b: ¹H NMR spectrum of p(SMA-co-MMA) in CDCl₃ revealing the 1:1 incorporation ratio of SMA:MMA.

FIG. 45. ¹H spectrum of IC-star₆ in CDCl₃ (showing integration per arm).

FIG. 46. ¹H spectrum of OC-stars in CDCl₃ (showing integration per arm)

FIG. 47a: Reaction scheme showing the synthesis of IC-star₉, and Oligo-IC-star₉ via ruthenium-mediated controlled radical polymerization, and FIG. 47b: their corresponding ¹H NMR spectra in CDCl₃ (displayed from top to bottom), showing integration per arm.

FIGS. 48a-48b. Melting and crystallization thermograms measured using differential scanning calorimetry (DSC) for FIG. 48a: neat additives, and FIG. 48b: as 2 wt % blends in Yubase 4. Linear p(SMA-co-MMA) (grey), MB-7980 (black), hybrid stars (<ƒ>=6) (IC-star₆) (green), organic stars (ƒ=8) (OC-Star₈) (purple), hybrid stars (<ƒ>=9) (IC-star₉) (red), hybrid cross-linked stars (Oligo-IC-Star₉) (orange), and hybrid stars (<ƒ>=9) with p(SMA) homopolymer arms as a reference (yellow).

FIG. 49. Compressed film thicknesses of neat Yubase 4 (black) and base oil solutions containing 2 wt % hybrid stars carrying an average of 9 arms (IC-Star₉, green) or 2 wt % MB-7980 (blue) as determined with a surface force apparatus (SFA).

FIGS. 50a-50b. Determination of the dn/dc for MB-7980. dRI response were determined using the GPC-MALS set-up described in the main text. FIG. 50a: Normalized dRI signals for a series with polymer concentrations ranging from 1-5 mg/mL (injection volume=100 μL, solvent=CHCl₃+0.25% TEA). FIG. 50b: Peak areas of dRI signals plotted versus injected mass. The slope of the fitted curve is equal to the dn/dc value.

FIGS. 51a-51f. Differential refractive index (dRI; grey) and light scattering (red) size exclusion chromatograms (SEC) obtained for the FIG. 51a: linear p(SMA-co-MMA), FIG. 51b: MB-7980, FIG. 51c: hybrid stars carrying 6 arms (IC-star₆), FIG. 51d: organic stars carrying 8 arms (OC-Star₈), FIG. 51e: hybrid stars carrying 9 arms (IC-star₉), and FIG. 51f: hybrid cross-linked stars (Oligo-IC-Star₉).

FIG. 52. Raw data showing the lateral or friction force (red line, right axis) responding to oscillating load (grey line, left axis). The first few peaks in friction indicates stiction behavior at the beginning of revolution. Friction coefficients, μ=F∥/L, are calculated by binning the raw data, plotting F∥ against L, then finding the best linear fit of F∥ to L, and calculating the slope.

FIG. 53. Wear track from 24 h shearing with 2 wt % MB-7980 in Yubase. The vertical yellow scale bar denotes 1 μm for the yellow profile in vertical direction. The horizontal white bar is 100 μm for the lateral distance of the yellow profile as well as the scale for the wear image below.

FIG. 54. Change in the frequency of quartz crystal while (1) Yubase 4 is introduced to iron oxide-coated quartz crystal, followed by (2) introduction of IC-star₉ solution at around 10 min mark, and (3) flushing with Yubase 4 to remove excess IC-star₉ starting around 20 min mark.

FIG. 55. Flowchart illustrating a method of making a composition of matter.

### DETAILED DESCRIPTION OF THE INVENTION

In the following description of the preferred embodiment, reference is made to the accompanying drawings that form a part hereof, and in which is shown by way of illustration a specific embodiment in which the invention may be practiced. It is to be understood that other embodiments may be utilized and structural changes may be made without departing from the scope of the present invention.

Technical Description

### SYNTHESIS EXAMPLES

The following description describes examples of making a star-shaped polymer comprising polymer chains grafted to or from a densely a silicon-containing or organic core.

1. Functionalization of silicon-containing hyper-branched polymer building blocks.

1.1. Grafting from the silicon-containing hyperbranched core and the organic core.

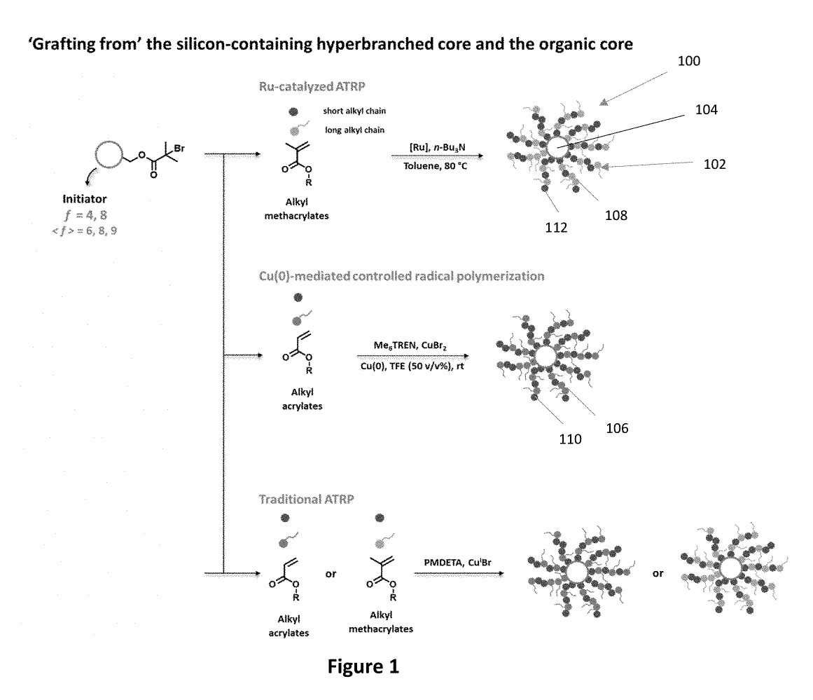

1.1.1. General approach. A general strategy is presented for the preparation of star-shaped polymers employing a core first method. Homo- and copolymer arms are grafted from an existing core carrying a discrete or average number f of initiator sites. The cores were either inorganic silicon-containing hyperbranched structures or organic-based. Ruthenium-catalyzed atom transfer radical polymerization is applied for grafting alkyl methacrylates, while Cu(0)-mediated controlled radical polymerization mainly for alkyl acrylates, and traditional atom transfer radical polymerization (ATRP) applicable for both alkyl acrylates and methacrylates that are less hydrophobic (FIG. 1).

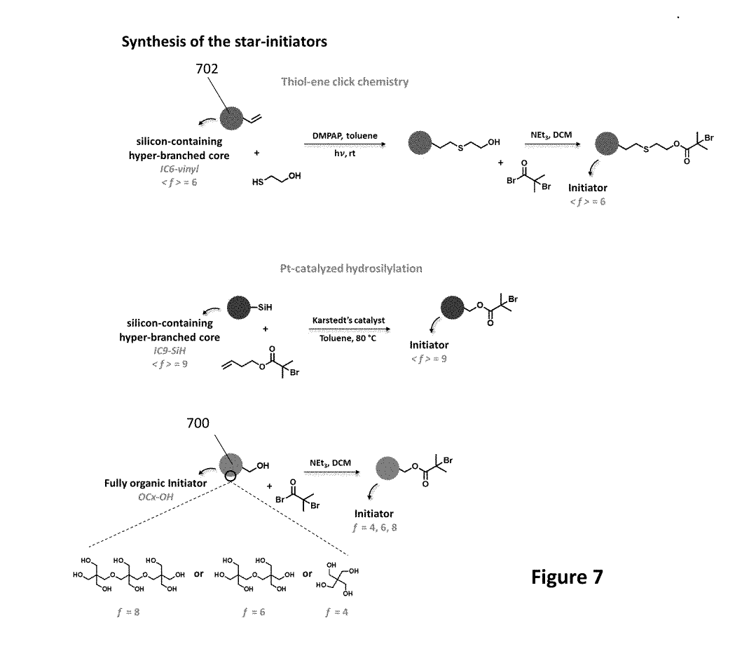

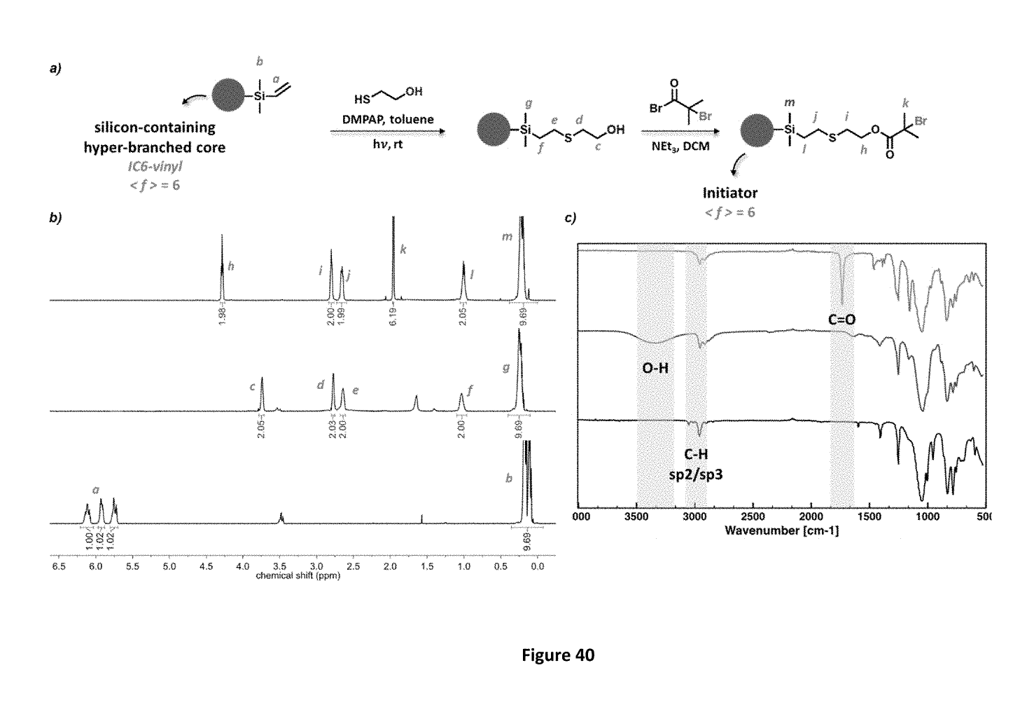

The synthetic routes toward the different star-initiators are schematically depicted in FIG. 7. For the 6-armed hybrid inorganic cores (IC₆-vinyl), cross-linked silicon-containing material with an average of 6 peripheral vinyl functional groups (<ƒ>=6) was subjected to a photo-catalyzed thiol-cane reaction with 2-mercaptoethanol using 2,2-dimethoxy-2-phenylacetophenone (DMPAP) as photo-initiator (FIG. 7, top). After irradiation of the reaction mixture with UV light (λₘₐₓ=365 nm) at room temperature for 2 h. (FIG. 40b), infrared (IR) spectroscopy revealed the disappearance of the characteristic absorption bands between 2840 and 3050 cm⁻¹ and the appearance of a broad band ˜3340 cm⁻¹. These changes in vibrational bands are related to the consumption of the vinyl (—C═CH and —C═CH₂) moieties and the introduction of the now exterior hydroxyl groups, respectively (FIG. 40c, dark blue middle spectrum). Subsequently, these peripheral —OH groups were reacted with α-bromoisobutyryl bromide (BIBB) to immobilize the desired ATRP initiators on the silicon-containing core (FIG. 7, top). Full functionalization was confirmed using ¹H NMR by a downfield shift of the protons alpha to the oxygen (FIG. 40b) after ester bond formation. Additionally, the newly formed ester bond appeared at 1735 cm⁻¹ in the recorded IR spectrum (FIG. S2c, green spectrum).

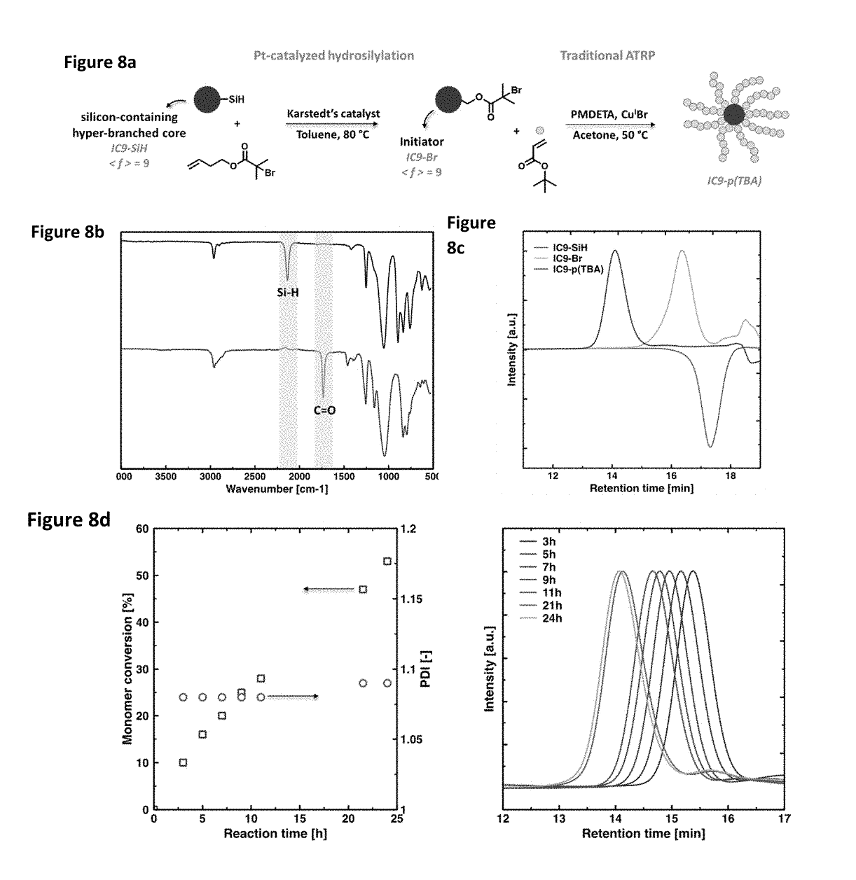

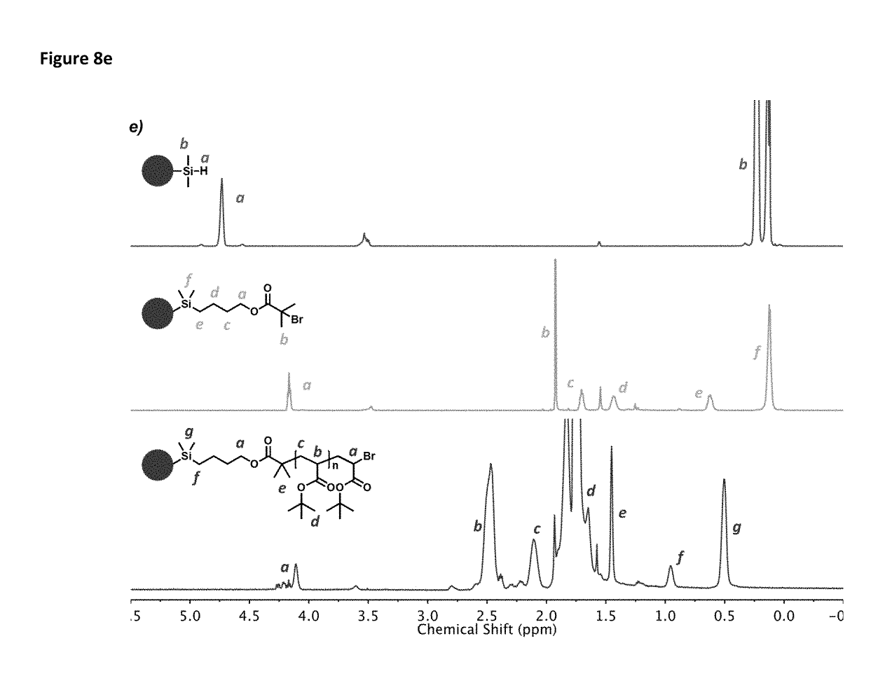

In addition to IC₆-vinyl, inorganic star-initiators with an average functionality of 9 arms (IC₉-stars, <ƒ>=9) were obtained by starting with silicon-based cores carrying peripheral silane moieties. These silane groups were reacted with but-3-en-1-yl 2-bromo-2-methylpropanoate [28] through a Karstedt-catalyzed hydrosilylation reaction [29] (FIG. 7, middle). Comparing the ¹H NMR spectra of the silicon-containing core before and after the hydrosilylation reaction indicated complete substitution of the Si—H groups with the ATRP initiator (FIG. 8e and Section S4). IR analysis confirmed full functionalization of the parent core by the disappearance of the Si—H-related signature bands at 2140 and 895 cm⁻¹, and the appearance of the carbonyl stretch at 1730 cm⁻¹ corresponding to the immobilized ATRP initiator (FIGS. 8b and S4).

Finally, an organic core with 4-8 initiating sites (OCₓ—OH, f=4-8) was obtained starting from pentaerythritol derivatives. Similar to the procedure described for IC₆-vinyl, ATRP initiators were coupled to the exposed OH-groups by reaction with BIBB (FIG. 7, bottom). [30-32] ¹H NMR and IR analysis shown for OC₈-Br revealed full functionalization (FIGS. 42b and c).

1.1.2 Traditional atom transfer radical polymerization (ATRP). Following previously established protocols for ATRP reactions, the star-initiator was tested for its initiator efficiency using tert-butyl acrylate as model monomer and a CuBr/PMDETA catalytic system in acetone at 50° C. [33]. The reaction was performed under dilute conditions (200 wt % of acetone of total components mass), to avoid the occurrence of star-star coupling resulting from inevitable termination reactions. Notably, an increase in molecular weight with respect to IC₉-Br was observed, translated by the shift of the gel permeation chromatography (GPC) traces to shorter elution times. The monomer conversion increased linearly as a function of time and reached a maximum of ≈50% conversion after 2.4 h, while maintaining low dispersity (Ð<1.1) as displayed by size exclusion chromatography (SEC) analysis in chloroform relative to polystyrene standards, suggesting well-controlled polymerization (FIG. 8d). Meanwhile, the degree of polymerization (DPₙ) per arm was determined by integrating the backbone peak b with respect to the isolated initiator peaks a, e, f or g (FIG. 8e).

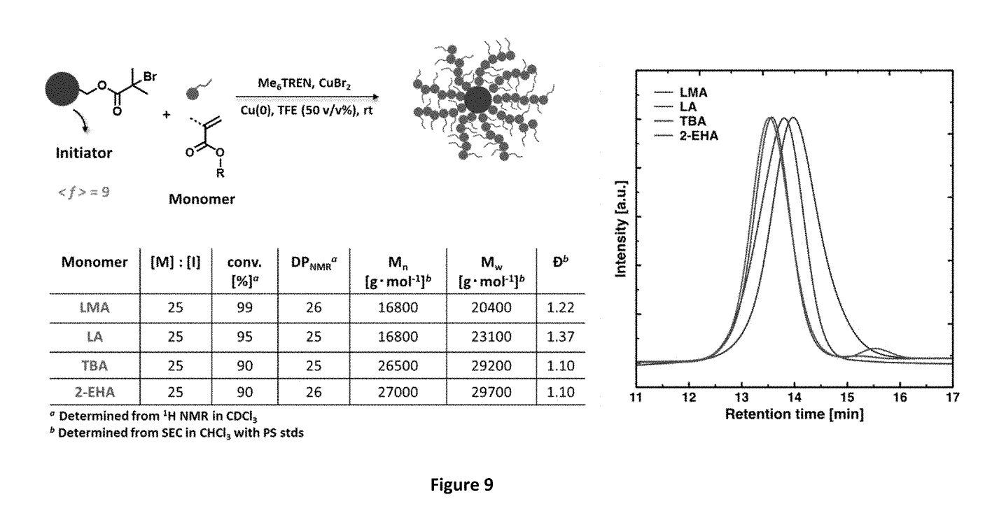

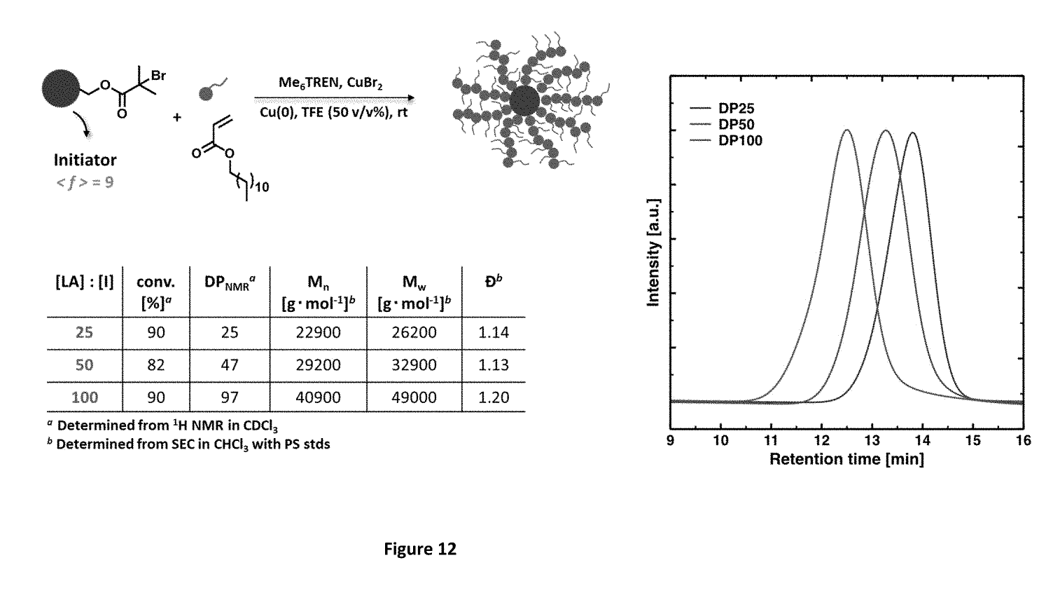

1.1.3. Cu(0)-mediated controlled radical polymerization. Grafting alkyl(meth)acrylates with a long hydrophobic tail (lauryl methacrylate LMA, lauryl acrylate LA, 2-ethylhexyl acrylate, 2-EHA) is inherently more challenging for controlled radical based polymerization techniques and was successfully achieved by employing Cu(0)-mediated controlled radical polymerization (FIG. 9) [34, 35]. The polymerizations were allowed to run overnight in trifluoroethanol (TFE) (50 v/v %) at ambient temperature with Me6TREN as coordinating ligand (0.18 equiv. per initiating site) in the presence of Cu(0) wire and Cu^{II}Br₂ (0.05 equiv. per initiating site). Controlled polymer growth, as evident from the low dispersity (Ð<1.4), and high end-group (bromo) fidelity (determined by MALDI-TOF) were observed even at high monomer conversions (>90%) (FIG. 9). In addition to tunability in monomer type, this method allows tunability in the arm length by targeting DPₙ's (FIG. 12). Hence, poly(LA) stars of different arm sizes were prepared following the same conditions and were isolated at high conversions (>82%) and low Ð (<1.20). The experimentally determined degree of polymerizations (DP_{NMR}) per arm were in agreement with the target DPₙ, further highlighting the controlled nature of this polymer grafting procedure.

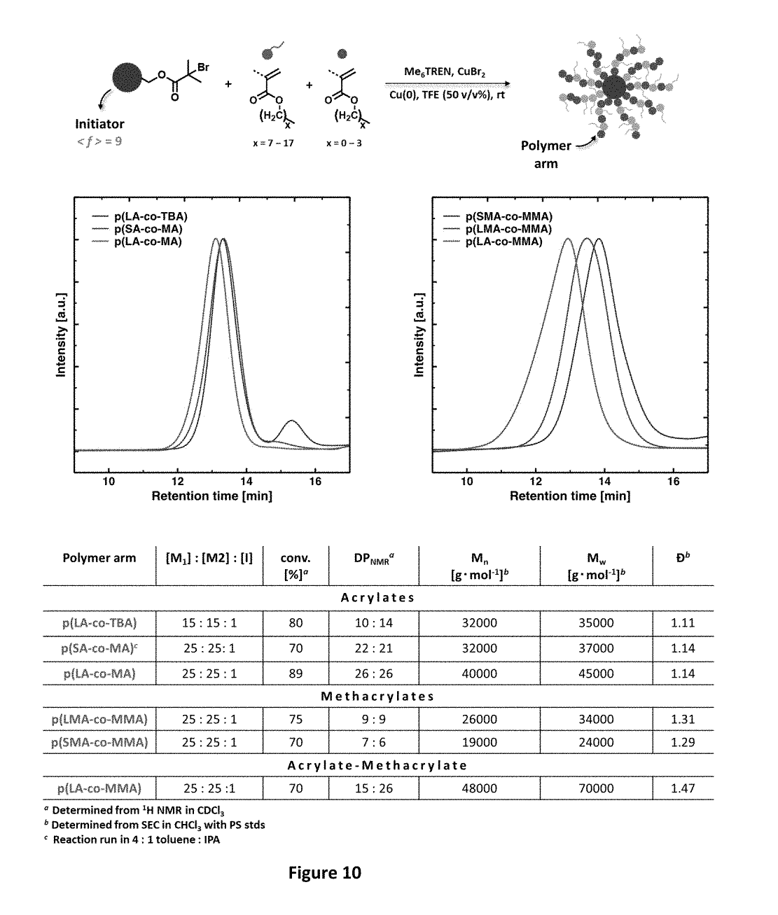

The scope of Cu(0)-mediated living radical polymerization in the presence of Cu^{II}Br₂ and Me₆TREN was expanded to include the copolymerization of acrylates, methacrylates, and their combinations (FIG. 10). In the case of acrylates, the reactions proceeded overnight reaching high monomer conversions (>70%), generating star polymers with low dispersity (Ð<1.14). In addition, the DPₙ per arm determined by NMR were in agreement with the targeted DPₙ (FIG. 10, Table). Poly(methacrylate) copolymers, on the other hand, did not reach their goal molecular weights and their molecular distributions were broad (FIG. 10, left) compared to their acrylate counterparts (FIG. 10, right). The poly(acrylate-co-methacrylate) copolymers despite reaching their target DPₙ, showed broad PDI's (FIG. 10).

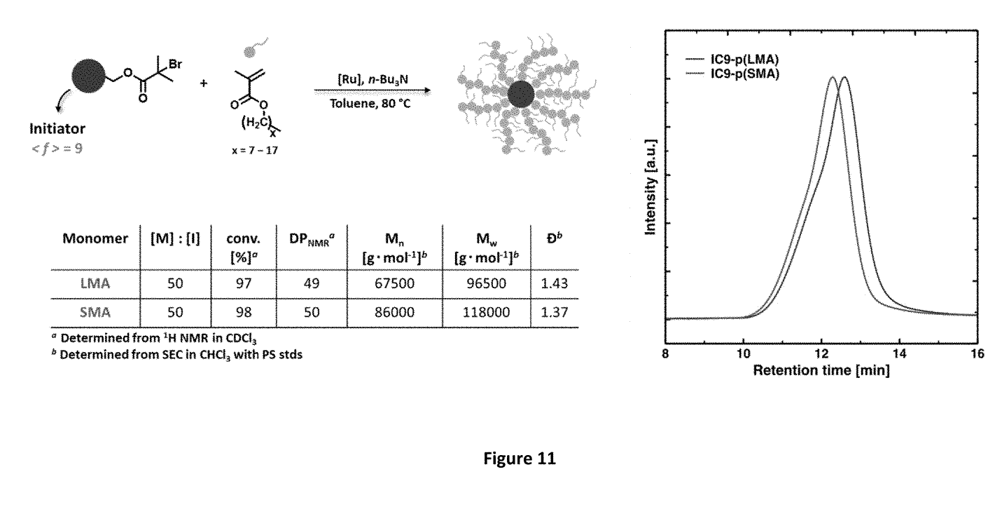

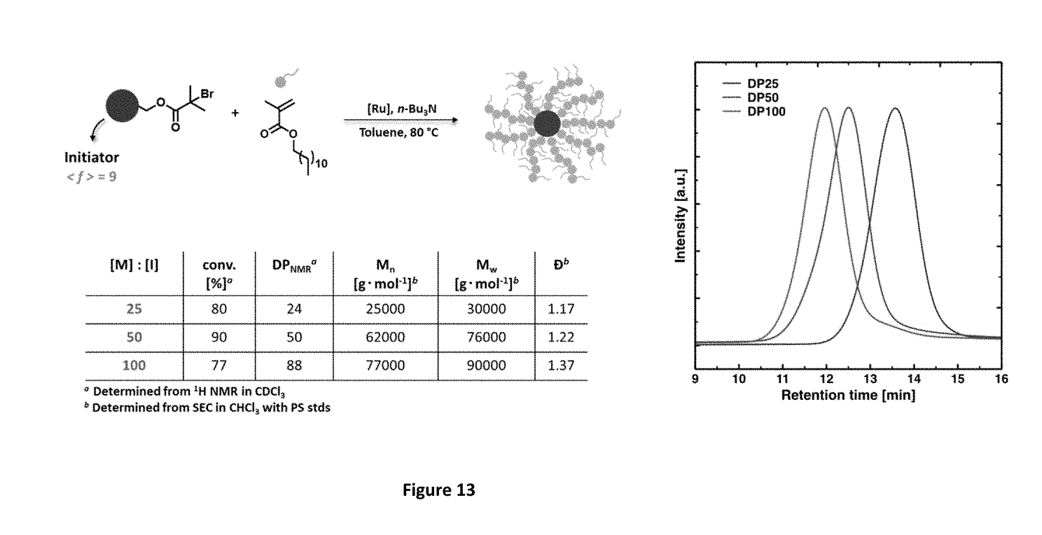

1.1.4. Ruthenium-mediated controlled radical polymerization. The following describes how ruthenium-mediated controlled radical polymerization [36, 37] can be used to graft poly(alkyl methacrylates) homopolymers from the silicon-containing hyperbranched core. Thus, the indenyl ruthenium-based catalyst (0,1 equiv. relative to initiating sites) in conjunction with IC₉-Br as initiator in the presence of a tertiary amine, tributyl amine n-Bu₃N (1 equiv. relative to initiating sites), was employed for the metal-catalyzed living radical polymerization of lauryl methacrylate LMA and stearyl methacrylate SMA. In toluene at 80° C. under inert atmosphere, both polymerizations proceeded homogeneously, after optimization of reaction concentration, to high degrees of conversion (>97%) to yield star polymers with relatively narrow molecular weight distributions (Ð<1.37) given their high molecular weights (FIG. 11). Changes in the arm length has been demonstrated with LMA to exemplify the tunability of this method in enabling the synthesis of star polymers with different arm lengths (FIG. 13).

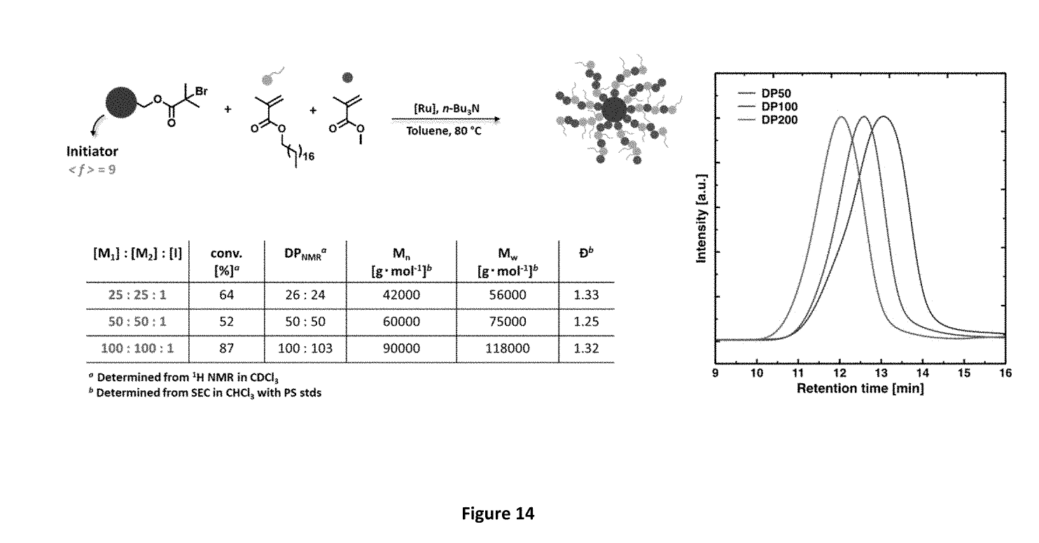

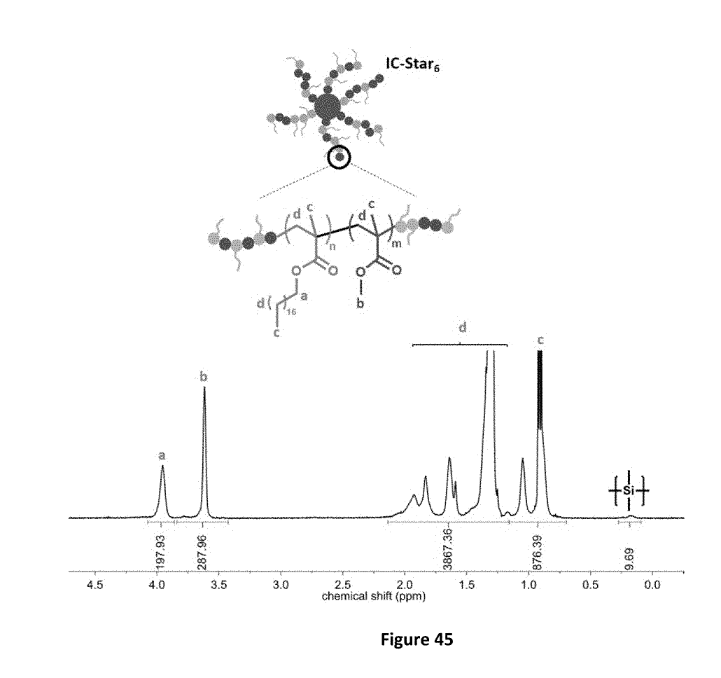

Statistical copolymers of stearyl methacrylate (SMA) and methyl methacrylate (MMA) with a co-monomer ratio of 1:1 and different DPₙ per arm were grafted from the silicon-containing hyperbranched core (FIG. 14). Under the same conditions, the polymerizations proceeded from moderate to high conversions (>50%) after overnight reactions, resulting in polymers with a fairly narrow molecular weight distribution (Ð<1.33). The 1:1 incorporation ratio of SMA to MMA was confirmed by ¹H NMR, endorsing the fairly similar reactivity ratios of the two monomers and therefore assuming a random monomer distribution within the polymer chains (FIG. 45).

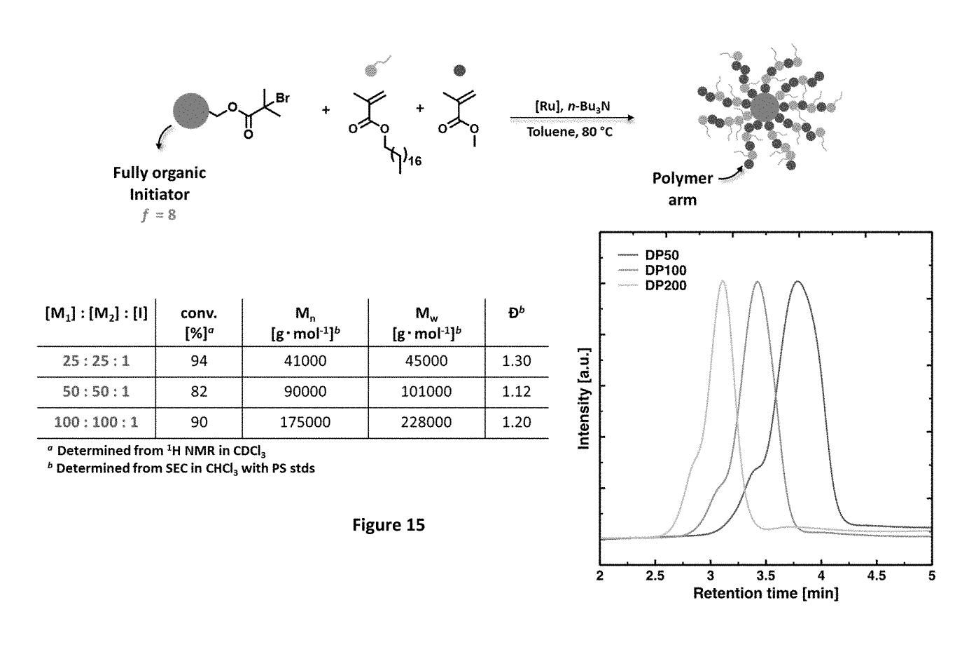

Equivalent fully organic star polymers were prepared by grafting p(SMA-co-MMA) arms from a tripentaerythriol-based star initiator under similar ruthenium-catalyzed polymerization conditions (FIG. 15). Unlike the hybrid stars, the monomer conversion was significant higher (>80%) and the organic stars were obtained with narrower molecular weight distributions (Ð<1.3). This observation is directly related to the fact that the organic star initiator is a well-defined molecular species, while the inorganic hyperbranched cores are inherently polydisperse. This polydispersity is amplified after polymer grafting.

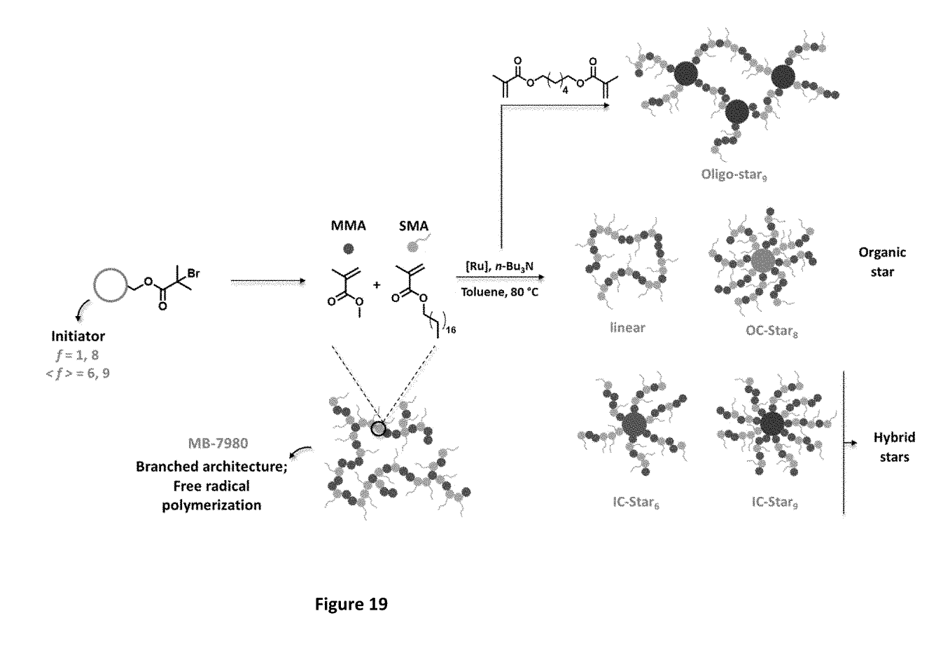

1.1.5. Synthesis of p(SMA-co-MMA) derivatives as triple function lubricant additives. A set of polymeric oil additives with well-defined macromolecular architectures were synthesized using ruthenium-catalyzed atom transfer radical polymerization (Ru-ATRP). [36] Inspired by industrially applied lubricant additives, statistical copolymers of stearyl methacrylate (SMA) and methyl methacrylate (MMA) with a co-monomer ratio of 1:1 were employed. Since the reactivity ratios of MMA and SMA are fairly similar, [38, 39] we assume a random monomer distribution within the polymer chains. The SMA monomers carry pendent alkyl groups with sufficiently long hydrocarbon chains to safeguard solubility in the base oil, while MMA incorporation aids in maintaining oil fluidity by preventing the liquid crystalline order of the SMA long side chains through interruptions of the regularities of the repeating units of the copolymer chain (see Section 2 and Section S4). [40, 41] The effect of topology and degree of polymer branching were evaluated against an industrially relevant polymer (MB-7980) based on the same SMA-co-MMA chemistry but prepared via conventional free-radical based polymerization techniques (FIG. 19).

Truly linear polymers were readily prepared starting from a mono-functional, commercially available initiator (ƒ=1, ethyl α-bromoisobutyrate), while for the star-shaped polymers, the previously described core-first method was employed. Following this strategy, the polymer arms were grafted from an existing core molecule carrying f initiator sites. The cores were either inorganic silicon-containing hyperhranched structures or organic-based. The synthetic routes toward the different star-initiators are schematically depicted in FIG. 7.

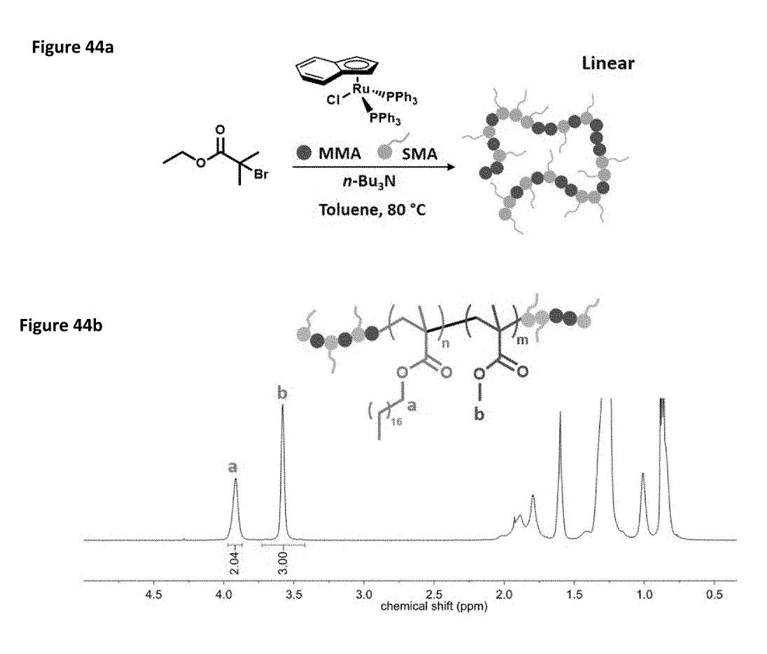

With these initiators in hand, the targeted well-defined additives were successfully synthesized using the previously mentioned Ru-ATRP technique. For the linear polymer, an initiator to co-monomer feed ratio of [SMA]:[MMA]:[I]=375:375:1 was used. Hence, a total of 750 repeating units per polymer chain was targeted. In toluene at 80° C. under inert atmosphere, the polymerization proceeded homogeneously to high conversions (>90%) after reaction overnight, resulting in polymers with a fairly narrow molecular weight distribution (Ð=1.5). The average, absolute molecular weight, as determined with size exclusion chromatography -angle light scattering (SEC-MALS), was equal to 165 kg·mol⁻¹ (Table S1, Entry 1). Finally, 1:1 incorporation ratio of SMA to MMA was confirmed by ¹H NMR (FIG. 44).

Analogous to the polymerization performed for the linear polymers, inorganic-based star polymers were prepared. IC-star₆, based on initiator IC₆-Br were obtained using 100 equivalents of both SMA and MMA per arm ([SMA]:[MMA]:[I]=100:100:1). After 10 h, nearly quantitative conversion (>97%) was reached for both monomers as resolved from the consumption of SMA and MMA by ¹H NMR (FIG. 45). The DPₙ per arm, as determined from the integration ratio between the monomer peaks and isolated initiator NMR signals (—S₁(CH₃)₂—), was close to the targeted values ([SMA]:[MMA]=99:96) and therefore in agreement with the measured monomer conversion. A molecular weight of 270 kg·mol⁻and PDI of 1.2 were measured by SEC-MALS (Table S1, Entry 3).

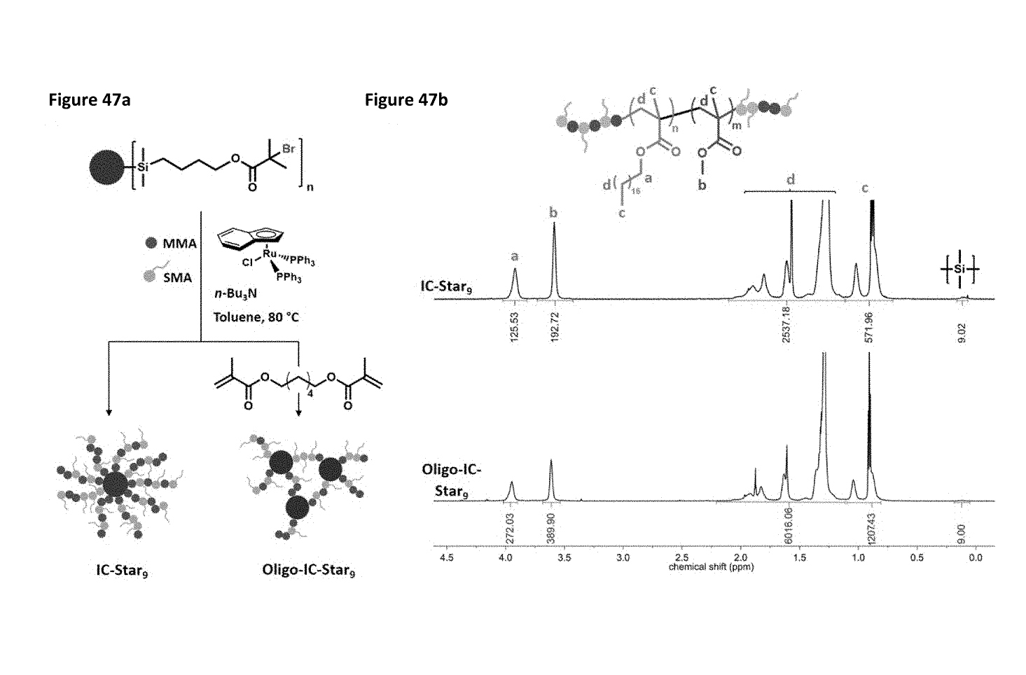

Grafting p(SMA-co-MMA) polymers from IC₉-Br was performed under more dilute reaction conditions compared to IC₆r-Br to prevent substantial degrees of star-star coupling. [42] Monomer equivalents were kept fixed at 100 per arm for both SMA and MMA. Characterizing the obtained 9-armed organic-inorganic hybrids with ¹H NMR (FIG. 47) and SEC-MALS revealed monomer conversions of approximately 64% and a relatively narrow molecular weight distribution (Ð=1.3) peaked around 250 kg·mol⁻¹ (Table S1, entry 5).

Equivalent fully organic star polymers were prepared by grafting p(SMA-co-MMA) arms from a tripentaerythritol-based star initiator under similar ruthenium-catalyzed polymerization conditions (FIG. 7). As for IC-star₉, the monomer conversion was kept relatively low (50%, determined by ¹H NMR). Under these conditions, organic stars with an absolute molecular weight of 170 kg·mol⁻¹ and Ð=1.2 were obtained (Table S1, Entry 4).

In addition to the monomeric star-shaped additives, a hybrid organic-inorganic macromolecular architecture composed of cross-linked stars was synthesized (see Section 1.3 for more detailed description on this synthetic strategy, Oligo-star₉). To this end, 2 equivalents (with respect to IC₉-Br) of di-functional cross-linker, 1,6-hexanediol dimethacrylate, were added to the Ru-catalyzed ATRP reaction of SMA and MMA. The cross-linker concentration was optimized to prevent macroscopic gelation. After 13 h, an apparent increase in molecular weight (933 kg·mol⁻¹) and dispersity=2.7) denoted the efficacy of cross-linking (Table S1, Entry 6). Worth noting, addition of cross-linker did not affect the monomer incorporation ratio of SMA to MMA (≈1:1, FIG. 47).

Summarizing, a topological library of (SMA-co-MMA) derivatives (FIG. 19) was successfully synthesized with uniform (arm) chemistries and fairly narrow molecular weight window across the different architectures (except for the cross-linked Oligo-star₉). Since the selected chemistry was based on industrially relevant oil additives, all polymers showed excellent solubility in the base oil of choice. Yubase 4. No precipitates were observed even after storing solutions containing 1 or 2 wt % of additives for months at room temperature, facilitating studying their solution and thin film properties.

1.2. Grafting to the silicon-containing hyperbranched core.

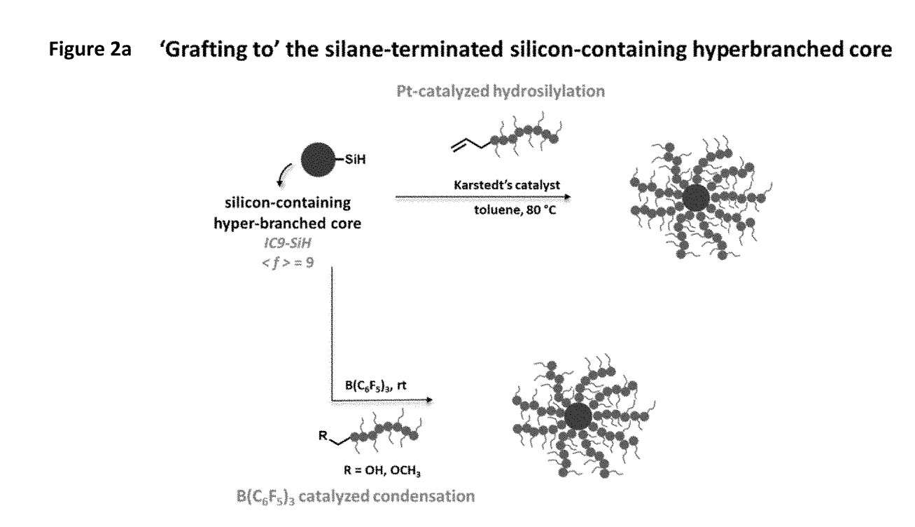

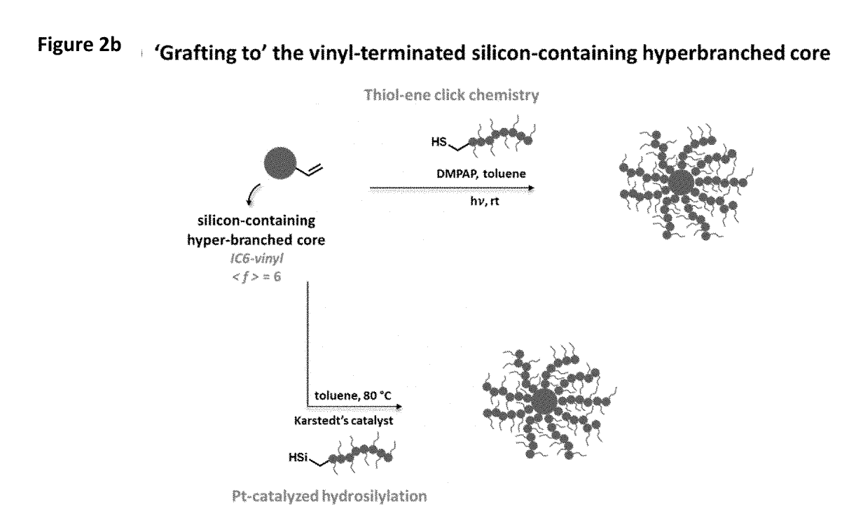

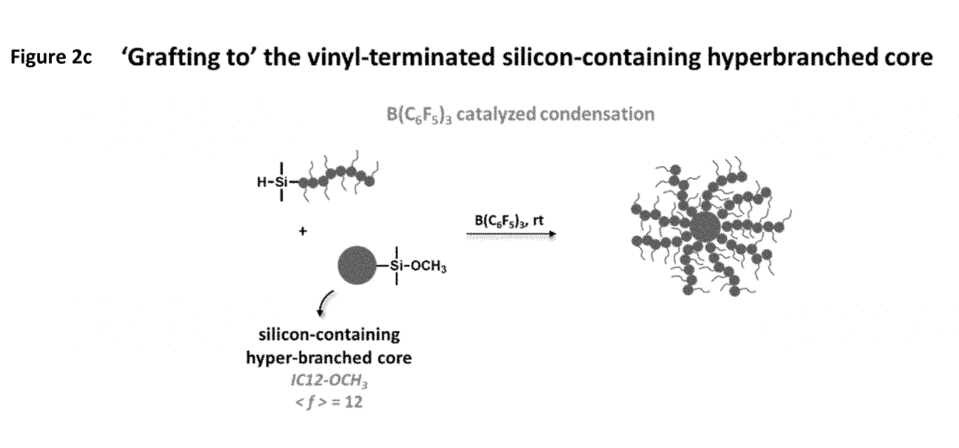

1.2.1. General approach. In addition to the previously described core-first method (Section 1.1), general synthetic strategies for grafting polymers to the different silicon-containing hyperbranched cores containing various terminal groups: vinyl, silane, and methoxy were developed. As for the grafting from method, the number of functionalities per core will dictate the number of arms of the resulting star polymers. Polymer arms/short alkyl chains can be grafted to the silane-terminated inorganic cores (IC₉-SiH) using [Pt]-catalyzed hydrosilylation reactions [29] or by using instant B(C₆F₅)₃-catalyzed condensations [43, 44] (FIG. 2a). The vinyl-terminated inorganic cores (IC₆-SiH) were decorated with (polymeric) chains by photo-catalyzed thiol-ene chemistry [45-47] or the same [Pt]-catalyzed hydrosilylations used for the IC₉-SiH. [29] (FIG. 2b). The methoxy-terminated inorganic cores (IC₁₂-OCH₃) were functionalized solely using B(C₆F₅)₃-catalyzed condensations (FIG. 2c).

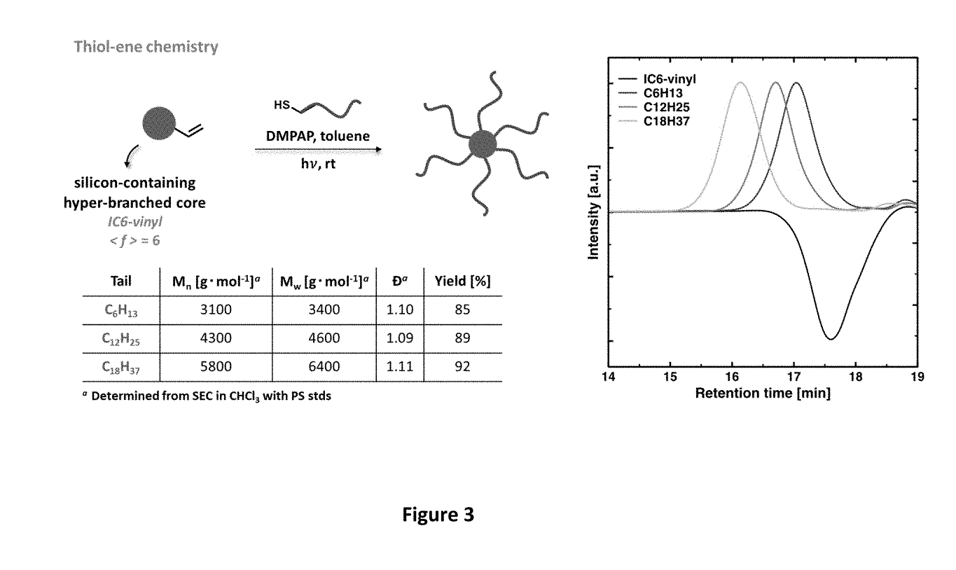

1.,2.2. Thiol-ene chemistry. The vinyl-terminated silicon-containing hyper-branched core was subjected to thiol-ene reaction using three different alkyl thiols (HS-C₆H₁₃, HS—C₁₂H₂₅, and HS—C₁₈-H₃₇) (FIG. 3). The inorganic core, the photo-initiator 2,2-dimethoxy-2-phenylacetophenone (DMPAP), and the corresponding thiol were dissolved in toluene under inert atmosphere. The reaction was sealed and irradiated with a UV-light (λₘₐₓ=365 nm) at room temperature for 1.5 h. The hybrid organic-inorganic materials were obtained in high yields (85%, 89%, and 92% respectively). All materials show narrow molecular weight distributions (Ð=1.1) when analyzed by size exclusion chromatography (SEC) in chloroform with respect to polystyrene standards. Analysis by ¹H NMR spectroscopy revealed complete loss of the vinyl group protons and the appearance of peaks corresponding to the quantitative incorporation of the mercaptans. FT-IR confirmed full conversion of the vinyl groups of the parent core upon reaction with the thiols by the disappearance of the corresponding signature bands at 2960 and 950 cm⁻¹, while the other bands remain unchanged.

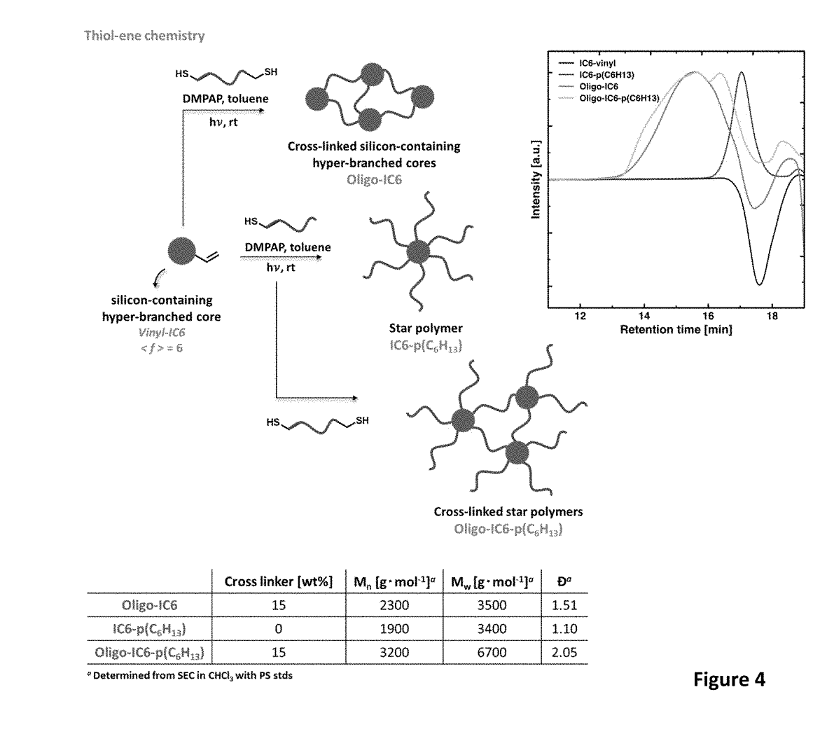

Star-star coupling was induced to increase the density of the silicon-based core in the macromolecular structure. The vinyl-terminated silicon containing hyperbranched polymer was subjected to thiol-ene chemistry with 15 wt % of 1,10-decandithiol in the presence and absence of 1-hexylthiol to generate cross-linked stars (Oligo-IC₆-C₆H₁₃) and cross-linked silicon-containing hyperbranched cores (Oligo-IC₆), respectively (FIG. 4). Size exclusion chromatography of Oligo-IC₆-C₆H₁₃ confirmed the success of the coupling reaction as was concluded from a broadening and shift of the GPC traces toward shorter retention times. Upon increasing the concentration of the dithiol cross-linker in the reaction mixture, the GPC traces revealed a larger amount of cross-linked material compared to monomeric silicone-containing cores. After the addition of 20 wt % or more of 1,10-decandithiol, macroscopic gelation was observed. Therefore, all measurements were carried out on materials consisting of 15 wt % of the dithiol linker.

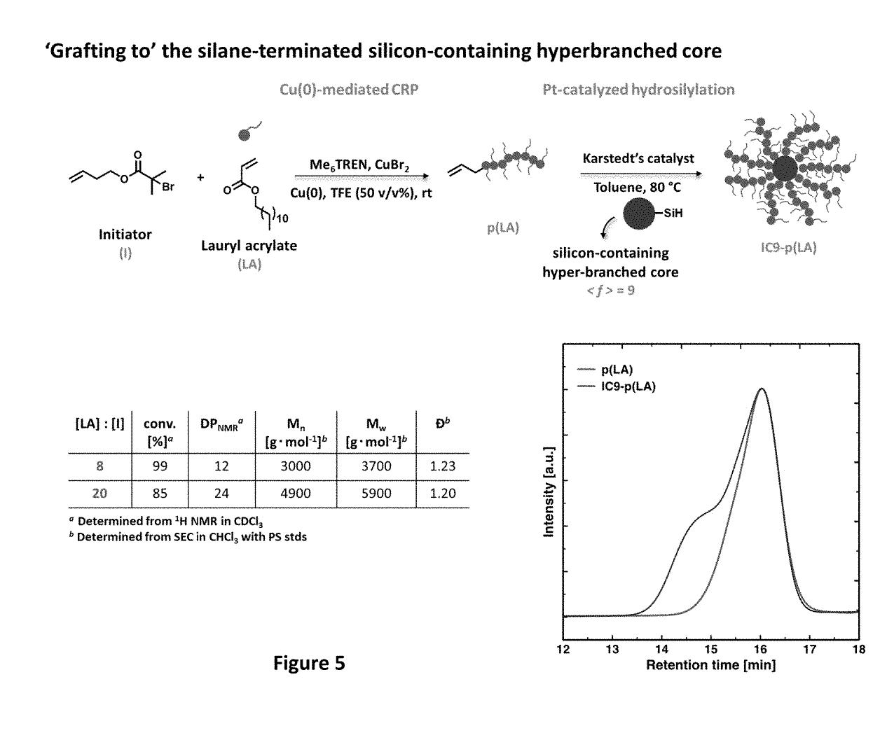

1.2.3. [Pt]-catalyzed hydrosilylatim After failing to procure poly(lauryl acrylate) p(LA) from an alkene functionalized initiator (synthesis see Section 53.4.1, FIG. 5, I) following traditional ATRP conditions (Cu^{I}Br/PMDETA, in 200 wt % acetone at 50° C. overnight), even under more concentrated conditions (in 100 wt % acetone), a different solvent (in 100 wt % anisole), and a more hydrophobic ligand such as 4,4′-dinonyl-2,2′-dipyridyl (dNbpy), alkene terminated-p(LA) was successfully prepared via the Cu(0)-mediated controlled radical polymerization described above (FIG. 5) [48]. Again, the polymerization was conducted in TFE (50 v/v %) at ambient temperature with Me₆TREN employed as the ligand (0.18 eq. relative to initiator) in the presence of Cu(0) (wire) and Cu^{II}Br₂ (0.05 eq. relative to initiator), and confirmed by ¹H NMR and size exclusion chromatography. The homopolymerization of LA in TFE was carried out with targeted degrees of polymerization (DPₙ=8 and 20). Controlled growth, with low dispersity (Ð˜1.2) are observed at relatively high conversion (>85%) (FIG. 5).

The alkene chain end of poly(LA) was then utilized as a handle to graft the polymers to silane-terminated inorganic core. Only eight equivalents of poly(LA) were added relative to the hydrosilyl groups associated with the silicon-containing hyperbranched polymer (average of 9 per molecule) in order to achieve full grafting of all the alkene-terminated poly(LA) chains. The crude ¹H NMR of the product showed the presence of some unreacted vinyl proton peaks indicating that the grafting to strategy is not quantitative, which was further supported by the GPC measurements (FIG. 5).

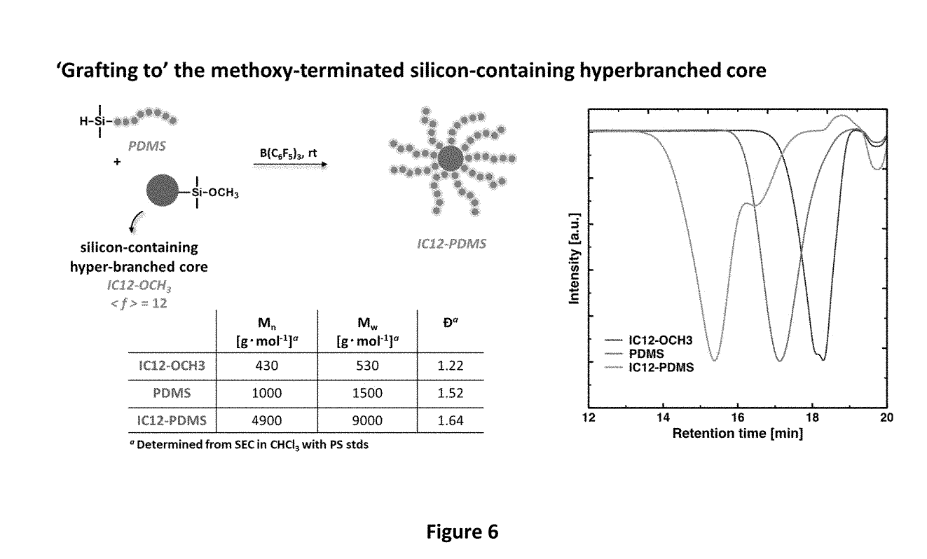

1.2.4. B(C₆F₅)₃-catalyzed condensation. Polydimethylsiloxane polymers (PDMS) with monofunctional silane chain-ends were grafted to the methoxy-terminated silicon-containing hyperbranched core (FIG. 6). Under neat conditions, B(C₆F₅)₃ (0.01 equiv. with respect to each initiating site) was added to a mixture of the inorganic core (IC₁₂-OCH₃) (carrying an average of 12 functional groups, <ƒ>=12) and 14 equivalents of PDMS. The resulting reaction mixture was stirred for 20 min at room temperature. The GPC trace of the crude product obtained showed the presence of a low molecular weight shoulder that corresponded to unreacted PDMS possibly indicating that the grafting to strategy is less effective compared to a grafting from approach (FIG. 6). The attractive features of this reaction include the short reaction times needed to relatively high conversions and the use of no solvents when one or both starting materials are liquid.

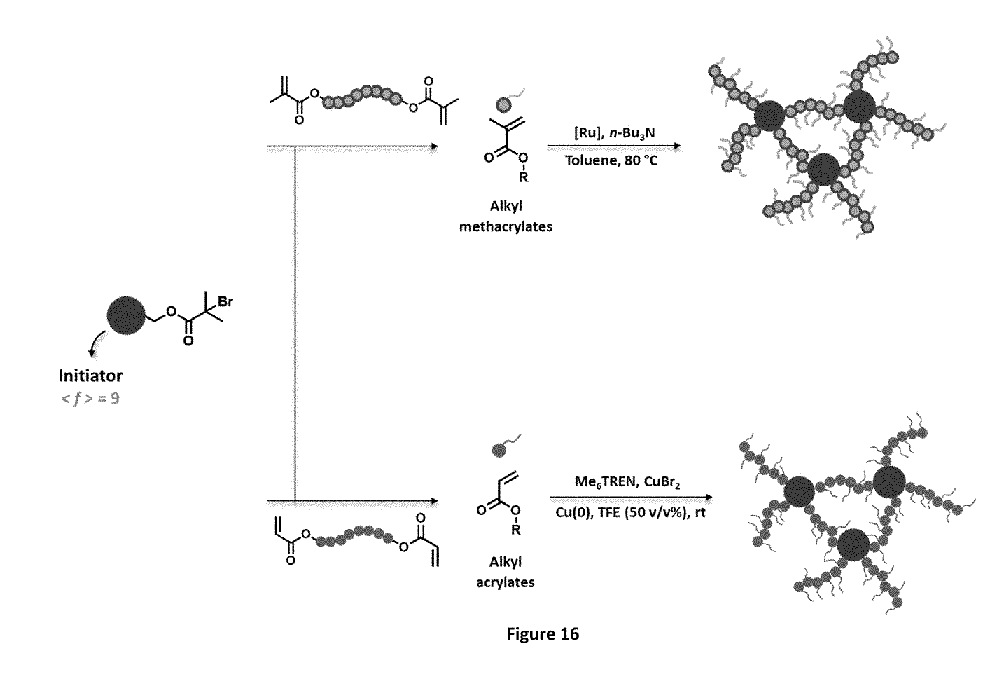

1.3. Macromolecular architectures by cross-linking via polymeric arms in addition to the monomeric star-shaped additives, hybrid organic-inorganic macromolecular architectures composed of cross-linked stars were synthesized. The general approach consist of adding small amount of di-functional cross-linkers (dimethacrylates) to the Ru-catalyzed ATRP reaction of alkyl methacrylates, or difunctional acrylates to the Cu(0)-mediated CRP of alkyl acrylates. The cross-linkers concentrations are optimized to prevent macroscopic gelation in both cases (FIG. 16).

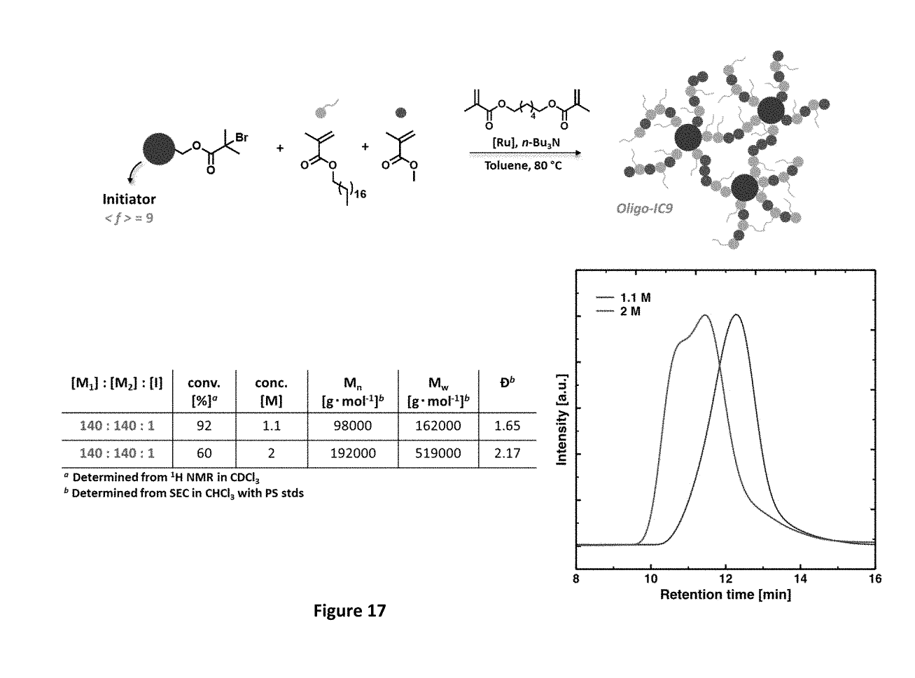

To this end, 2 equivalents (with respect to IC₉-Br) of di-functional cross-linker, 1,6-hexanediol dimethacrylate, were added to the Ru-catalyzed ATRP reaction of SMA and MMA (FIG. 17). Various cross-linker concentrations were tested to obtain maximum cross-linking while preventing macroscopic gelation. After an overnight reaction, an apparent increase in molecular weight and dispersity (Ð>1.65) denoted the efficacy of the cross-linking. Worth noting, addition of cross-linker did not affect the monomer incorporation ratio of SMA to MMA (≈1.1) as determined by ¹H NMR.

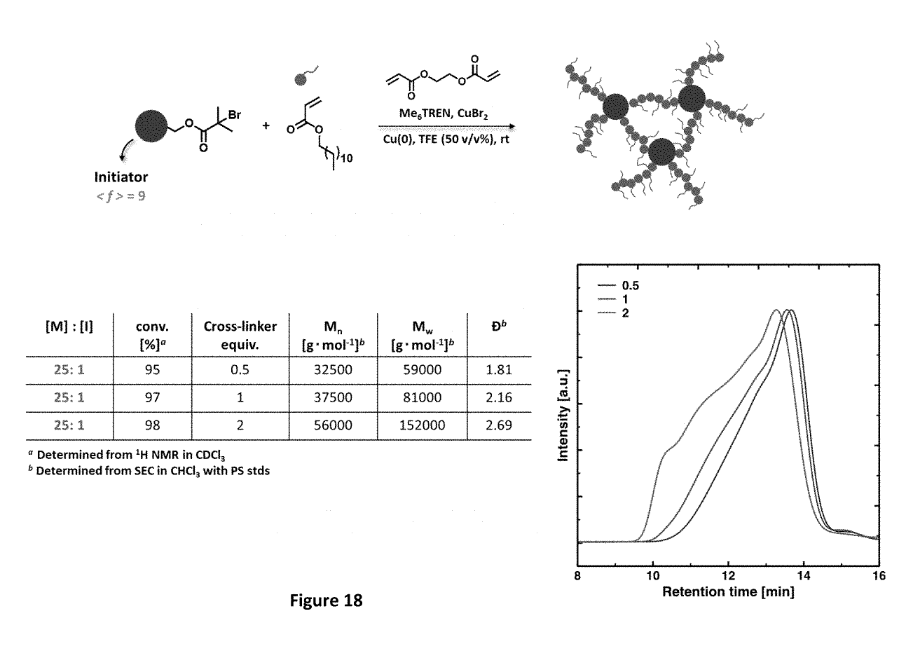

On the other hand, cross-linked poly(LA) hybrid stars were obtained by adding various amounts of ethylene glycol diacrylate (0.5, 1, 2 and 10 equiv. with respect to the inorganic core) to the same reaction conditions used to graft poly(LA) arms (FIG. 18). SEC analysis showed a clear high molecular weight shoulder with the addition of 0.5, 1, and 2 equivalents of the cross-linker and a significant increase in the molecular weight distribution, endorsing the efficiency of the reaction. Meanwhile, the addition of 10 equivalents of the diacrylate generated an insoluble gel that could not be characterized by either NMR or SEC.

The following sections 2-4 describe characterization of one or more of the Examples.

### CHARACTERIZATION EXAMPLES

2. Thermal properties of additive-containing base oil solutions. Before evaluating the boundary lubricant and bulk viscosity improving performance, the thermal stability/properties of the additives and their solutions in Yubase 4 were determined. Firstly, the thermal stability of the neat p(SMA-co-MMA) derivatives was assessed by thermal gravimetric analysis (TGA). The decomposition temperature (T_{d5%}), defined as the temperature at which the materials lose 5% of their original weight, proved to be above 205° C. for all neat additives and the pure base oil (Table 1). The thermal stability of Yubase 4 solutions containing 2 wt % of the various additives decreased marginally as evident from slightly lower decompositions temperatures. Nevertheless, for all solutions, the T_{d5%} remained above 190° C. which is significantly higher than typical automotive lubricant operating temperatures (100° C.). [1, 3]

TABLE 1
Thermal properties of poly(stearyl methacrylate-co-methyl methacrylate)
(p(SMA-co-MMA)) based additives, neat and as 2 wt % solutions in
Yubase 4.

| | | Neat | | | 2 wt % solution | | |
|---|---|---|---|---|---|---|---|
| Entry | Additive | Tₘ^{a} | T_{c}^{a} | T_{d5%}^{b} | Tₘ^{a} | T_{c}^{a} | T_{d5%}^{b} |
| 1 | —^{c} | — | — | 210 | — | — | — |
| 2 | Linear | 25 | 12 | 240 | — | — | 235 |
| 3 | MB-7980 | 25 | 11 | 265 | — | — | 205 |
| 4 | IC-star₆ | 25 | 10 | 245 | — | — | 190 |
| 5 | OC-star₈ | 21 | 4 | 265 | — | — | 230 |
| 6 | IC-star₉ | 23 | 9 | 250 | — | — | 205 |
| 7 | Oligo-IC- | 24 | 10 | 205 | — | — | 200 |
| | star₉ | | | | | | |

^{a}Determined from the peak temperature of the DSC curve at a heating/cooling rate of 10° C./min under N₂ atmosphere.
^{b}Determined by TGA at 5% loss of initial mass at a heating rate of 10° C./min in presence of O₂.
(—) indicates no signal was measured within the probed temperature window.
^{c}pure Yubase 4.

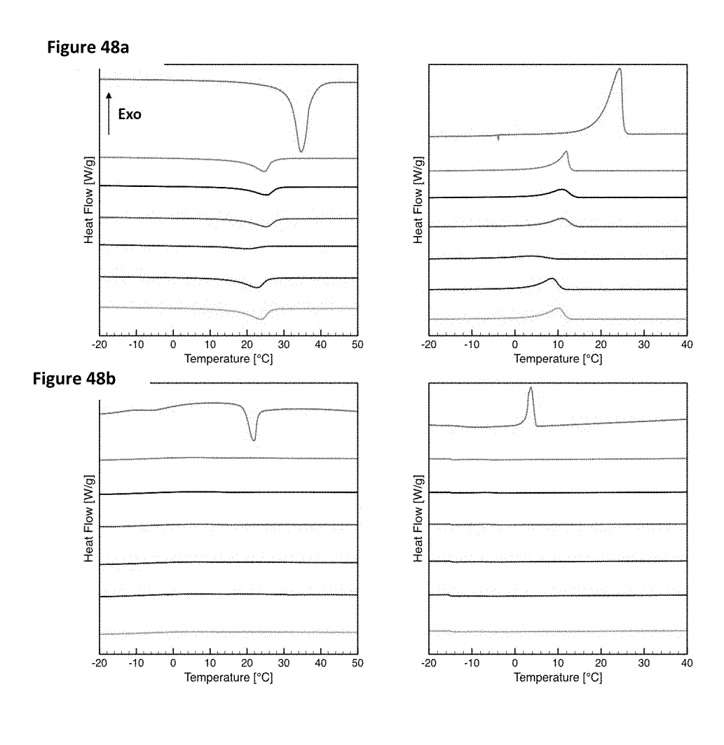

Thermal properties of the neat additives and their Yubase 4 solutions were probed using differential scanning calorimetry (DSC, see Section S4 for thermograms). The thermal history of each sample was set to be the same by subjecting them to three subsequent heating and cooling cycles. The thermograms of all the p(SMA-co-MMA) derivatives revealed broad endothermic and exothermic signals at ˜25° C. and ˜10° C., respectively (Supporting Information S4, FIG. 48a). We hypothesize that the observed broad melting peaks are the result of SMA crystalline domains perturbed by the random incorporation of the shorter MMA side chains. [49-51] The validity of this premise was obtained by synthesizing and measuring the thermal properties of an inorganic-organic hybrid star polymer containing p(SMA) homopolymer arms (employed initiator=IC₉-Br). In contrast to the weak melting signals obtained for the SMA-co-MMA copolymers, a sharp melting transition was observed for the p(SMA)-based star. Evidently, this is related to a more regular, three-dimensional, periodic arrangement of the pendent alkyl chains into liquid crystalline segments, since there are no MMA units incorporated to break up these ordered domains.

Performing DSC measurement on Yubase 4 solutions containing 2 wt % of the p(SMA-co-MMA)-based additives gave completely flat thermograms without any discernable thermally induced transitions (Supporting Information, FIG. 48b). This is a strong indication that the low degree of ordering observed in the neat additives does not persist in the base oil solutions and that the polymers are fully solvated. In sharp contrast, p(SMA) homopolymer derived stars displayed melting and crystallization signals, even in solution (Supporting Information, FIG. 48, yellow curves). The persistence of order when dispersed in the base oil negatively impacts additive solubility, further motivating our choice of statistical copolymers of MMA and SMA.

3. Bulk viscosity improvement

3.1 Viscometry—Effect of polymer topology. To elucidate the effect of topology and chemistry on the swelling capability, detailed temperature and concentration dependent zero-shear viscosity measurements for the synthesized additives dissolved in a (model) base oil of interest were performed. The obtained data was used to extract intrinsic viscosities ([η]). [η] is a directly related to the polymeric coil dimensions in solution. [52, 53] An increase of [η] can therefore be attributed to swelling of individual polymer chains. Measuring [η] as a function of temperature allows therefore for direct coupling between this fundamental quantity and viscosity improving performance.

[η] is related to the solution viscosity (ηₛ) and the viscosity of the pure liquid (η) as described by Eq. 1, where k_{H} is the so-called Huggins coefficient; a quantity related to the solvent quality. Plotting the left-hand side of Eq. 1 vs. polymer concentration results in linear curves which intersect they-axis at a value equal to [η]. A rolling ball viscometer was used for these measurements since capillary-based viscosity determinations are by far the most precise and in this case required to obtain trustworthy values for [η]. A temperature range of 25-90° C. was used.

$$\frac{η - {η}_{s}}{{η}_{s}} = [ η ] + {{k}_{h} [ η ]}^{2} c \qquad ( 1 )$$

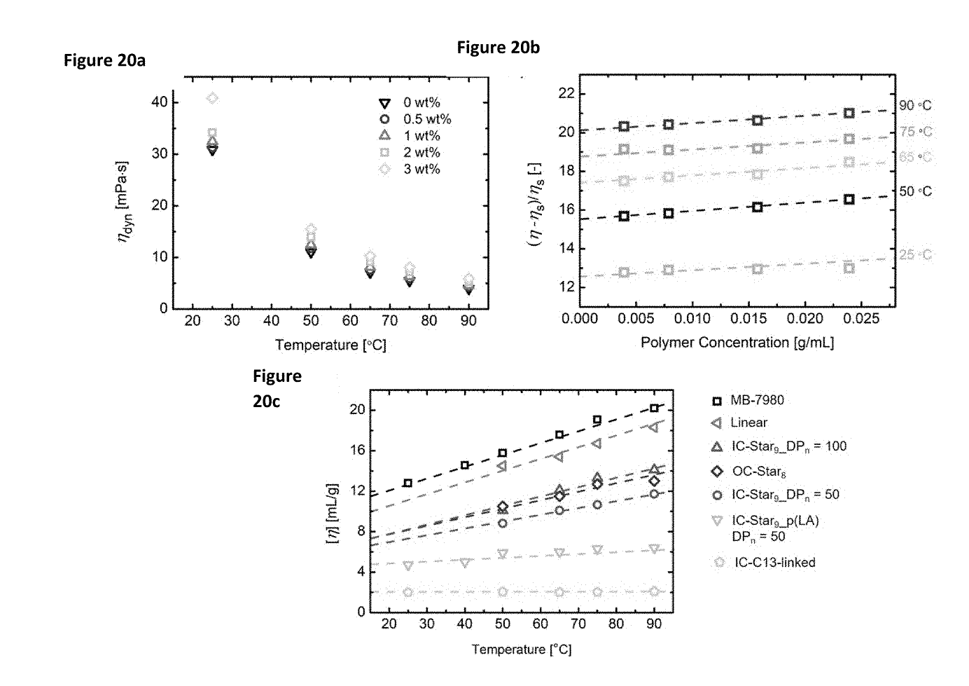

This complete Huggins analysis is shown in FIG. 20 for the benchmark additive MB-7980 dissolved in Yubase 4, the base oil of main interest during this study. Polymer concentrations ranging from 0.5 to 3 wt % were used. Measuring at these low concentrations prevents overlap or interactions between individual polymers and therefore a reliable determination of single coil [η]. Each data point in FIG. 20a is the average of at least 10 individual measurements to ensure statistically reliable results. Processing the temperature dependent viscosity data and plotting it in the functional form giving by Eq. 1 yields FIG. 20b. The obtained [η] are subsequently plotted against temperature to reveal the tendency towards swelling as expressed by the slope of the [η] vs. T graph. The same procedure was performed for linear p(SMA-co-MMA) polymers (grey triangles), p(SMA-co-MMA) based organic star polymer carrying 8 arms (OC-Star₈, FIG. 20c, purple diamonds), and silicon-containing hyper-branched polymer cores grafted with an average of 9 arms (IC-Star₉) with a degree of polymerization (DPₙ) equal to 50 (FIG. 20c, blue circles) or 100 (FIG. 20c, green triangles). IC-Star₉ grafted with poly(lauryl acrylate) was included to investigate the influence of arm chemistry on the swelling capacity in Yubase 4 (FIG. 20c, light grey triangles). Finally, silicon-containing hyper-branched cores cross-linked via short C13 spacers was investigated to probe the necessity of the flexible polymer arms (FIG. 20c, yellow diamonds).

Based on the data presented in FIG. 20c, the following conclusions were drawn:

(1) All p(SMA-co-MMA) based polymers show a significant increase in the intrinsic viscosity upon heating the Yubase 4 based solutions. As mentioned before, this increase is an indication for temperature induced coil expansion and renders these additives potentially high-performing viscosity index modifiers. The slopes of the [ƒ] vs. T curves, a measure for the extent to which the polymer coils can swell, is slightly lower for the star-shaped polymers compared to the truly linear and randomly branched MB-7980 benchmark material. This observation can be rationalized when considering that the swelling capability of polymers is typically inversely proportional to their degree of branching. In contrast to linear polymer, inherently branched star-shaped polymers are more restricted to swelling since all arms are confined onto a single core. Additionally, it is reasonable to assume that the arms of the stars are already slightly stretched because of the excluded volume interactions between the individual arms, [54, 55] leading to a relatively smaller expansion upon increasing the temperature.

(2) The absolute value of [η] is highest for the MB-7980 benchmark material, suggesting that this polymer has the largest coil dimensions in solution. The linear p(SMA-co-MMA) additive follows the benchmark polymer closely, while the p(SMA-co-MMA)-based star polymers have the smallest hydrodynamic dimensions. This trend can again be explained by the fact that star polymers with are hydrodynamically more compact compared to linear analogues (having similar molecular weights) due to the branched architecture. [54, 55] Although disadvantageous for the VI performance, we hypothesize the star polymer will show a superior shear stability compared to linear polymers (as discussed in the Introduction). Naturally, this would yield additives with a longer lifetime when applied under realistic, high shear conditions.

Increasing the DPₙ of the arms from 50 to 100 on IC-Star₉ leads to an increase in [ƒ]. Intuitively, this is to be expected since the arms gain more freedom with increasing length. The observation that MB-7980 has a larger coil volume compared to the truly linear polymer was not expected, since MB-7980 has a lower molecular weight than the linear polymer (Supporting Information Section S2, Table S1, Entry 2) and is randomly branched. At this point we hypothesize that the apparent larger coil volume is caused by weak aggregation of MB-7980 polymers in (model) base oils. Evidently, these aggregates have a higher molecular weight and therefore a higher [ƒ]. This hypothesis is supported by small angle neutron scattering experiments (SANS, see Section 3.4).

(3) Based on the viscosity data we cannot distinguish between the fully organic or organic-inorganic hybrid additives (FIG. 20, green diamonds vs. blue triangles). This observation is consistent with the hypothesis that silicon-containing hyper-branched polymer grafted polymers are star-shaped or branched entities. Clearly, the presence of a more rigid core has no negative influence on the VI performance.

(4) The p(LA) grafted inorganic cores show minimum degree of coil expansion upon heating (FIG. 20c, light grey triangles). Additionally, the absolute values of [η] are significantly lower in comparison with the same cores grafted with p(SMA-co-MMA) arms of similar length. This indicates that the p(LA) polymers are presented in a more collapsed coil conformation and that increasing the temperature does not sufficiently alter the solvent quality of Yubase 4 for the polymer to induce appreciable chain swelling. Therefore, p(LA) based polymers are not expected to be efficient viscosity index improving additives for this particular base oil.

(5) When high molecular weight structures were targeted by simply linking the IC9 cores together via short C13 spacers, no temperature induced swelling was observed (FIG. 20c, yellow diamonds). The absolute values of [η] are low, indicating that these additives hardly contribute to the solution viscosity. The inventors of the present invention believe the absence of swelling capability is based on the chemical structure of this additive. The cross-linked assembly is decorated with only short alkyl chains (—C₆H₁₃), which are not able to undergo a coil-to-globule transition. In addition, the fact that these assemblies consist of cross-linked silicon-containing hyper-branched cores probably translates into an additive which behaves as a relatively rigid object. These measurements exemplify the need for polymeric species if a strong swelling with increasing temperature is desired.

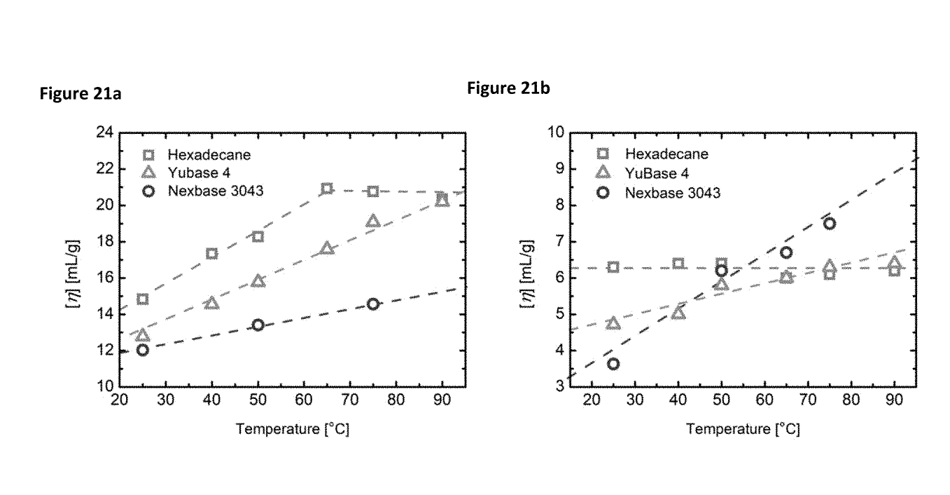

3.2 Viscometry—Effect of the base oil. Inspired by the results in the previous section, where we found a distinct difference in swelling capacity between p(SMA-co-MMA) and p(LA) based additives in Yubase 4, we screened three different solvents to probe the effect of the base oil. In addition to Yubase 4, Nexbase 3043 and n-hexadecane (HD) were selected as second commercial base oil and a molecularly well-defined model oil, respectively. The primary reason for selecting HD as model oil is based on the fact that it represents the chemical structure of the commercial base oils fairly well as it is composed of long, saturated alkyl chains. Additionally, fully deuterated HD is commercially available, making it a useful solvent for SANS measurements (see Section 3.4). Intrinsic viscosities as a function of temperature for the p(SMA-co-MMA) based benchmark MB-7980 and IC-Star₉ grafted with p(LA) arms were determined in these three solvents as shown in FIG. 21. As mentioned before, [η] is directly related to the volume of individual polymer coils in solution. An increase in [η] with temperature indicates coil swelling, which is believed to be responsible for the viscosity improving properties of typical additives.

MB-7980 performs significantly better in Yubase 4 (FIG. 21a, blue triangles) than in Nexbase 3043 (FIG. 21a, red circles). This enhanced performance is exhibited by both higher absolute values of [n] and a steeper temperature dependence of [η]. In HD, MB-7980 showed and even more pronounced temperature induced swelling compared to the commercial oils (FIG. 21a, grey squares). Coil expansion seems to stagnate beyond 65° C. as a constant value for [η] was obtained beyond this temperature. Since polymers cannot swell indefinitely and it is plausible that under these conditions maximal swelling is obtained. In this context, the maximum is set by the balance between enthalpic gain upon creating favorable solvent-polymer contacts (promoting swelling) and decreasing entropic contributions upon chain stretching (counteracting swelling).

Evaluating the swelling capabilities of IC-Star₉ grafted with p(LA) arms yielded strikingly different results. In stark contrast to the p(SMA-co-MMA) polymers, the swelling capability for this p(LA)-based additive is largest in Nexbase 3043. As depicted in FIG. 21b, the VI improving capabilities of this additives are far less pronounced in Yubase 4 (FIG. 21b, blue triangles) as manifested by a much weaker temperature dependence of the intrinsic viscosity. In HD hardly any polymer expansion was measured (FIG. 21b, grey squares).

These detailed viscosity measurements therefore underline that the VI performance heavily depends on the type of base oil and that universal viscosity improving additives are most likely non-existent, meaning that trends observed in one type of base oil cannot be extrapolated to other oils. [1, 2, 7] The chemistry of the polymer arms needs to be tailored to the targeted base oil. Considering that the inorganic cores provided by Mitsubishi Chemical Corporation are compatible with a wide variety of polymerization techniques and monomers (see Section 1), this tunability of the arm chemistry is within reach. This feature ensures wide employability of the inorganic cores as constituents in a variety of commercial base oils.

3.3 High temperature rheological measurements & viscosity index (VI). Combining the high sensitivity of a state-of-the-art rheometer with an oven accessory allows us to determine viscosities of base oil solution containing VII additives under harsher conditions compared to the limited temperature regime previously probed with the viscometer (20-90° C., see Section 3.2). As preliminary experiment to probe thermal stability, the following measurement protocol was developed. Firstly, the sample's viscosity (ηₛ) was measured at 40° C. by performing a shear rate sweep from 0.1-750 cm⁻¹. This ramp in shear rate was followed by a sweep in the reverse direction to ensure no artefacts were measured. To prevent sample loss a Couette geometry was selected. The cup of the geometry was rotated while the inner cylinder was kept stationary, to circumvent Taylor Couette instabilities at higher shear rates. [56] A 20 second pre-shear period was included in the protocol to ensure a homogeneous starting solution before data acquisition.

After data acquisition at 40° C. the sample was heated up to 100° C. and ramping up and down of the shear rates was repeated. Measurements were started after the oven temperature equilibrated at 100±0.1° C. for at least 5 min. The complete cycle was subsequently performed at 120, 140 and 160° C. as well. After completing the data collection at 160° C., the sample was cooled down to 40° C. and the viscosity was determined again at this temperature to probe the effect of the heat treatment. (Thermal) degradation should to result in a drop of solution viscosity since the average molecular weight of the polymeric species decreases. These measurements were performed for pure Yubase 4 and its solutions containing 1 or 2 wt % of the following p(SMA-co-MMA)-based additives: MB-7980, linear, OC-Star₈, IC-Star₉_{_}DPₙ=100, IC-Star₆_{_}DPₙ=100, and Oligo-IC-Star₉. The measurements were limited to p(SMA-co-MMA)-derived additives, since zero-shear viscosity data showed that this class of polymers shows most promise to behave as high performing viscosity index improving additives.

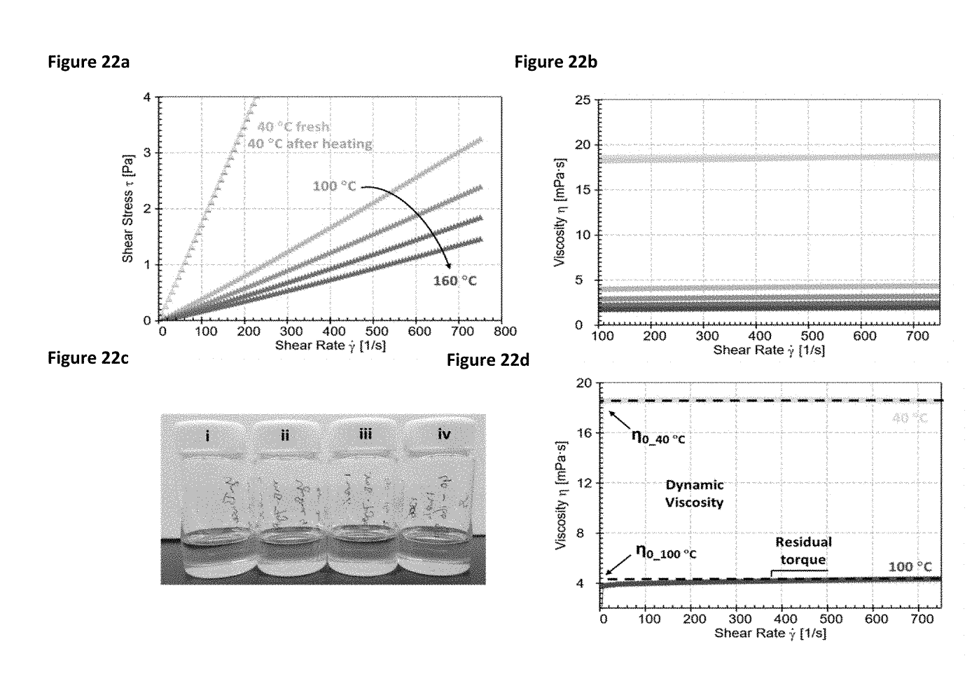

The raw data obtained from the high-temperature rheometer measurements for Yubase4 solutions containing MB-7980 is depicted in FIG. 22 and is representative for the other additives. A linear relationship between the applied shear rate and measured shear stress was found, indicating that these dilute polymer solutions behave as Newtonian fluids (FIG. 22a). The viscosity of such fluids is constant and is equal to the slope of the shear rate vs. shear stress curves. The minimal deviation from a constant ηₛ with applied shear rate (FIGS. 22b and d) is caused by residual torque of the instrument. ηₛ decreases with increasing temperature and no anomalous behavior was observed due to the presence of the polymers. Re-measuring at 40° C. after heating the samples up to 160° C. yielded similar ηₛ as measured for the fresh sample indicating the absence of polymer/base oil disintegration (FIG. 22b, pink and grey data points). The slight mismatch in viscosity was attributed to temperature drift during the measurement. Visual inspection of the samples showed no coloration, indicative of the absence of heat induced oxidation reactions (FIG. 22c). These initial experiments show that both the pure base oil and the p(SMA-co-MMA) derived additives are thermo-stable up to at least 160° C. for several hours (time required to measure one sample at all temperatures). Naturally, prolonged exposure of the oils might lead to degradation. Nevertheless, given the fact that in automotive applications lubrication oils are typically not exposed to temperatures higher than 110-120° C., these preliminary results are encouraging. [1, 3]

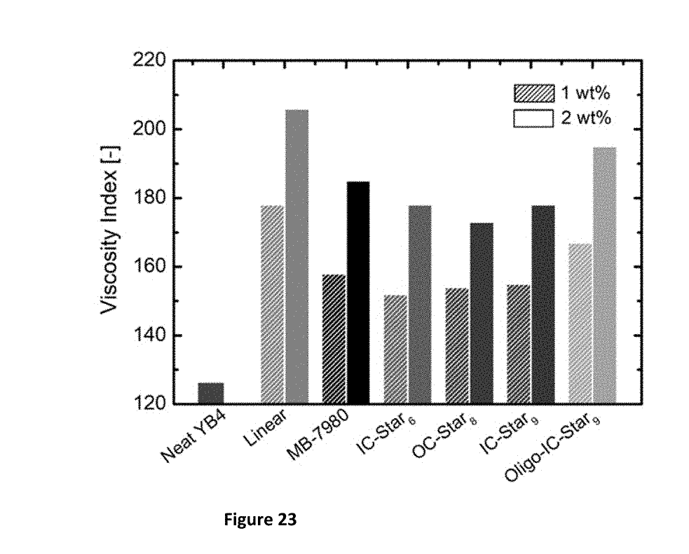

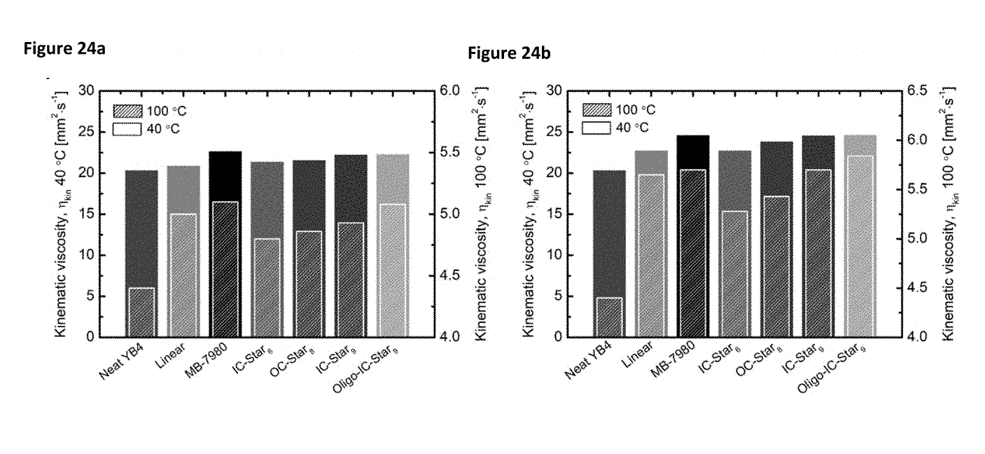

The data obtained from the high-temperature rheological measurements did not only gain insight in the thermal stability but can also be used to calculate the viscosity index (VI) of the solutions. The VI is a typically employed unit-less performance indicator expressing how temperature sensitive the solution viscosity is within a temperature window ranging from 40 to 100° C. [57] The higher the VI, the less sensitive the solution viscosity is towards temperature changes. As mentioned in the Background of the Invention, maintaining solution viscosities above a minimal value is essential to ensure efficient lubrication at the elevated operating temperatures commonly found in (automotive) applications. Herein, we use the VI as a metric to evaluate the viscosity improving performance of the synthesized additives by comparing the VIs of Yubase 4 samples containing the different additives. Polymer concentrations of 1 and 2 wt % were considered for this purpose. The results are summarized in FIG. 23 Evidently, all synthesized additives behave as viscosity improvers as manifested by an increase in VI (to values between 152 and 206) upon polymer addition, with respect to the neat base oil (VI of 126). Unsurprisingly, increasing the polymer concentration from 1 to 2 wt % leads to higher VI values. The increase in VI after polymer addition is mainly attributed to a significant elevation of the kinematic viscosity (ηₖᵢₙ) at 100° C. (FIG. 24, stripped columns), while the low-temperature viscosity remains relatively unaffected (FIG. 24, solid columns). This behavior is beneficial for typical (automotive) engine environments, since it safeguards efficient lubrication at elevated service temperatures (≈100° C.), while practically retaining the cold-starting facility of the neat base oil. [8]

Evaluating viscosity index improvement according to polymer topology reveals a decreasing trend with increasing degree of branching within the polymeric structure. The VI gradually increases going from the star polymers (FIG. 23, red, purple, green) via the randomly branched additive (FIG. 23, black) to a truly linear polymer (FIG. 23, grey). This trend is consistent with the generally accepted mechanism for polymethacrylate based viscosity improvers, which rely on a temperature-induced coil expansion for their performance. [1, 2, 5, 9] The swelling capability of polymers is typically inversely proportional to their degree of branching, making the truly linear polymers the most efficient viscosity improvers. Star polymers, inherently branched structures, are more restricted to swelling. Additionally, it is reasonable to assume that the arms of the stars are already slightly stretched because of the excluded volume interactions between the individual arms, [52, 54] leading to a relatively smaller contribution to the solution viscosity at elevated temperatures. Worth noting that no significant differences between the fully organic and the hybrid stars were observed, implying that the core chemistry has no influence on the temperature-induced response of the arms. Increasing the average number of arms per star from 6 to 9 had no distinct effect on the measured VI. We speculate that the comparable performance of the stars is related to limited changes in polymer conformations in the bulk, since the radius and therefore degree of stretching of the individual arms depend only weakly on f [54, 55]

The free-radical based polymer (MB-7980) is best described by having an undefined, although moderately branched topology, positioning its performance in between those of the purely linear and star polymers (FIG. 23, black). Oligo-IC-Star₉ seems to be an exception to this trend. Despite the cross-linked structure of this additive, a relatively high VI was obtained (FIG. 23, orange). We believe that this is due to the extremely high molecular weight of this polymeric structure. The effect of topology is therefore completely overshadowed by its hydrodynamic dimensions.

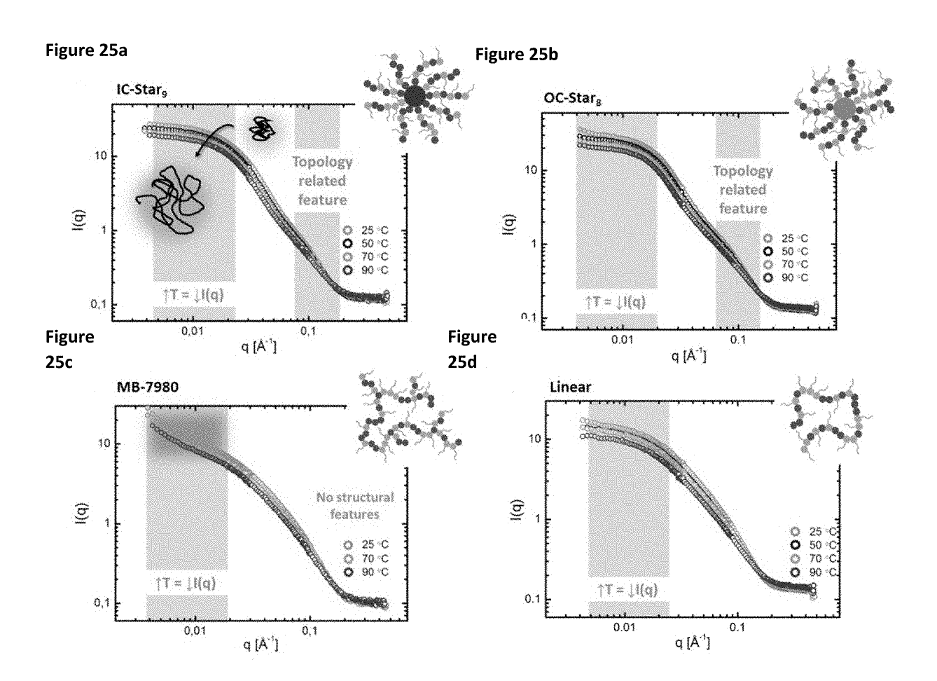

3.4. Temperature-dependent small angle neutron scattering (SANS). The temperature dependent solution behavior of MB-7980, linear p(SMA-co-MMA), IC-Star₉_{_}DPₙ=100, and OC-Star₈_{_}DPₙ=100 was probed using small angle neutron scattering (SANS). Deuterated n-hexadecane was used as solvent since it combines high scattering contrast with a reasonable chemical match to realistic base oils. Polymer concentration of 2 wt % were used, ensure we are in the dilute concentration regime, i.e., no overlap of polymer coils. FIG. 25 depicts the temperature dependent scattering profiles obtained by plotting the scattering intensity (I(q)) vs. wave vector (q) for the 4 additives. For all polymers, the scattered intensity in the low q-regime decreases with increasing temperature. This loss in intensity can be interpreted as a diminished scattering contrast between the polymers and the background solvent caused by a more efficient solvation of the polymer globules. This interpretation is in agreement with the mechanism for efficient viscosity improving polymers and the temperature-induced swelling previously probed with viscometry (Section 3.2).

The scattering profiles of the star-shaped polymers (FIGS. 25a and b) are strikingly similar and both reveal a characteristic feature at approximately q=0.1 Å⁻¹. This feature is related to the topology of these polymers and reflects the scattering from the interface between the core and the grafted arms. Since the organic star has a chemically well-defined core providing certainty that these polymers possess a star topology, the similarity between the scattering profiles provides strong evidence that the silicon-containing hyper-branched core-derived polymers also have a star-shaped topology. However, we must not that the profiles do not provide any information on the shape of the inorganic core or the distribution of arms. The scattering feature is absent for the linear and MB-7980 benchmark polymer (FIGS. 25c and d), which is consistent with the absence of any strong topological constraints.

In addition to these quantitative observations on the shape of the scattering profiles, more information was extracted from these profiles by analysis of their asymptotic behavior. At low q, in the so-called Guinier regime, the scattering profiles can be described by Eq. 2, where R_{g} is the radius of gyration; a physical quantity directly related to the polymer coil size. In the Guinier regime, plotting ln(I(q)) vs. q² should yield straight lines with slopes equal to R_{g}²/3. [58]

$$I ( q ) ≅ I ( 0 ) exp [ - \frac{- {( {qR}_{g} )}^{2}}{3} ] \qquad ( 2 )$$

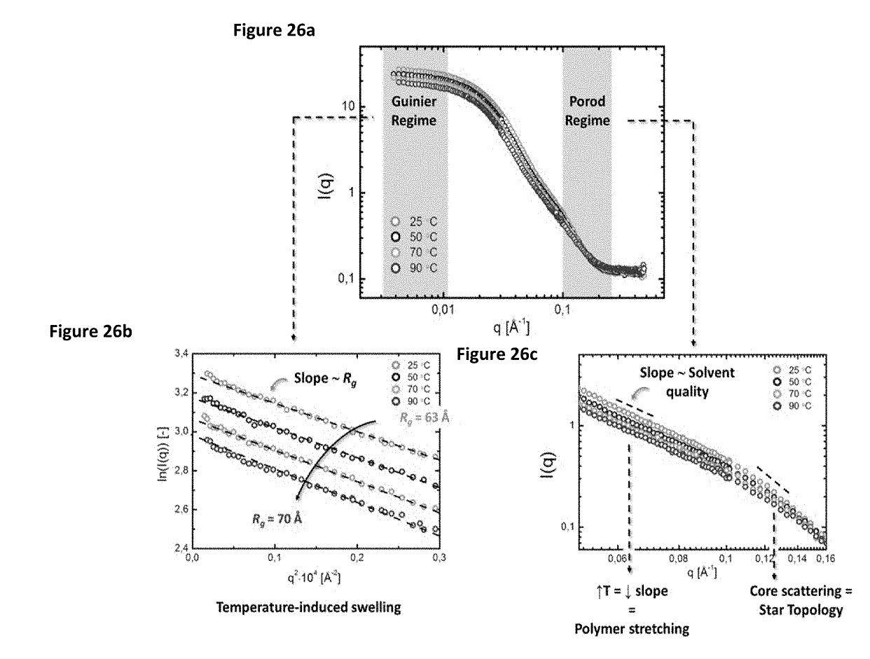

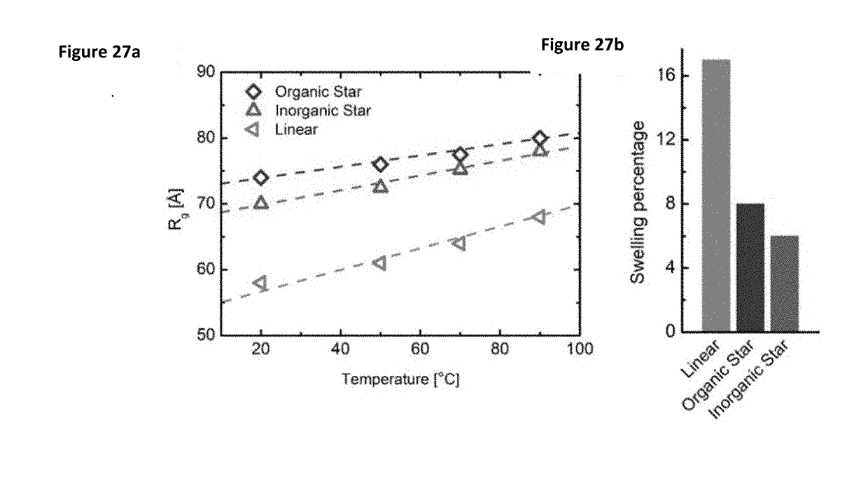

As a representative example, this Guinier analysis is illustrated in FIG. 26b for IC-Star₉. By determining R_{g} as a function of temperatures provides direct insight in the swelling capacity of these p(SMA-co-MMA) additives. The results of his Guinier analysis are summarized in FIG. 27 for IC-Star₉ (green), OC-Star₈ (purple), and the linear polymer (grey). Again, it was observed that all the considered additives swell as a function of temperature. The variation in absolute size is directly related to a difference in molecular weight (Table S1, Entry 1, 4, 5). Calculating the swelling percentage, here defined as difference in R_{g} determined at 20 and 90° C. divided by the R_{g} at 20° C., reveals that the star-shaped additives swell significantly less compared to their linear counterpart (FIG. 27b). This observation is in agreement with the rheological data (Section 3.2 and 3.3) and can be related to topological constraints that are introduced when moving from linear to the branched, star-shaped architectures.

The Guinier analysis could not be applied reliably to the scattering profiles of MB-7980 (FIG. 25c). Unlike the profiles for the star polymers, the profiles for MB-7980 do not plateau at low q, making it not possible to define a constant slope in the low q-regime according to Eq. 2. The excess scattering at low q (FIG. 25c, highlighted in red) is associated with structures forming on larger length scales and could for example be caused by (weak) aggregation of individual polymer chains (note: the SANS measurements were performed at a concentration 5 time below the overlap concentration (c*). Excess scattering is not caused by simple overlap of polymer coils). Although the molecular origin of this aggregation is not clear, it does explain the excellent VI performance of MB-7980. In the aggregated state, the effective molecular weight of the dispersed entities is higher, leading to a larger contribution to the solution viscosity. This hypothesis is in agreement with the most pronounced temperature sensitivity and highest values obtained for [η] (see Section 3.2, FIG. 20).

Besides the low q regime, the slope of the profiles at high q (Porod regime) provide information on the fractal dimensions of the polymers. FIG. 26c depicts representative results obtained for IC-Star₉. To determine the slopes at greater precision and reveal all features in the scattering profiles, a background subtraction was performed. After this subtraction a decrease in the slopes of the scattering profiles with increasing temperature was observed. This observation is related to an increase in fractal size or polymer stretching, again indicative for temperature-induced swelling. Additionally, exclusively for the star-shaped polymers, a q-regime with a slope of approximately −3.8 was found. This is diagnostic from scattering of the interface between the core and the grafted polymers. [58, 59] The presence of these two regimes with distinctly different slopes therefore further confirms the star topology of both IC-Star₉ and OC-Star₈.

In summary, SANS measurements provide us with the following key insights:

1) In agreement with viscometry data, the p(SMA-co-MMA)-based additives swell as a function of temperature as evident from an increase in R_{g} upon heating.

2) The scattering profiles of IC-star₉ shows the same characteristic features as OC-Star₈, suggesting that IC-star₉ has the star-shaped topology.

3) MB-7980 shows signs of (weak) aggregation in HD, which might be (partially) responsible for the larger values for the [η].

4) The linear polymer shows relatively larger degrees of swelling compared to the star-shaped additives.

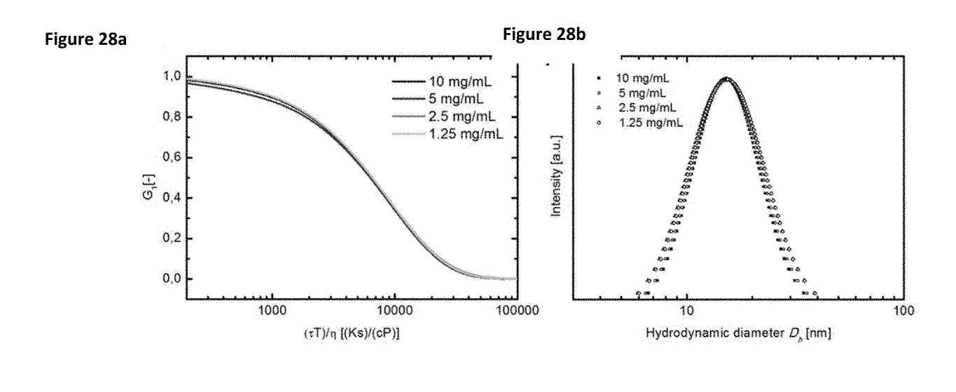

3.5. Temperature-dependent dynamic light scattering (DLS). Dynamic light scattering (DLS) measurements were conducted to complement the SANS measurements described in Section 3.4 and provide an independent characterization technique to probe temperature induced coil expansion. DLS was performed on MB-7980, linear p(SMA-co-MMA), IC-Star₉, and OC-Star₈ dissolved in n-hexadecane or Yubase 4. To ensure sufficient scattered intensity relatively high polymer concentrations were required (10 mg/mL). This is especially true in Yubase 4, where the polymers scatter significantly less than in HD. To verify that these higher concentrations are still below the overlap concentration (c*) of the polymers and therefore allow for probing individual coils, DLS measurements were performed on a dilution series of MB-7980 in HD (FIG. 28). The polymer concentration was varied between 10 and 1.25 mg/mL. Regardless of the concentration, no significant changes were observed in the normalized correlation functions (FIG. 28a) or extracted size distributions (FIG. 28b), indicating the absence of polymer-polymer interactions. Based on this result, a polymer concentration of 10 mg/mL was employed for all subsequent measurements.

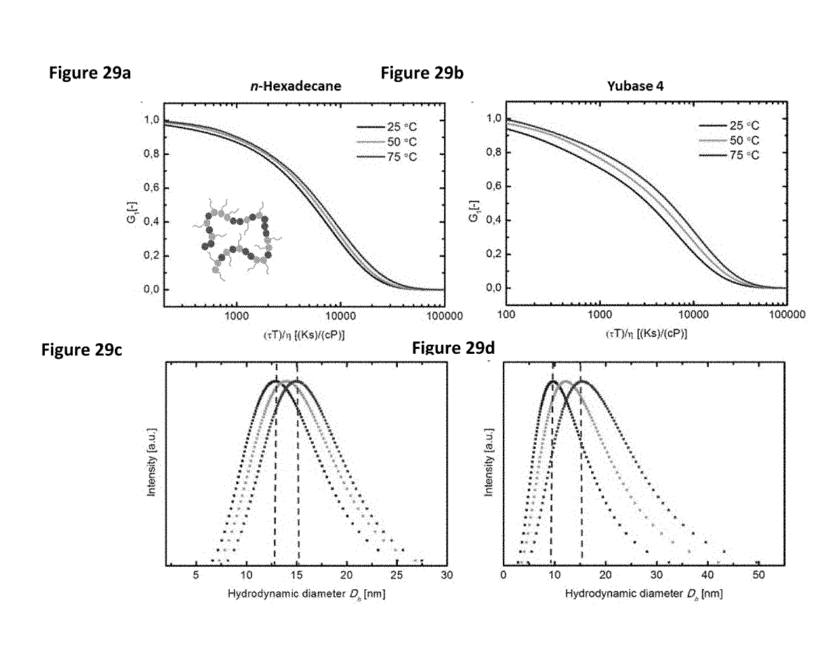

FIG. 29 depicts the DLS results obtained for linear p(SMA-co-MMA) in both HD (FIGS. 29a and c) and Yubase 4 (FIGS. 29b and d) as a function of temperature. The scattering data was obtained after a 15 min equilibration period to ensure the samples were at the set temperature. To facilitate direct comparison between scattering data obtained at different temperatures and correct for the temperature dependency of the solvent viscosity, the correlation functions were plotted against the reduced delay time t′. t′ is defined as the delay time (τ) multiplied by the temperature (T) and divided by the viscosity (η) of the dispersing medium at the set temperature. Heating the additive containing samples sample from 25 to 75° C. led to a minor increase in the characteristic decay time, indicative for an increase in hydrodynamic size (FIGS. 29a and 29b). More quantitatively we can extract temperature-dependent hydrodynamic diameters (Dₕ) from the correlograms (FIGS. 29c and 29d). In agreement with the shifts observed in the correlation functions, an increase in Dₕ from approximately 11 to 16 nm was observed upon heating the HD based samples from 25 to 75° C. This small shift in dimensions is in agreement with the values for R_{g} obtained from SANS measurements (Section 3.4) and estimated from intrinsic viscosity measurements (Section 3.3).

Comparing the results obtained in HD with those in Yubase 4 reveals that the degree of swelling, loosely defined as the shift in peak maximum of the size distribution (FIGS. 29c and d, dotted vertical lines) is more pronounced in Yubase 4. This behavior is caused by the fact that the polymer coils are more compact in this solvent at 25° C., giving them more swelling capacity over the probed temperature range. The compactness of the polymer coils implies that Yubase 4 is not solvating the polymers as good as HD, especially at lower temperatures. This observation is in line with the rheological measurements to determine the VI (FIG. 24). Here it was shown that the presence of polymers had only a marginal effect on ηₛ at 40° C., while significant thickening of the additive containing solutions compared to the pure base oil was observed at 100° C. As mentioned before, this behavior is beneficial for typical (automotive) engine environments, since it safeguards efficient lubrication at elevated service temperatures (≈100° C.), while practically retaining the cold-starting facility of the neat base oil. [8]

The seemingly lower solvent quality of Yubase 4 is also reflected in the asymmetric shape of the DLS size distributions. While in HD the polymers display symmetric distributions, in Yubase 4 the distributions tail toward larger hydrodynamic dimensions. This tailing is indicative for (weak) polymer aggregation. This polymer clustering could be responsible for the good VI performance of the p(SMA-co-MMA) based additives. Indications for clustering were previously observed in SANS measurements for MB-7980 (Section 3.4, FIG. 25c).

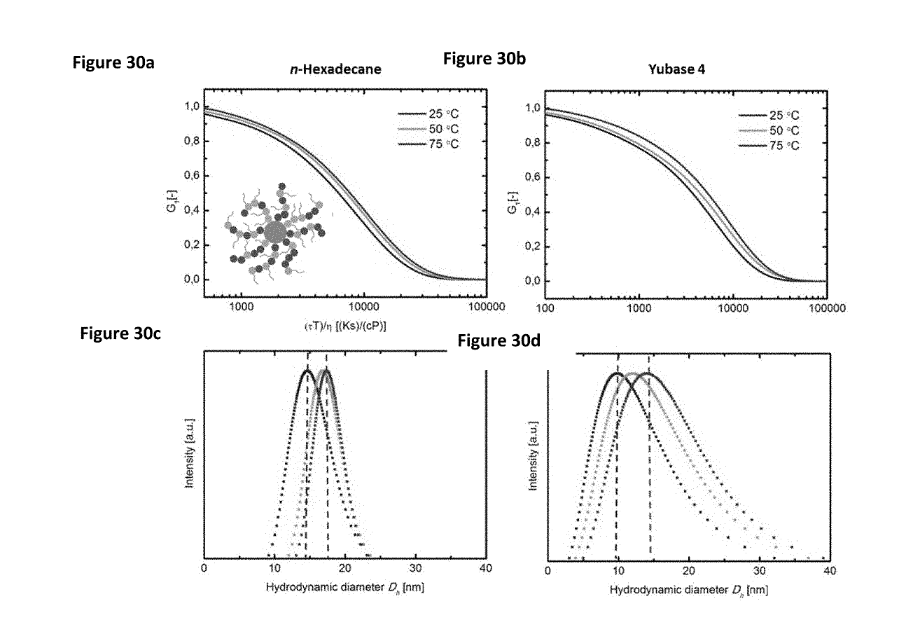

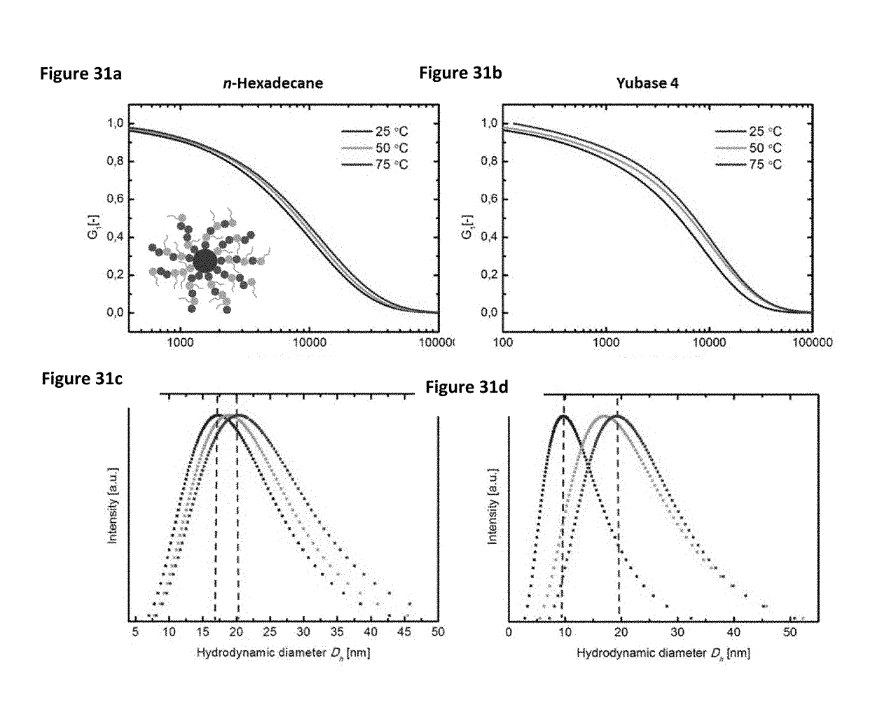

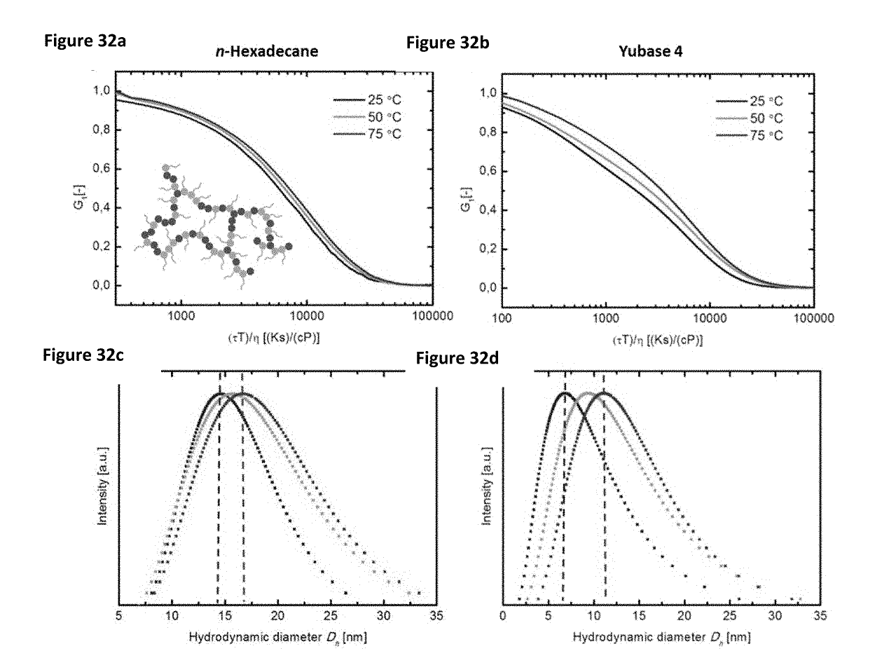

The trends described here are valid for all p(SMA-co-MMA) based additives. The differences observed in size distributions are most pronounced for the linear and OC-Star₈ polymers (FIGS. 29 and 30). In contrast to MB-7980 and the inorganic core stars, these additives have a significantly lower polydispersity, i.e., distribution in molecular weight. This translates to narrower size distributions and solvent/temperature induced changes on these distributions are more easily identified. These subtle changes are less pronounced for the more polydisperse materials (MB-7980 and IC-Star₉), since they are overshadowed by the inherent broadness of the size distributions (FIGS. 31 and 32).

This set of DLS data can be summarized in the following key conclusions:

1) In agreement with viscometry and SANS, the p(SMA-co-MMA)-based additives swell as a function of temperature as evident from an increase in Dₕ upon heating.

2) The increase in Dₕ upon heating is larger in Yubase 4 compared to HD. This larger difference is facilitated by the fact that the polymer coils are more compact in Yubase 4 at low temperatures, enabling a relatively larger chain expansion.

3) Tailing of the size distributions to larger dimensions might indicate weak polymer clustering of the polymers in Yubase 4. The formation of clustering was previously observed for MB-7980 in SANS measurements and might play a role in the bulk viscosity improving performance.

4. Boundary lubrication.

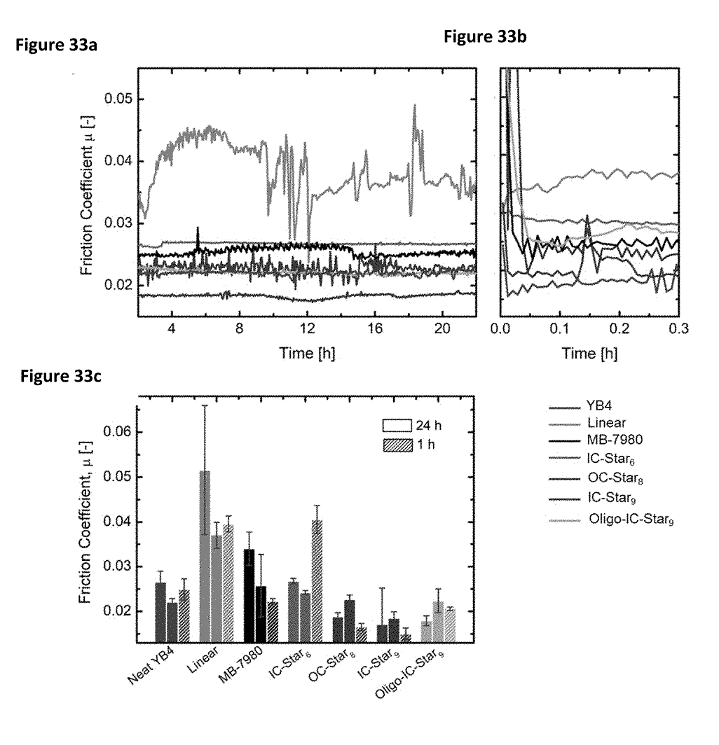

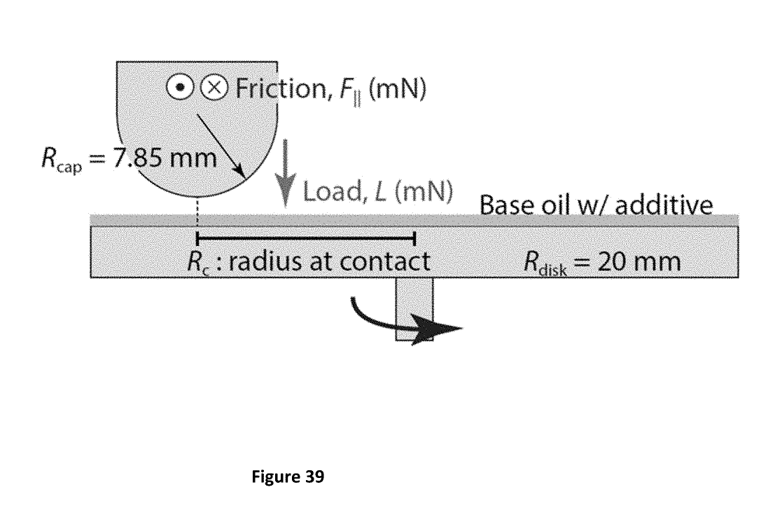

4.1. Friction coefficient measurements. To evaluate the lubrication performance of the synthesized additives we utilized surface force apparatus (SFA) friction measurements. As described in the Supporting Information Section S1 (FIG. 39), the SFA instrument was modified with a high speed (HS) attachment enabling lateral force measurements under extremely high shear (≈10⁷ s⁻¹) for prolonged times (up to 24 h), resembling conditions typically encountered in real-life automotive applications. Averaging over longer periods of time increases reliability of the obtained friction coefficients by eliminating experimental fluctuations. We also tested the friction force over a range of loads, in order to test the linearity of the friction coefficient and determine over what range of loads the friction coefficient is a reliable quantitative parameter. Typical friction coefficient tests are run over short time periods (<1 min) and only at one specified load, meaning the friction coefficient is only truly verified at that one specific loading condition. Additionally, specimens with smooth steel surfaces were employed to mimic engine environments and eliminate the effect of roughness on the measured friction coefficients. Friction coefficients were calculated and plotted as a function of time to compare the lubrication properties during shear of each polymer additive in Yubase 4. An example of the raw data obtained from these HS-SFA experiments, including the load, L (left axis), and friction, F∥ (right axis), as a function of time can be found in Supporting Information Section S8, FIG. 52. The data points were binned every 10 s, and the average friction coefficient for each the best linear fit to the F∥ vs. L plot within one bin. The results obtained using this procedure are summarized in FIG. 33a, which shows the averaged friction coefficient as a function of time for pure Yubase 4 and its solution containing 2 wt % of the p(SMA-co-MMA)-derived additives. During the first 6 min, all solutions, with the exception of the linear p(SMA-co-MMA) (FIG. 33a, grey), show drastic changes in their friction coefficients (FIG. 33b). The additives are likely attaching to the surfaces and undergoing rearrangements during the first few cycles of shear before a stable conformation is reached upon multiple passes over the same location on the disk. During the initial few passes, it is much more likely to see sharp events such as stiction or stick-slip sliding. The friction coefficients then become stable, although the magnitudes of fluctuation differ among the various additives. Remarkably, the significant fluctuations observed for the linear polymers were reproducible, and we hypothesize that this phenomenon is related to the continuous, high load induced ordering of linear molecules and the breakdown of such ordered structure between the two steel surfaces. [24, 26, 60]. The smaller fluctuations in friction coefficients for the other samples are most likely related to sudden mechanical instabilities, commonly observed in this type of prolonged time measurements. To more directly compare the friction reducing capabilities of the different additives, the steady values were averaged over 1 or 24 h shearing period and plotted in FIG. 33c. The 24 h shearing experiments were performed twice to probe the run-to-run variations, while error bars indicate the variations with time upon averaging. The following trends could be extracted from the obtained data set. With respect to pure Yubase 4, addition of linear p(SMA-co-MMA) yields the undesired effect of decreasing the lubricity significantly as the friction coefficient effectively doubles (_{μYB4,24 h}=0.025; μ_{linear,24 h}=0.04-0.05, FIG. 33c, blue and grey, respectively). These results are consistent with the fact that a linear polymer is not expected to perform well as a boundary lubricant due to the tendency to solidify under high compression as a result of molecular ordering or crystallization. This ordered polymer arrangement translates to higher film viscosities and resistance to shear. [24-26, 60] By moving away from a perfectly linear polymer and introducing some random degree of branching (MB-7980), friction coefficients comparable to those observed for the neat base oil were obtained _{μMB-7980,24 h}=0.02-0.035 (FIG. 33c, black). The randomly branched chains prevent excessive molecular ordering due to steric forces. This inability to conform to a more solidified state ensures that the polymer boundary layer remains fluid-like and lubricating under compression. Increasing the degree of branching even further by employing IC-star₆ resulted in a minor decrease in friction reduction compared to randomly branched polymers when the average friction coefficient over a 24 h time frame is considered (_{μIC-star6,24 h}=0.024-0.027) (FIG. 33c, green). However, when the number of arms per star polymer was increased to 8 (OC-star₈) or an average of 9 (IC-star₉, Oligo-IC-star₉), friction coefficients lower than those obtained for the neat base oil were measured (μ=0.02, FIG. 33c, red and orange). The fact that these star-like molecules perform better than MB-7980 suggest that the arms attached to the core behave as flexible, lubricating molecular brushes instead of being severely entangled with neighboring star polymers. In addition to the brush mechanism to enhance lubricity, these compact spherical-like polymers may act as molecular roller bearings between the two metal surfaces to reduce friction even more compared to the slightly, randomly branched polymers. [61]

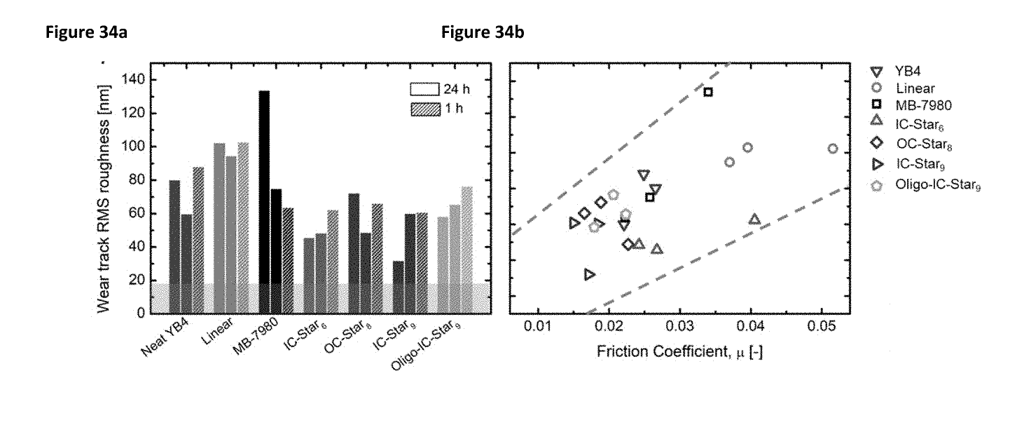

4.2. Wear track analyses & adsorbed layer thicknesses. In addition to measuring the friction coefficients, we set out to investigate the wear protective properties of the tested additives. Wear profiles (for an example, see Section S9, FIG. 53) were measured using profilometry after the previously described shearing experiments to quantify the root mean square (RMS) roughness. Since smooth HS-SFA specimens were used for the shearing tests (RMS≈10-20 nm), shear-induced damage could be determined accurately. FIG. 34a displays the RMS roughness of the most severely damaged section of the wear tracks obtained after shearing Yubase 4 and its additive containing solutions. The grey shaded area at the bottom of the histogram represents the average initial RMS roughness prior to shearing. In line with the trends observed for the friction coefficients (FIG. 33), the star-shaped polymers resulted in slightly less rough wear tracks compared to pure Yubase 4 (the four furthest right samples in FIG. 34a) while linear p(SMA-co-MMA) and MB-7980 yielded wear tracks with more pronounced roughness (FIG. 34a, black and grey bars).

Qualitatively, the RMS wear after shearing and the measured friction coefficients (FIG. 33) as a function of the degree of additive branching show similar trends. This suggests a close relationship between the friction coefficients and severity of surface wear. The RMS roughness is plotted against the friction coefficient (FIG. 34b) for a better visualization of this correlation; all data points are located around a straight line with a positive slope, further highlighting the relationship between the damage of the steel specimens and the measured friction coefficients. Without being able to quantify the roughness during shear, it is unclear whether the higher friction coefficients lead to higher degrees of wear, or the onset of wear leads to higher friction coefficients, both of which are plausible. Nevertheless, the wear track data does indicate that the polymers with a star-shaped architecture promote surface protection in comparison with the neat base oil and linear/randomly branched polymers.

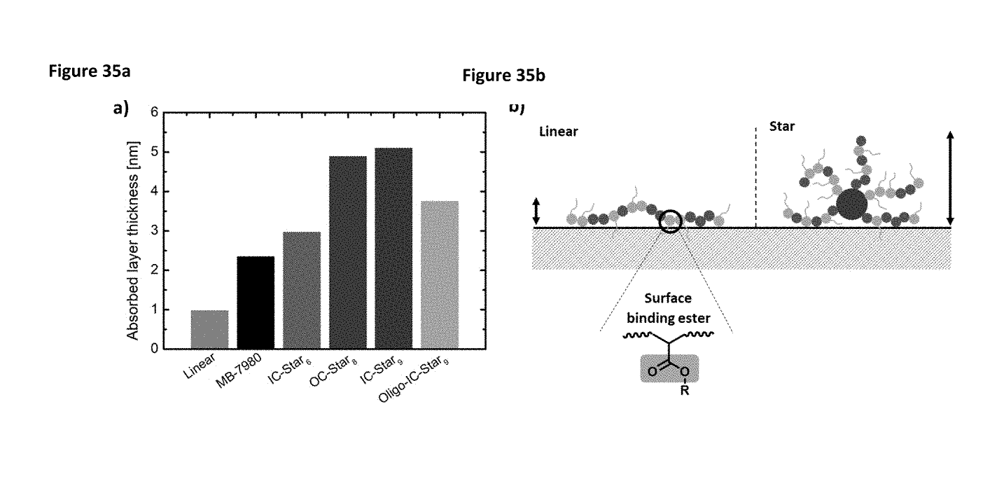

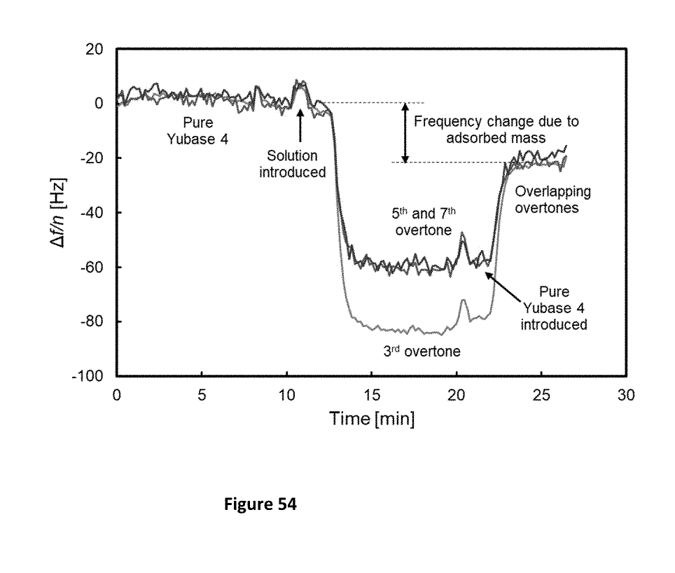

To verify that the surface protecting and friction reduction properties of the additives are related to the formation of an absorbed polymer boundary layer, we used quartz crystal microbalance (QCM) analysis. Quartz sensors coated with iron oxide were selected to mimic steel surfaces (which are typically more than 93% iron oxide). Yubase 4 was found to be non-absorbing to these surfaces even after 15 min of exposure, allowing us to determine the change in frequency only due to additive absorption. Absorbed layer thicknesses were measured after introducing Yubase 4 solutions containing the different additives and flushing the QCM chamber with pure base oil to remove weakly adsorbed polymers (for experimental details see Supporting Information Sections S1 and S10). The layer thicknesses, calculated using the Sauerbrey equation (Eq. S4), are summarized in FIG. 35a. Judging from the overlapping overtones (see Supporting Information S10, FIG. 54) all polymer layers can be interpreted to behave like rigid added layers. The additives under investigation do not contain any functional moieties, e.g., carboxylic acids or amines, that can act as surface tethering points, which leaves the fairly polar ester groups from the incorporated monomers to participate in the adhesion to the iron oxide surface. The lyophilic backbone or SMA-derived pendent chains are not likely to drive the adsorption, since the neat base oil, composed of pure hydrocarbons, did not show any adsorbed mass. These results indicate that addition of specifically designed surface binding groups in the polymer architecture is not an absolute necessity for boundary film formation. [21, 62] The thin absorbed layers observed for the linear and randomly branched additives (FIG. 35a, grey and black) suggest that these polymer chains lay flat on the surface, indicative of fairly strong adsorption (FIG. 35b, left). This flat orientation is further emphasized when realizing that the radii of gyration (R_{g}), a measure of the coil dimensions in bulk solution, are significantly larger than the adsorbed layer thickness (Table S1, Entry 1 and 2). However, we must note that R_{g}'s were determined in chloroform, while the QCM studies were performed in Yubase 4. Evidently, changing the solvent (quality) might have a significant effect on the coil dimensions. Nevertheless, trends in observed in the dimensions are expected to be solvent independent. Having comparable values for R_{g} in the bulk, MB-7980 chains form a thicker absorbed layer compared to the truly linear polymers, consistent with the inherently three-dimensional structure imposed by the cross-links of the branched polymer. Increasing the configurational constraints on the polymer chains even further and employing a star polymer architecture, resulted in slightly thicker adsorbed layers (FIG. 35, green, purple, orange). Comparing the layer thicknesses to the R_{g} values reveals a striking numerical resemblance (Table S1, Entry 3-5). This suggests that the star polymers use a fraction of their arms to adhere to the surface, while the rest of the arms remain exposed (FIG. 35b). This polymer configuration might be stabilized by the fairly polar cores being able to interact with the surface. As a consequence of this surface configuration, the free arms are able to behave as a molecular brush providing the previously observed decrease in friction coefficient and anti-wear characteristics.

Finally, Oligo IC-star₉ surprisingly showed a thinner adsorbed layer compared to the monomeric star polymers, despite its significantly larger dimensions (FIG. 35a, yellow, Table S1, Entry 6). Although not completely understood, this observation could be related to the number of free arms available for surface adhesion. Additionally, covalently linking arms of multiple stars is potentially leading to decreased molecular flexibility, hampering equilibration of the polymeric additive on the surface to find an optimal adsorption configuration.

5. Probing shear stability using high pressure homogenization

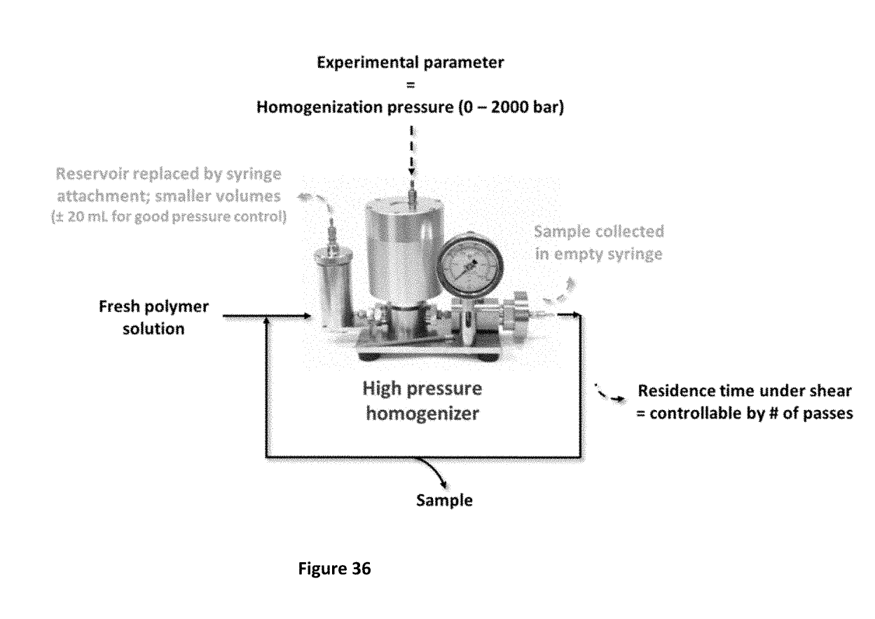

One of the key hypotheses of this project is that star polymers with an inorganic, silicate core are more resilient against mechanical degradation. For polymers in elongational flow, the maximal stress is located in the center of the polymers. [11, 62] Having a hyper-branched inorganic network at this location would therefore results in better shear stability translating in longer operating windows in (automotive) applications. In order to get preliminary data on the shear stability of the synthesized additives, we set out to use a benchtop, high pressure homogenizer (FIG. 36). In this set up, the solution containing the polymers were forced through a small channel equipped with a pneumatically controlled, dynamic homogenizing valve operating at a back pressure of 1500 bar (lower pressures proved to be incapable of inducing chain scission). The exact shear rate that is generated at this pressure is unknown due to the complicated flow geometry in the device, although we estimate shear rates on the order of 10⁵-10⁶ s⁻¹ are achievable. Besides the pressure as experimental knob, we can also control the time over which the polymers are subjected to high shear by the number of passes through the device.

To test the feasibility of using the high pressure homogenizer for the scission of polymers, a set of model shearing experiments on monodisperse, high molecular weight polystyrene (p(St)) polymers were performed. These experiments allowed us to establish relevant shearing times, i.e., number of circulations through the device and to estimate the minimum required molecular weight that the polymer need to have to undergo chain breakage. Only polymers of sufficient length will be affected by the applied shear since the stress (a) that a chain feels at a fixed shear rate is proportional to the number of repeating units (N) of the polymer squared. Because of this sensitive chain length dependence, there will be a sharp molecular weight cut-off below which polymers will not undergo scission.

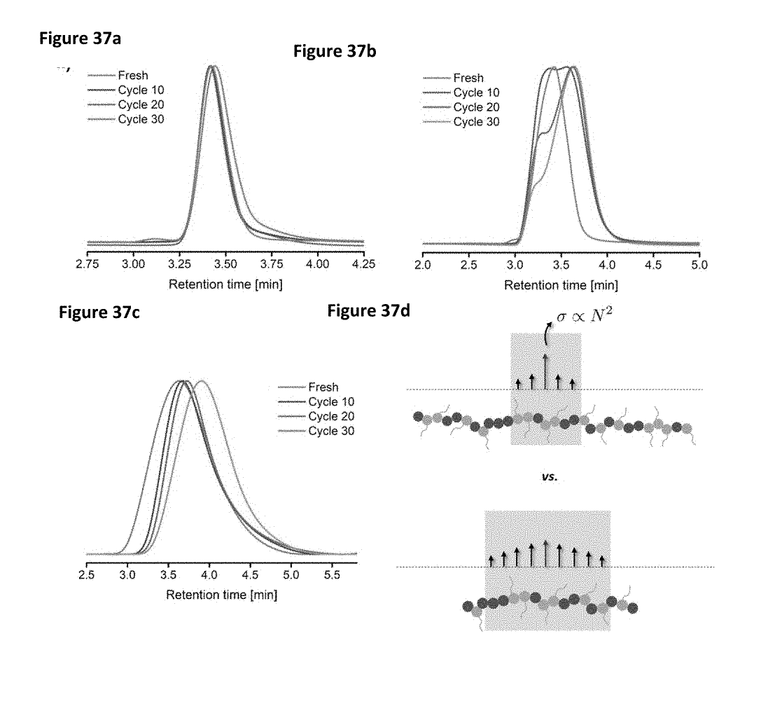

Two linear polystyrene polymers with narrow molecular weight distributions (Ð=1.05) centered around 200 kDa and 400 kDa were used. Shearing experiments were performed on 3 wt % solutions in chloroform (CHCl₃). Chloroform was selected as solvent, since it facilitates post-shearing GPC analysis to monitor the evolution of the molecular weight distribution as a function of accumulated shearing time and therefore assess the degree chain scission. The solutions were passed through the homogenizer for 30 cycles (residence time is on the order or minutes). GPC samples were taken from the sheared solution after 10, 20, and 30 cycles (FIG. 37). The 200 kDa p(St) (FIG. 37a) was only marginally cleaved as evident from the development of a small tail at longer retention time (=lower molecular weight). The main distribution of polymers remained virtually unaffected by the applied shear. In sharp contrast, the 400 kDa polymers underwent significant scission. The fresh polymer (FIG. 37b, grey) had a monomodal molecular weight distribution centered around a retention time of 3.4 min. Upon passing the polymers through the homogenizer, the distribution broadens and splits into a trace with two maxima. The second maximum is located at longer retention times and therefore represents to cleaved polymers with a significantly lower molecular weight. Upon increasing the high shear residence time, the signal corresponding to the fresh polymer gradually decreases while the cleaved polymers gain in signal intensity. After 30 cycles, the majority of the polymers was cleaved, indicating that these fairly low shearing times are sufficient to induce an appreciable degree of mechanical degradation.

From the shear stability test performed on these p(St) standards we can conclude that the shear rates achievable with the homogenizer allow for scission of linear polymers with molecular weights exceeding 200 kDa. Polymers below this cut-off are largely unaffected by the shearing forces.

With a working shearing protocol and set-up in hand, we proceeded to mechanical degradation experiments on MB-7980. The molecular weight distribution in evolution is shown in FIG. 37c. In contrast to the distinct splitting of the GPC traces observed for the 400 kDa p(St) polymers (FIG. 37b), MB-7980 shows a smoother transition of the high molecular weight tail to longer retention times. Since the average molecular weight of MB-7980 is significantly lower compared to the 400 kDa p(St), scission is limited to only the highest molecular weight polymers in the total distribution. The fact that the scission of these high molecular weight polymers does not lead to the appearance of a distinct new signal in the GPC traces is related to the length-dependent shear-induced stress (σ) distribution (arrows in FIG. 37d). For longer polymers, this stress distribution is sharply peaked around the center of the polymer. This leads to a situation in which the scission location is well-defined and relatively monodisperse polymers are formed after shear-induced cleavage. In contrast, for shorter polymers, such as MB-7980, the stress distribution is more diffuse compared to the length of the polymer. Scission yields a set of polydisperse polymers which do not appear as a distinct maximum in a GPC chromatogram, but instead is buried under the main distribution. Additionally, the starting molecular weight distribution of MB-7980 is already broad amplifying this smoothening of the GPC traces even further.

Cleavage of a fraction of the MB-7980 polymer chains was further corroborated by viscosity measurements performed on the samples passed through the homogenizer for 20 cycles. Compared to the fresh solution, which has a viscosity of 2.22 mPa·s, the sheared sample gave a viscosity of 1.93 mPa·s. This result clearly illustrates a significant drop in viscosity even at low degrees of chain scission.

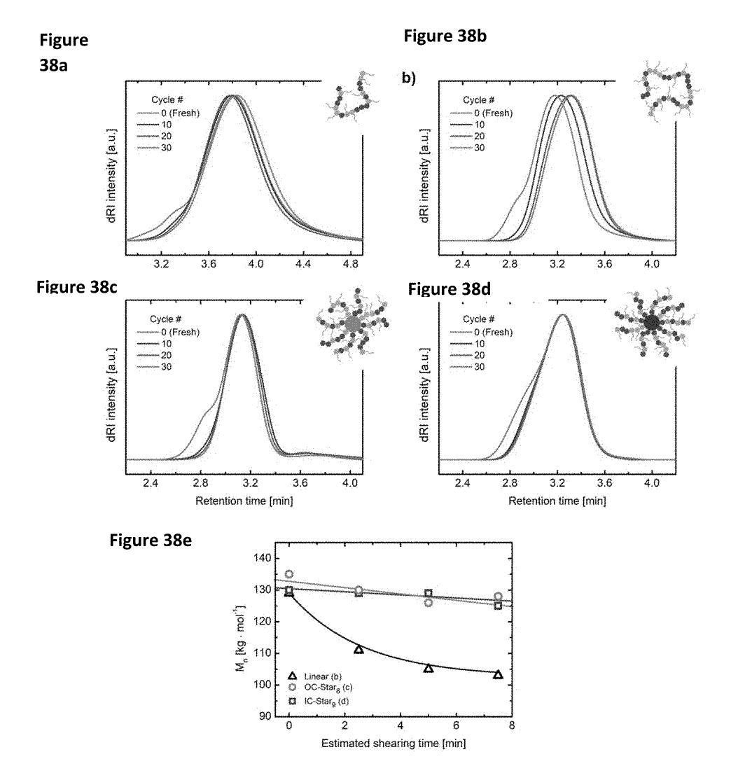

Next, we expanded the homogenization runs to other p(SMA-co-MMA)-based additives, namely, two linear p(SMA-co-MMA) polymers with molecular weights of 165 kDa and 200 kDa, OC-Star₈ (DPₙ=100/arm), and IC-Star₉ (DPₙ=100/arm). The results are summarized in FIG. 38. For the linear polymers (FIGS. 38a and b) the high molecular weight shoulders resulting from termination via recombination during the synthesis of these polymers were removed by mechanical degradation within the first 10 cycles. During the additional 20 shearing cycles, the molecular weight distribution of the longer p(SMA-co-MMA) polymer gradually shift to longer retention time (FIG. 38b), indicative for the scission of polymers. The molecular weight evolution is therefore similar to that observed for MB-7980 (FIG. 37c). The scission of polymer chains is also clearly reflected when plotting the number average molecular weight (Mₙ) versus the estimated shear time (FIG. 38e). This shift was significantly less apparent for the shorter linear chains (FIG. 38a, black triangles). This lack of chain scission for these polymers can be attributed to a molecular weight close to the previously identified minimum molecular weight cut-off required to induce polymer degradation with the employed high shear homogenization set-up.

Stars-shaped additives OC-Star₈ and IC-Star₉ with absolute molecular weight (as previously determined using light scattering experiments; see Supporting Information S1, see Table S1, Entry 3 and 5) of approximately 200-300 kDa were used. The total molecular weight of the star polymers is therefore comparable to that of the previously mentioned linear polymers. GPC analysis of the sheared polymers reveals that for these stars, no polymer degradation was observed (FIGS. 38c and d). Cycling these polymers through the homogenizer only results in the removal of the high molecular weight shoulder corresponding to coupled stars. As for the linear polymers, these coupled products are formed as a side-product during the synthesis. The main distribution, corresponding to single star polymers, remains completely intact, indicating enhanced shear stability compared to the linear p(SMA-co-MMA) polymers. Enhanced mechanical resilience is also evident from plotting Mn versus the estimated shearing time (FIG. 38e, red squares and grey circles). In contrast to the sharply decreasing molecular weight observed for the linear polymer, Mₙ remains practically constant over the course of the shearing experiment. The preliminary data shown here provides no solid evidence for an enhanced shear stability of the inorganic core stars compared to conventional fully organic stars. Employing longer shearing times and/or possibly high shear rates are required to provide a definitive answer to this.

At this point we would like to note that the comparison in FIG. 38 between stars and linear polymers were made based on polymers with approximately the same overall molecular weight. Therefore, this comparison effectively probes the effect of how a fixed number of monomers are arranged on the mechanical resilience of the resulting additive. Per gram of additive the stars perform better in terms of shear stability than the linear polymers, this comparison is not completely fair from a fundamental point of view. In order to probe the influence of topology on shear stability more correctly one would use star polymers carrying arms that are roughly half the length of the linear polymer. In this case, the end-to-end distance of two opposing arms have the same length as the linear chain. In this situation the effect of the presence of additional arms on the shear stability can be made correctly. However, with the current chemistry and molecular weight restriction imposed by the shear rates accessible with the high pressure homogenizer, synthesizing this set of polymers is highly challenging. Either the molecular weights of the stars need to be extremely high, or the linear chains are too short to be affected by the applied shear rates.

In summary, these shearing experiments provides us with the following preliminary insights:

1) At equal molecular weight, star-shaped additives show a higher resilience against mechanical degradation compared to linear chains.

2) Within the currently probed experimental window of shear rates and shearing times, no differentiation can be made between the fully organic stars and star polymers carrying the inorganic hyper-branched core.

Further Information on Synthesis and Characterization methods.

S1. Experimental details of physical characterizations.

S1.1. Thermal stability & properties of additive (solutions). Thermal gravimetric analysis (TGA) was performed using a TA Discovery TGA 1-0055 v5.7 at a heating rate of 10° C./min using 5-10 mg of sample in an alumina cup atop a platinum or ceramic hanging pan (in the presence of oxygen). The data was analyzed using Trios software v3.3. Differential Scanning Calorimetry (DSC) was performed using a TA Instruments DSC Q2000 at a heating/cooling rate of 10° C./min between −50 and 200° C., using 4-10 mg of sample in a sealed aluminum pan, with respect to an empty aluminum reference pan. Three cycles of heating and subsequent cooling were performed. The data was analyzed on Universal Analysis 2000 4.4A software. The resulting thermograms can be found in Section S4, FIG. 48.

S1.2. Shearing experiments. A surface forces apparatus (SFA 2000, SurForce LLC) with a high-speed friction attachment, hereby called HS-SFA, was developed and used to measure the friction coefficients and wear properties of the described lubricant additives. The HS-SFA is complementary and analogous to other industrial friction tests, such as, ASTM D6425. A spherical cap is sheared against a rotating disk while being pressed at a certain load, L, as seen in FIG. 39. The spherical cap (radius of curvature, R_{cap}=7.85 mm) was fixed to a mount equipped with force detecting springs parallel to the lateral direction for friction measurement (F∥). The spring deflection (force detection) was measured by strain gauges attached to the springs. [63] A planar disk with radius, R_{disk}=20 mm, was held by the rotating disk mount which is connected to a servo motor via a Viton belt. The position of the cap relative to the planar disk center, R_{c}, was controlled by adjusting the lateral position of the top mount on the HS-SFA. For these experiments, both the spherical caps and planar disks were cut from cylindrical stainless steel (AISI E52100) rod to simulate automotive engine surfaces. Unlike other industrial tests, the roughness of the surfaces was controlled through electro-chemical polishing (root mean square (RMS) roughness=15-21 nm, see FIG. 34) to minimize the unknown or unquantifiable effect of roughness on friction.

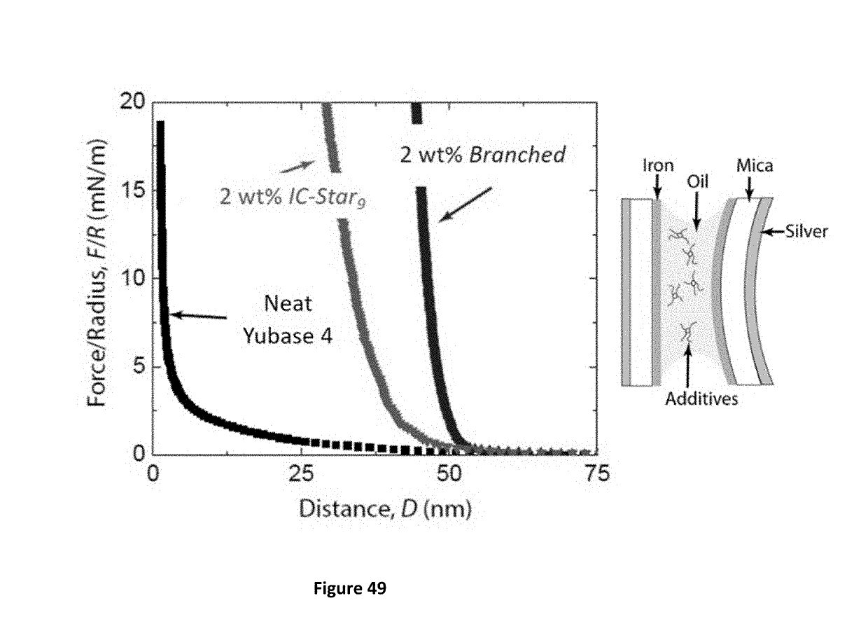

Once the rotating disk and spherical cap were mounted in the HS-SFA, the base oil with dissolved additive was injected between the spherical cap and disk, forming a capillary bridge. Prior to the shearing experiments, the system was equilibrated to room temperature (˜21° C.) for at least 1 h. After the wait time, the disk and cap were pressed together with an applied load, L, of approximately 150 mN. The disk was then rotated at 632 revolutions per minute (RPM) (˜10 Hz), resulting in a shear velocity of 1 m·s⁻¹ when R_{c}=15 mm. Considering these molecules form 50 nm thick films on iron oxide (see Section S5, FIG. 49), the maximum shear rate is up to 10⁷ s⁻¹. The data points were acquired at 50 Hz to avoid aliasing. The slight imperfection in horizontal alignment of the rotating disk leads to load changes in an oscillating pattern harmonious to the revolution of planar disk. The friction coefficient was then calculated by measuring the slope of the resulting friction force vs. load curve, μ=dF∥/dL (see Supporting Information S8 for details). For each solution, two 24 h shearing experiments and one 1 h shearing experiment were performed. The prolonged shear experiments help to determine any possible deformation or degradation of the additive molecules that may be measured by changes in the friction coefficient with time as would occur in an engine environment. A new steel disk and cap were used for each experiment to avoid contamination and previous wear effects.

S1.3. Profilometry for Wear Track Characterization. After the shearing experiments, a profilometer (Dektak 6M) was used to measure the wear profiles on the steel disks. The wear tracks were visually inspected under a low magnification microscope (5×) attached to the profilometer, and the areas with the most severe wear were scanned to obtain a roughness profile to calculate the RMS roughness (see Section S9, FIG. 53).

S1.4. Adsorption Layer Thickness Measurement. The adsorbed layer thickness of the additive molecules was measured using a quartz crystal microbalance (QCM-D, Biolin Scientific) with iron oxide coated quartz crystal sensors (QSX-326, Biolin Scientific). Iron oxide surfaces were selected to mimic steel application environments as closely as possible. First, a baseline resonance frequency and overtones were found for pure Yubase 4 flowing over the sensors (0.5 mL/min). Next, the desired additive dissolved in Yubase 4 (1 wt % each) was introduced to the sensor chamber. The frequency deviates due to adsorption of the lubricant additive to the sensor. Once the new resonance frequency equilibrated, pure Yubase 4 was reintroduced to the chamber to remove weakly bound additive polymer. Flushing with pure base oil was continued until no significant changes in resonance frequency were observed. The adsorbed layer thickness was then calculated using the Sauerbrey equation (see Supporting Information S10) which provides the linear relation between the frequency changes and the mass absorbed. The use of the Sauerbrey equation is justified by the resonance overtones converging to one value. [64]

S1.5. Bulk viscosity modification measurements. Following the standard ASTM D2270-04 procedure, viscosity indices (VIs) of Yubase 4 solutions containing 1 and 2 wt % of the described additives were determined using Eq. S1 [57]

$$VI = \frac{{10}^{N} - 1}{0.00715} + 100 \qquad ( S1 )$$

where N is defined as

$$N = \frac{log ( H ) - log ( U )}{log ( Y )} \qquad ( S2 )$$

In Eq. S2, Y and U are the kinematic viscosities (ηₖᵢₙ) in mm²·s⁻¹ at 100° C., and 40° C., respectively, of the solution whose VI, is to be calculated, and H equals the ηₖᵢₙ at 40° C. of a reference oil with VI=100 that has the same ηₖᵢₙ at 100° C. as the solution whose VI is to be calculated. H is obtained from an ASTM reference table, [57] while Y and U were measured experimentally. To this end, dynamic viscosities (η_{dyn}) were determined using an Anton Paar MRC-702 rheometer equipped with a CTD-180 convection oven. A 20 mm Couette geometry with a gap of 1 mm was used and operated in cup rotation mode to prevent the emergence of Taylor-Couette instabilities at elevated shear rates. [56] The samples were equilibrated for 10 min with a temperature tolerance of ±0.1° C. Shear rates between 0.1 and 750 s⁻¹ were probed. For calculation of the VI, zero shear viscosities (ƒ_{0,dyn}) were used, which were obtained by extrapolating the viscosity vs. shear rate curves to zero shear (FIG. 22). This procedure minimizes the influence of the residual instrumental torque as evident from a minor slope in the viscosity vs. shear rate curves and allows for a consistent and fair comparison between the samples. The obtained zero shear dynamic viscosities were subsequently converted to zero shear kinematic viscosities (η_{0,kin}) by dividing with the solution viscosity determined using an Anton Paar DMA 4100 densitometer.

S1.6. Molecular weight and radius of gyration (R_{g}) determinations. Absolute molecular weights and radii of gyration (R_{g}'s) were measured using size exclusion chromatography-multi-angle light scattering (SEC-MALS). The chromatography set-up comprised of a Waters Alliance HPLC 2695 separation module in combination with two 300×7.8 mm, 5 μm 2 Agilent PolyPore GPC columns (flow rate=1 mL·min⁻¹) and was coupled to a Wyatt DAWN HELEOS-II light scattering detector (λ₀=663.1 nm) and a Wyatt Optilab rEX differential refractive index (dRI) detector. Chloroform with 0.25% triethylamine (TEA) was used as the mobile phase. 100 μL of a polymer solution with a known concentration (3-5 mg·mL⁻¹) was injected for the analysis. The resulting light scattering data were analyzed following a partial Zimm formalism developed for static light scattering (SLS) of dilute solutions of non-interacting polymers (Eq. S3). [65]

$$\begin{matrix}\frac{{K}^{*} c}{{R}_{θ}} = ( \frac{1}{Mw} ) ( 1 + ( \frac{16 {π}^{2}}{{3}^{2}} ) 〈 {R}_{g}^{2} 〉 {sin}^{2} ( \frac{θ}{2} ) ) & ( S3a ) \\ {K}^{*} = 4 {π}^{2} {{n}_{0}^{2} ( \frac{dn}{dc} )}^{2} {λ}_{0}^{- 4} {N}_{A}^{- 1} & ( S3b )\end{matrix}$$

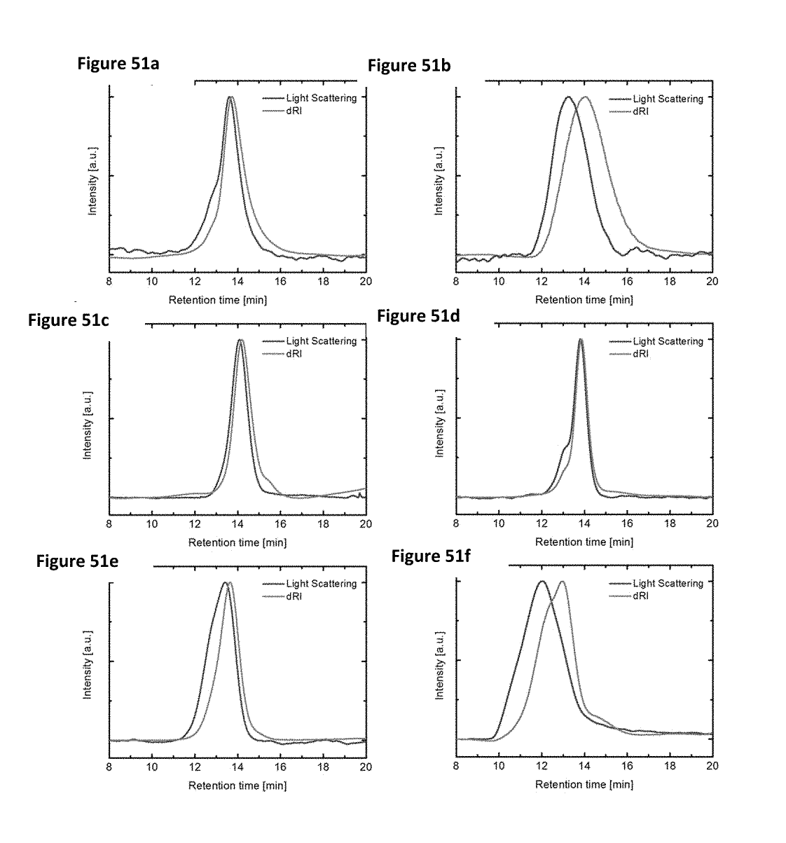

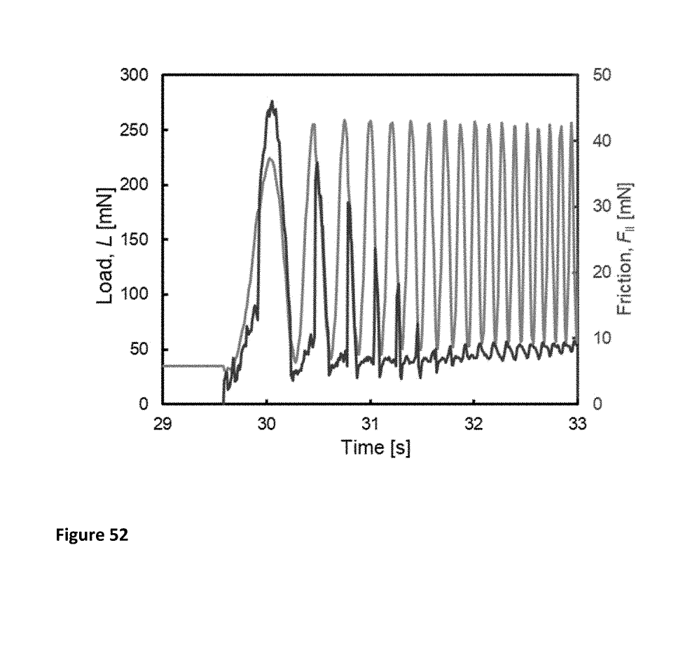

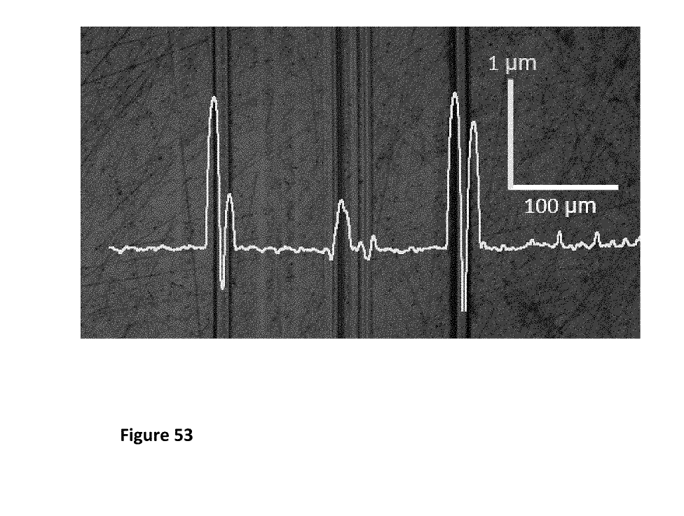

In Eq. S3a, c represents the polymer concentration, M_{w} the absolute molecular weight, R_{θ} the Rayleigh ratio, <R_{g}²> is the average radius of gyration squared, θ the scattering/detector angle, and K* is an instrument dependent constant depending on the wavelength of the laser (λ₀), the refractive index of the mobile phase (no), and the refractive index increment (dn/dc). N_{A} represents Avogadro's number. dn/dc values for the additives of interest were determined by injecting a concentration series of the individual polymers in the SEC-MALS instrument. Plotting the integrated dRI signal intensity against the injected polymer mass yielded linear curves with a slope equal to the dn/dc (see Supporting Information S6). Absolute molecular weights and R_{g}'s were evaluated at the retention time where the dRI signal was maximum. According to Eq. S3a, M_{w}, and R_{g} were obtained by plotting K*c/R_{θ} as a function of sin²(θ/2) (evaluated with at least 7 detector angles) and fitting the data with a linear relation (R²>0.93). The numerical values for the intersect with the y-axis, and the slope of the fitted curve yielded values for the absolute molecular weight and R_{g}, respectively (Table S1). The dRI and light scattering chromatograms can be found in Section S7, FIG. 51.

S2 Overview of p(SMA-co-MMA) based additives and their physical parameters used for lubricant performance screening.

TABLE S1
Molecular weights, monomer compositions, and radii of gyration of poly(stearyl
methacrylate-co-methyl methacrylate) (p(SMA-co-MMA)) based additives.

| | | | | | | Absolute | | |
|---|---|---|---|---|---|---|---|---|
| | | | | X | M_{w,th} | M_{w} | R_{g} | Ð |
| Entry | Additives | [SMA]:[MMA]:[I] | SMA:MMA^{a} | [%]^{b} | [kg · mol⁻¹]^{c} | [kg · mol⁻¹]^{d} | [nm]^{d} | [—]^{d} |
| 1 | Linear | 375:375:1 | 374:371 | 99 | 165 | 165 | 11.6 ± 0.7 | 1.5 |
| 2 | Branched | — | — | — | — | 128 | 10.3 ± 1.6 | 1.9 |
| 3 | IC-star₆ | 600:600:1 | 99:96 | 97 | 265 | 270 | 7.0 ± 0.5 | 1.2 |
| 4 | OC-star₈ | 800:800:1 | 47:50 | 50 | 352 | 181 | 6.3 ± 0.1 | 1.2 |
| 5 | IC-star₉ | 900:900:1 | 62:64 | 64 | 393 | 300 | 11.0 ± 0.4 | 1.3 |
| 6 | Oligo-IC- | 1260:1260:1 | 136:130 | 95 | — | 933 | 33.8 ± 0.3 | 2.7 |
| | star₉ | | | | | | | |

^{a}Monomer incorporation ratio determined by ¹H NMR analysis of diagnostic signals of stearyl methacrylate (SMA) at 3.9 ppm and methyl methacrylate (MMA) at 3.6 ppm with respect to the corresponding isolated initiator peaks. For star polymers, the ratios per arm are listed.
^{b}Determined based on total monomer consumption.
^{c}Theoretical molecular weight at quantitative monomer conversion.
^{d}Determined using size exclusion chromatography-multi angle laser scattering (SEC-MALS).
dn/dc values can be found in Supporting Information S6.

S3 Detailed synthetic procedures for p(SMA-co-MMA) based additives used for lubricant performance screening.

S3.1. Materials. All chemicals were used as obtained unless otherwise specified. Chloro(indenyl)bis(triphenylphosphine)ruthenium(II), dichloromethane adduct (98%) was purchased from Strem Chemicals. Ethyl α-bromoisobutyrate (EBIB) (98%), α-bromoisobutyryl bromide (BIBB) (98%), tripentaerythritol (technical grade), anhydrous pyridine (99.8%), tributylamine (≥98.5%; distilled and stored in sealed ampoules as 0.4 M solutions in dry toluene), methyl methacrylate (MMA) (99%; stabilized with MEHQ, passed through a basic alumina column before usage), 4-(dimethylamino)pyridine (ReagentPlus®, ≥99%), 2-mercaptoethanol (≥99%), 2,2-dimethoxy-2-phenylacetophenone (DMPAP) (99%), tris[2-(dimethylamino)ethyl]amine (Me₆TREN) (97%), copper(II) bromide (99%), and Karstedt's catalyst (platinum(0)-1,3-divinyl-1,1,3,3-tetramethyldisiloxane complex solution in xylene, Pt ˜2%) were purchased from Sigma Aldrich. 3-buten-1-ol (98%), and stearyl methacrylate (SMA) (>97%; stabilized with MEHQ, dissolved in dichloromethane and passed through a basic alumina column then dried under vacuum before usage) were purchased from TCI America. Triethylamine (TEA) (reagent grade), and toluene (certified ACS) were purchased from Fisher Scientific. Dichloromethane 20 L drums were purchased from Fisher Scientific, degassed and passed through two sequential purification columns (activated alumina) under a positive argon atmosphere. Ex1001 [lot MQ0156850-(5)-1] (cross-linked silicon-containing material with vinyl peripheral groups; Si-vinyl 6.0 mmol/g), and Ex901 [lot 016323HK] (cross-linked silicon-containing material with silane peripheral groups; Si—H 9.0 mmol/g) were provided by Mitsubishi Chemical Corporation (MCC). A group III base oil (Yubase 4, YB4), donated by MCC, was used for all the experiments. Benchmark MB-7980, a random copolymer of SMA and MMA, replicated from a commercial lubricant modifier via suspension polymerization using 2,2′-azobis-2-methylbutylonitrile (AMBN) as initiator and 1-dodecanethiol as a chain transfer agent. MB-7980 was also provided by MCC.

S3.2. Characterization methods. ¹H (¹³C) nuclear magnetic resonance (NMR) spectra were recorded on a Varian VNMRS 600 (150) MHz spectrometer. Chemical shifts (δ) are reported in ppm relative to residual chloroform in CDCl₃ (7.26 ppm). Size exclusion chromatography-multi-angle laser scattering (SEC-MALS) for absolute molecular weight analysis was performed on Waters Alliance HPLC 2695 separation module in combination with two 300×7.8 mm, 5 μm 2 Agilent PolyPore GPC columns (flow rate=1 ml/min), coupled to a Wyatt DAWN HELEOS-II light scattering detector (λ₀=663.1 nm) and a Wyatt Optilab rEX differential refractive index (dRI) detector. Chloroform with 0.25% triethylamine (TEA) was used as the mobile phase. Thermal gravimetric analysis (TGA) was performed using a TA Discovery TGA 1-0055 V5.7 at a heating rate of 10° C./min using 5-10 mg of sample in an alumina sample cup atop a platinum or ceramic hanging pan (in presence of oxygen). The data was analyzed using Trios software V3.3. Differential Scanning calorimetry (DSC) was performed using a TA Instruments DSC Q2000 at a heating/cooling rate of 10° C./min between −50 and 200° C., using 4-10 mg of sample in a sealed aluminum pan, with respect to an empty aluminum reference pan. Three cycles of heating and subsequent cooling were performed. The data was analyzed on Universal Analysis 2000 4.4A software. All chemicals were used as obtained unless otherwise specified.

S3.3 Synthesis of inorganic star-initiator (IC₆-Br, FIG. 40)

S3.3.1. Hydroxy-terminated inorganic core (IC₆-OH). IC6-vinyl (5.0 g, 5.5 mmol, Si-vinyl 6.0 mmol/g), DMPAP (0.14 g, 0.55 mmol), and 2-mercaptoethanol (3.0 mL, 42 mmol) were dissolved in toluene (100 mL) then degassed with Ar for 20 min. The reaction was sealed and irradiated with UV-light (λₘₐₓ=365 nm) for 1.5 h at room temperature. The reaction mixture was poured in i-PrOH, and centrifuged (3×) to obtain the pure product in 90% yield.

¹H NMR (600 MHz, in CDCl₃): δ 3.72 (b, 2H), 2.75 (b, 2H), 2.60 (b, 2H), 0.97 (b, 2H), 0.07-0.26 (m, 10 H); FT-IR (v, cm⁻¹): 3330 (O—H), 2850-2960 (C—H sp2/sp3).

S3.3.2. Inorganic star-initiator (<ƒ>=6, IC₆-Br). The hydroxy-terminated inorganic core (IC₆-OH, 6.2 g, 4.5 mmol) was dissolved in dry DCM (90 mL), in a 3-neck round-bottom flask equipped with a dropping funnel and a magnetic stir bar, followed by the addition of TEA (4.1 mL, 29 mmol). The solution was cooled down to 0° C. in an ice bath. BIBB (3.6 mL, 29 mmol) was added dropwise to the reaction flask within 30 min under vigorous stirring. After complete addition, the ice-water bath was removed, and the reaction mixture was allowed to stir overnight at room temperature. The resulting solution was subsequently washed with 10% HCl solution (3×50 mL), saturated NaHCO₃ solution (3×50 mL), and water (3×50 mL). After washing, the organic phase was dried over anhydrous MgSO₄, filtered, and concentrated under reduced pressure. The resulting oil was purified by leaving it overnight under high vacuum at 100° C. The product was obtained in 85% yield. ¹H NMR (600 MHz, in CDCl₃): δ 4.30 (t, J=6.8 Hz, 2 H), 2.79 (b, 2H), 2.65 (b, 2H), 1.93 (s, 6H), 0.97 (b, 2H), 0.29-0.09 (m, 10H); FT-IR (v, cm⁻¹): 2850-2960 (C—H sp2/sp3), 1735 (C═O).

S3.4. Synthesis of inorganic star-initiator (IC₉-Br)

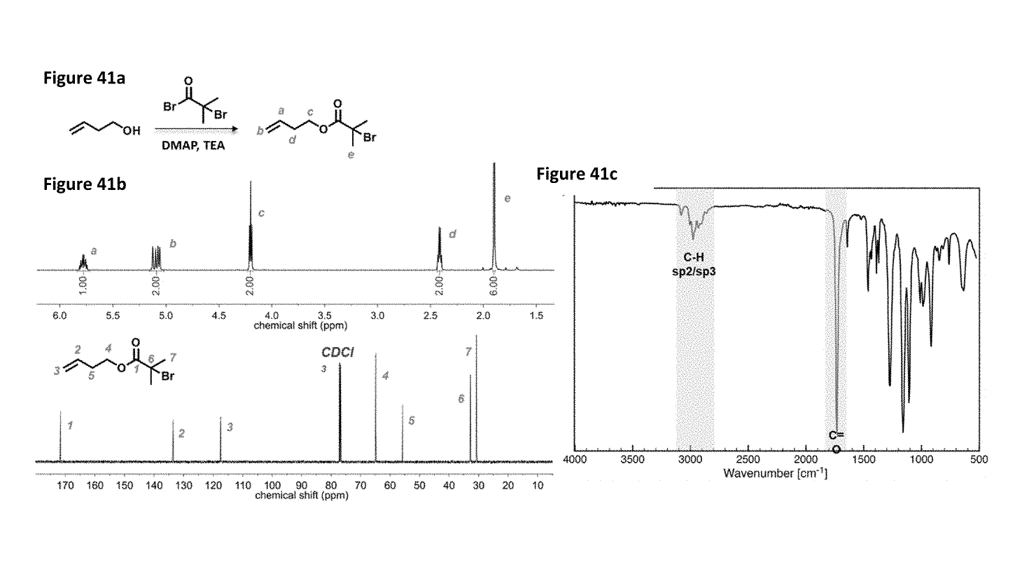

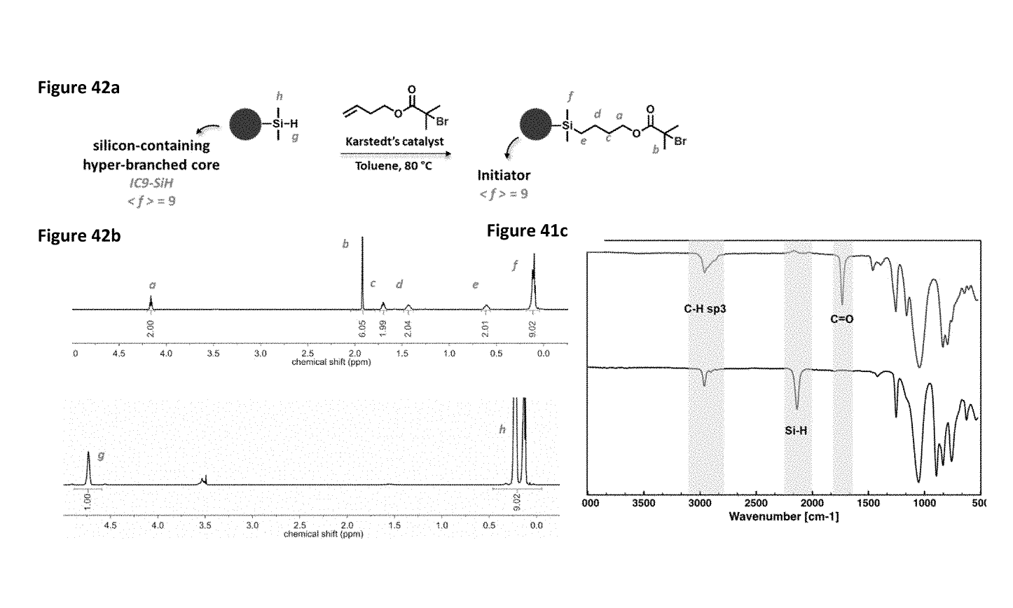

S3.4.1. Preparation of but-3-en-1-yl 2-bromo-2-methylpropanoate (FIG. 41). 3-Buten-1-ol (8.0 mL, 0.13 mol) was added to a stirred solution of BIBB (17 mL, 0.14 mol), DMAP (1.7 g, 0.014 mol), and TEA (19 mL, 0.14 mol) in dichloromethane (95 mL) at 0° C. After complete addition, the resulting mixture was stirred overnight at room temperature. Aqueous saturated NH₄Cl (30 mL) was added, and the organic phase was separated. The organic layer was washed with brine (30 mL), dried over anhydrous MgSO₄, and concentrated in vacuo. Distillation of the crude mixture under reduced pressure (bp, 40° C.) gave the title compound as a colorless oil in 80% yield (23 g). ¹H NMR (600 MHz, in CDCl₃): δ 5.82-5.75 (m, 1H), 5.19-5.00 (m, 2H), 4.21 (t, J=6.6 Hz, 2H), 2.46-2.38 (m, 2H), 1.90 (s, 6H);

¹³C NMR (600 MHz, in CDCl₃): δ 171.6, 133.5, 117.5, 64.9, 55.8, 32.8, 30.8, 30.7; FT-IR (v, cm⁻¹): 2970-3080 (C—H sp2/sp3), 1730 (C═P); ESI-MS (m/z): [M+K]⁺ calcd for C₈H₁₃BrKO₂: 258.9736, 260.9716; found: 258.1008, 260.0903.

S3.4.2. Synthesis of inorganic star-initiator (<ƒ>=9, IC₉-Br, FIG. 42). Karstedt's catalyst (100 μM) was added to a stirred solution of silane-terminated inorganic core (IC₉-SiH, 10 g, 0.011 mol, Si—H 9.0 mmol/g) and but-3-en-1-yl 2-bromo-2-methylpropanoate (24 g, 0.11 mol) in toluene (100 mL). The mixture was heated in toluene at 65° C. overnight, after which, it was cooled to room temperature, passed through a column of neutral alumina to remove the platinum catalyst, then concentrated under reduced pressure. The product was purified by automated column chromatography on silica gel by gradient elution in 5% ethyl acetate in hexanes to afford the product in 85% yield (29 g). ¹H NMR (600 MHz, in CDCl₃): δ 4.16 (t, J=6.4 Hz, 2H), 1.92 (s, 6H), 1.68-1.72 (m, 2H), 1.43 (b, 2H), 0.62 (b, 2H), 0.14-0.10 (m, 9H); FT-IR (v, cm⁻¹): 2960-2850 (C—H sp2/sp3), 1735 (C═O).

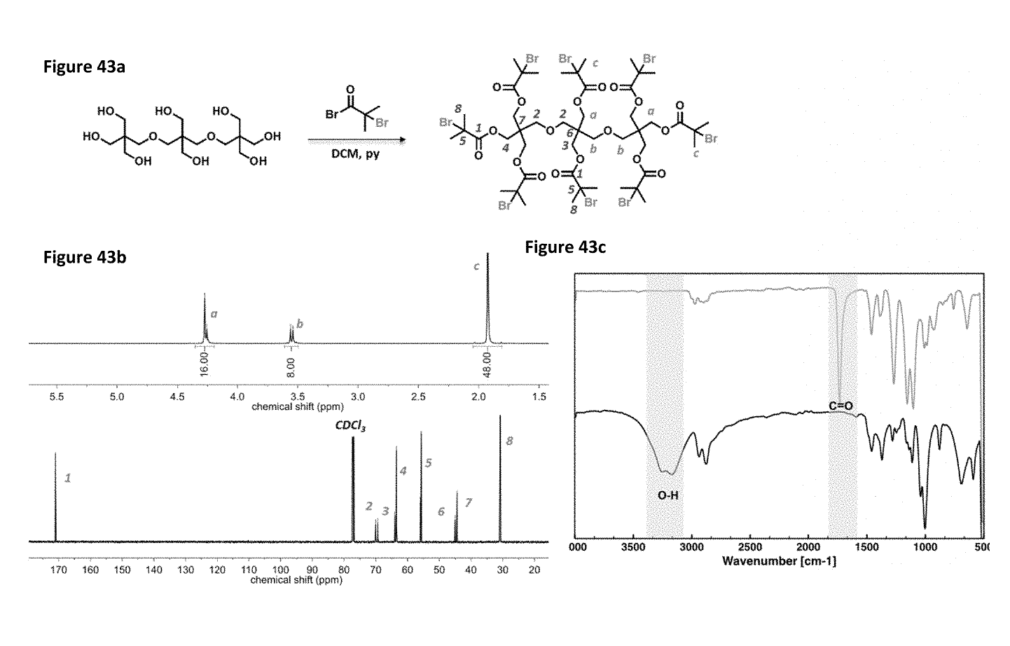

S3.5. Synthesis of organic star-initiator (OC₈-Br, FIG. 43). The octa-functional organic initiator was synthesized according to the procedure described in Ref 32. Tripentaerythritol (OC₈-OH, 1.0 g, 0.027 mol) was suspended in dry dichloromethane (25 mL), in a 3-neck round-bottom flask equipped with a dropping funnel and a magnetic stir bar, followed by the addition of pyridine (10 mL, 0.12 mol). The solution was then cooled down to 0° C. in an ice-water bath. A solution of BIBB (5.2 mL, 0.043 mol) in DCM (20 mL) was added dropwise to the reaction flask within 30 min under vigorous stirring. After complete addition, the ice-water bath was removed, and the reaction mixture was allowed to stir for 48 h at room temperature. Then it was diluted with chloroform and stirred for 30 min. The resulting solution was subsequently washed with 10% HCl solution (3×50 mL), saturated NaHCO₃ solution (3×50 mL), and pure water (3×50 mL). After washing, the organic phase was dried over anhydrous MgSO₄, filtered, and concentrated under reduced pressure. The resulting oil was recrystallized from iPr—OH to generate the product as a white solid (78%, 3.3 g). ¹H NMR (600 MHz, CDCl₃): δ 4.27 (s, 12H), 4.26 (s, 4H), 3.56 (s, 4H), 3.54 (s, 4H), 1.93 (s, 36H), 1.92 (s, 12H); ¹³C NMR (150 MHz, CDCl₃): δ 171.0, 170.9, 70.0, 69.4, 64.0, 63.5, 56.0, 55.7, 45.0, 44.4, 30.9, 30.8; FT-IR (v, cm⁻¹) 1730 (C═O); ESI-MS (m/z): [M+Na]⁺ calcd for C₄₇H₇₂Br₈NaO₁₈ 1586.8001; found: 1586.7113.

S3.6. Synthesis of linear p(SMA-co-MMA, FIG. 44). EBIB (7.0 μL, 0.047 mmol), SMA (6.0 g, 18 mmol), MMA (1.9 mL, 17 mmol), and tributylamine (0.4 M in toluene) (0.24 mL, 0.094 mmol) were dissolved in toluene (6 mL). The mixture was degassed with Ar for 40 min. The catalyst, chloro(indenyl)bis(triphenylphosphine)ruthenium(II), dichloromethane adduct (7.3 mg, 0.0094 mmol) was added and the reaction mixture was degassed for an additional 5-10 min, then left stirring at 80° C. for 16 h after which monomer conversions of >95% were reached. The reaction vessel was cooled to room temperature, the solution diluted with toluene, filtered over a column of neutral alumina, and concentrated under reduced pressure. The crude product was dissolved in THF and purified by precipitation in a 3:1 mixture of MeOH:CHCl₃ (3×) to yield the desired pure polymer.

S3.7. Synthesis of IC-p(SMA-co-MMA)₆ (IC-star₆, FIG. 45). The inorganic star-initiator (IC₆-Br, <ƒ>=6) (15 mg, 0.013 mmol), SMA (1.3 g, 3.9 mmol), MMA (0.42 mL, 3.9 mmol), and tributylamine (0.4 M in toluene) (0.15 mL, 0.060 mmol) were dissolved in toluene (2 mL). The mixture was degassed with Ar for 40 min. The catalyst, chloro(indenyl)bis(triphenylphosphine)ruthenium(II), dichloromethane adduct (4.6 mg, 0.0060 mmol) was added and the reaction mixture was degassed for another 5-10 min, then left stirring at 80° C. The reaction reached high monomer conversions (˜97%) after 10 h. The reaction vessel was cooled to room temperature, the solution diluted with toluene, filtered over a column of neutral alumina, and concentrated under reduced pressure. The crude product was dissolved in THF and purified by precipitation (3×) in 3:1 a mixture of MeOH:CHCl₃ to afford the desired pure polymer.

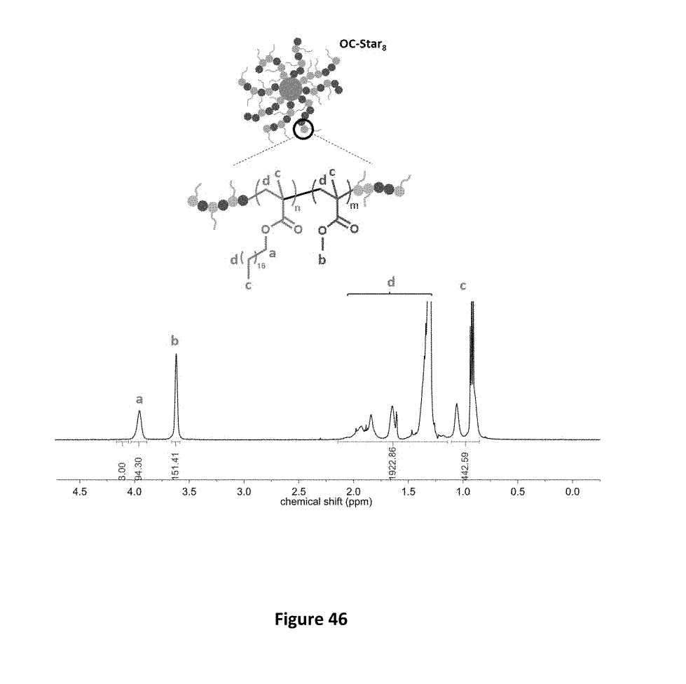

S3.8. Synthesis of OC-p(SMA-co-MMA)₆ (OC-star₈, FIG. 46). The organic star-initiator (OC-Br, ƒ=8) (30 mg, 0.020 mmol), SMA (5.4 g, 16 mmol), MMA (1.6 mL, 16 mmol), and tributylamine (0.4 M in toluene) (0.4 mL, 0.16 mmol) were dissolved in toluene (29 mL). The mixture was degassed with Ar for 40 min. The catalyst, chloro(indenyl)bis(triphenylphosphine)ruthenium(II), dichloromethane adduct (12 mg, 0.016 mmol) was added and the reaction mixture was degassed for another 5-10 min, then left stirring at 80° C. for 10 h. The reaction vessel was cooled to room temperature, the solution diluted with toluene, filtered over a column of neutral alumina, and concentrated under reduced pressure. The pure polymer was isolated at ˜50% conversion by precipitation (3×) in a 3:1 mixture of MeOH:CHCl₃ from THF.

S3.9. Synthesis of hybrid p(SMA-co-MMA) star polymers (<ƒ>=9, FIG. 47)

S3.9.1. Synthesis of IC-p(SMA-co-MMA)₉ (IC-star₉). The inorganic star-initiator (IC₉-Br, <ƒ>=9) (50 mg, 0.016 mmol), SMA (4.8 g, 14 mmol), MMA (1.5 mL, 14 mmol), and tributylamine (0.4 M in toluene) (0.36 mL, 0.14 mmol) were dissolved in toluene (25 mL). The mixture was degassed with Ar for 40 min. The catalyst, chloro(indenyl)bis(triphenylphosphine)ruthenium(II), dichloromethane adduct (11 mg, 0.014 mmol) was added and the reaction mixture was degassed for another 5-10 min, then left stirring at 80° C. for 10 h. The reaction vessel was cooled to room temperature, the solution diluted with toluene, filtered over a column of neutral alumina, and concentrated over reduced pressure. The pure polymer was isolated at ˜64% conversion by precipitation (3×) in a 3:1 mixture of MeOH:CHCl₃ from THF.

S3.9.2. Synthesis of oligo-IC-p(SMA-co-MMA)₉ (Oligo-IC-star₉). The inorganic star-initiator (IC₉-Br, <ƒ>=9) (15 mg, 0.005 mmol), SMA (2.1 g, 6.1 mmol), MMA (0.64 mL, 6.1 mmol), 1,6-hexanedioldimethacrylate (6.1 μL, 0.02 mmol) and tributylamine (0.4 M in toluene) (0.11 mL, 0.043 mmol) were dissolved in toluene (6 mL). The mixture was degassed with Ar for 40 min. The catalyst, chloro(indenyl)bis(triphenylphosphine)ruthenium(II), dichloromethane adduct (3.3 mg, 0.004 mmol) was added and the reaction mixture was degassed for another 5-10 min, then left stirring at 80° C. for 13 h. The reaction vessel was cooled to room temperature, the solution diluted with toluene, filtered over a column of neutral alumina, and concentrated under reduced pressure. The product was dissolved in THF and purified by precipitation (3×) in a 3:1 mixture of MeOH:CHC13 and isolated with 95% conversion.

S4 Thermograms (TGA and DSC) of p(SMA-co-MMA) based additives
See FIG. 48.

SS Compressed film thicknesses of additive containing solutions in Yubase 4
See FIG. 49.

S6 dn/dc determination for p(SMA-co-MMA) based additives

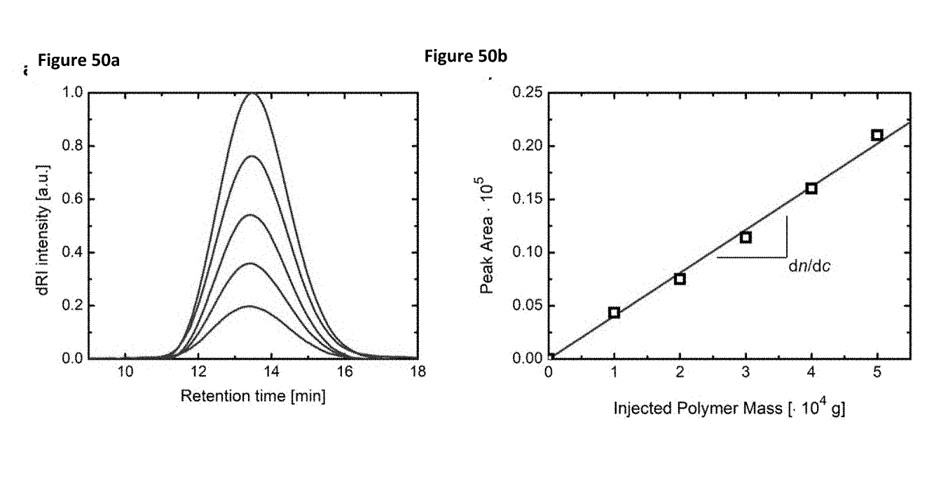

Refractive index increments (dn/dc) were determined using the dRI detector of the SEC-MALS instrument described in the Experimental Section of the main text. A series with polymer concentrations ranging from 1-5 mg/mL were injected (injection volume=100 μL, solvent=CHCl₃+0.25% TEA). The resulting dRI responses (FIG. 50a) were integrated to determine the peak area. The obtained peak areas were plotted as a function of the injected polymer mass and fitted with a straight line (R²>0.99). The dn/dc values were obtained as the slope of these fitted curves. FIG. 50 shows the data obtained for MB-7980 polymer and is representative for all other additives. The resulting dn/dc values are listed in Table S2.

TABLE S2
Refractive index increments (dn/dc) of poly(stearyl
methacrylate-co-methyl methacrylate) (p(SMA-co-MMA)) based
additives in CHCl₃ + 0.25% TEA.

| | | dn/dc |
|---|---|---|
| Entry | Additives | [ml/mg] |
| 1 | Linear | 0.0405 ^{a} |
| 2 | Branched | 0.0405 |
| 3 | IC-star₆ | 0.0430 ^{b} |
| 4 | OC-star₈ | 0.0435 |
| 5 | IC-star₉ | 0.0430 |
| 6 | Oligo-IC-star₉ | 0.0347 |

^{a} not measured separately. The dn/dc is assumed to be equal to the value obtained for entry 2.
^{b} not measured separately. The dn/dc is assumed to be equal to the value obtained for entry 5

S7 SEC-MALS traces of p(SMA-co-MMA) based additives
See FIG. 51.

S8 Calculation procedure for friction coefficient from varying loads and friction force

FIG. 52 shows a set of raw data from which the change in friction coefficient over time is calculated. This figure shows the first 18 disc revolutions when Yubase 4 solution containing 2 wt % IC-star₉ was sheared. The magnitude of the first red peak, or Fμ, corresponding to the first blue peak (L), decreases in consecutive revolutions until it reaches a much smaller and steadier value, at which point major damage may have already occurred. [25, 66-68] The surfaces may experience stiction during first sliding as shown. The data such as below are binned for every 10 s, and the data are plotted again with load, L, at the lateral axis and friction force, F∥, at the y-axis. The slope is equal to the averaged friction coefficient, μ, over that 10 seconds.

S9 Visualization of wear tracks

After each HS-SFA shearing experiment, the wear profiles were analyzed using a profilometer. FIG. 53 shows a representative example obtained with a Yubase 4 solution containing 2 wt % of MB-7980.

S10 Brief introduction to Quartz Crystal Microbalance (QCM) measurements

QCM measures the change in frequency due to change in the mass adsorbed on a quartz crystal coated with a specific material. The change in frequency can be used to directly calculate the mass, given that the density and area of the adsorbed layer is known, and the Sauerbrey equation is applicable as expressed in the following equation

$$Δ f = \frac{C Δ m}{n} \qquad ( S4 )$$

where Δf is the change in frequency, n is the overtone number, and Am is the change in mass due to adsorption. C is the constant specific to quartz sensors. In our experiments, we used C=17.7 ng·Hz⁻¹ as specified by the manufacturer.

If the absorbing molecules or polymers adhere to the coated material rigidly as if a solid layer is added, then the overtones of the fundamental frequency of the quartz crystal overlap each other, and Sauerbrey equation is applicable. On the contrary, the layer is viscoelastic if the overtones diverge. FIG. 54 shows the QCM measurement for IC-Star_{9.} The solution was introduced, pure Yubase was introduced 10 min after the experiments started. The diverged overtones indicate possible viscoelastic adsorbed layer. After pure Yubase 4 was introduced (20 min mark), the excess IC-star9 was removed and shows the overlapping overtones. This indicate the applicability of the Sauerbrey equation and the rigidity of the adsorbed layer.

Process Steps

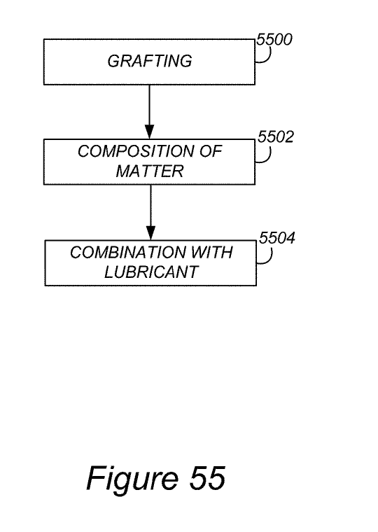

FIG. 55 is a flowchart illustrating a method of making a star-shaped polymer 100 (referring also to FIG. 1 and FIG. 7).

Block 5500 represents grafting polymer chains 102 to or from an organic or inorganic polymer core 104. In one or more examples, the core comprises cross-linked silicon containing material. In one or more examples, the core comprises cross-linked chains wherein each chain includes silicon and oxygen. In one or more examples, the core is/includes a silicate functionalized with one or more organic groups. In one or more examples, the core comprises a (e.g., densely) cross-linked silicon-containing hyperbranched core. In one or more examples, the densely cross-linked silicon-containing hyperbranched core is/includes a silicate functionalized with one or more organic groups. The silicate functionalized with one or more organic groups can be synthesized according to existing methods. In one or more examples, the silicate functionalized with one or more organic groups is synthesized according to reference (67) or (68).

In one or more examples, the polymer chains each have an arm length and the step comprises efficiently controlling the ratio of the arm length with respect to a size of the core.

In one or more examples, the polymer chains are attached to the core at arm attachment points and the step comprises controlling or tuning a density of the arm attachment points depending on a composition of the core.

In one or more examples, the core further comprises at least one material selected from —H, vinyl, and OMe on its surface.

Block 5502 represents the end result, a composition of matter comprising a star-shaped polymer 100 including polymer chains 102 grafted to or from the core 104.

The star shaped polymer can be embodied in many ways including, but not limited to the following.
1. In a first example, the core 104 comprises silicon, cross-linked silicon containing material, cross-linked and/or branched chains wherein each chain includes silicon or a cross-linked silicon-containing branched or hyperbranched core 702, e.g., comprising a silicate functionalized with one or more organic groups.
2. In a second example, the core 104 comprises an organic core 700, e.g. comprising OCₓ-OH.
3. In a third example, the composition of example 1 or 2 includes the polymer chains each comprising at least one compound selected from an acrylate and a methacrylate.
4. In a fourth example, in the composition of examples 1, 2, or 3, a number of the polymer chains is in a range of 4-16 (e.g., 6-12).
5. In a fifth example, each polymer chain in examples 1, 2, 3, or 4 includes between 25-200 monomer units.
6. In a sixth example, the monomer unit of example 5 includes an acrylate or a methacrylate.
7. In a seventh example, each polymer chain in examples 1, 2, 3, 4, 5, or 6 is a copolymer.
8. In an eighth example, the copolymer in example 7 comprises a first alkyl acrylate 106 or alkyl methacrylate 108 having a first pendant C8-C18 alkyl chain and a second alkyl acrylate 110 or alkyl methacrylate 112 having a second pendant C1-C4 alkyl chain.
9. In a ninth example, the copolymer in example 7 comprises a first alkyl acrylate 106 or alkyl methacrylate 108 having a first pendant C4-C12 alkyl chain and a second alkyl acrylate 110 or alkyl methacrylate 112 having a second pendant C1-C4 alkyl chain.
10. In a tenth example, the first and second alkyl acrylate of examples 8 or 9 each have the structure

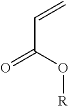

wherein R is the first pendant C8-C18 or C4-C12 chain or the second pendant C1-C4 alkyl chain.
11. In an eleventh example, the first or second alkyl methacrylate of examples 8 or 9 each have the structure

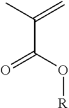

wherein R is the first pendant C8-C18 or C4-C12 chain or the second pendant C1-C4 alkyl chain.
12. In a twelfth example, the polymer chains of examples 1, 2, 3, 4, 5, or 6 are each a homopolymer.
13. In a thirteenth example, the homopolymer of the twelfth example comprises an alkyl acrylate having a pendant C4-C18 alkyl chain.

14. In a fourteenth example, the alkyl acrylate of example 13 has the structure

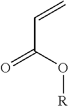

wherein R is the pendant C8-C18 chain.
15. In a fifteenth example, the ratio of the first or second alkyl methacrylate to the second alkyl acrylate or alkyl methacrylate (in the copolymer of any of the examples 7-11) is 1:1.
16. In a sixteenth example, the core in examples 1 and 3-15 is three dimensional and has a number average molecular weight (Mn) determined by gel permeation chromatography (GPC) with polystyrene standard samples between 400 and 10000.
17. In a seventeenth example, the core comprises an oligomer or a polymer of Si(OR)₄.
Si(OR)₄ having four reactive alkoxy groups that are polymerized so as to form a branched or hyperbranched structure.

In one or more examples, the composition of matter of examples 1-17 (e.g., comprising p(SMA-co-MMA)) exhibits the surprising and unexpected combination of improved multifunctional performance as a bulk viscosity modifier, boundary lubricant, and wear protectant, (e.g., when the composition of matter is used as an additive, e.g., in a lubricant oil) as compared to non-star shaped polymers that do not have the structures and compositions described in embodiments 1-14.

In one or more of the examples 1-17, the star-shaped polymer has superior/improved properties (e.g., shear stability) as compared to linear and branched polymers

Block 5504 represents optionally combining the composition of matter of any of the examples 1-17 in a lubricant.

In one example, the lubricant comprises the composition of matter of embodiments 7, 8, 9, 10, 11, or 12 combined with a lubricant oil (e.g., Yubase 4). In one or more examples, between 1-3 wt % of the composition of matter of embodiments 7, 8, 9, 10, 11, or 12 is combined with the lubricant oil (e.g., Yubase 4).

In another example, the lubricant comprises the composition of matter of embodiments 12, 13, or 14 combined with a lubricant oil (e.g., Nexbase 3043).

In yet another example, the lubricant is petroleum derived and the composition of matter forms coils.

In one or more examples, the core comprises an organic core including a trimethyl ammonium group having (e.g., up to 3) functional groups attached, the functional groups having biological and/or non-biological functionalites.

### REFERENCES

The following references are incorporated by reference herein

(1) Kinker, B. G. Lubricant additives—chemistry and applications. In CRC Press; Rudnick, L. R., Ed.; CRC Press: Boca Raton, Fla., 2009; pp 315-337.

(2) Ver Strate, G.; Struglinski, M. J. Polymers as lubricating-oil viscosity modifiers (Ch. 15 in Polymers as Rheology Modifiers). ACS Symposium Series, 462, 1991, 256-272.

(3) Rizvi, S. Q. A. A comprehensive review of lubricant chemistry, technology, selection and design, ASTM International, West Conshohocken, 2009.

(4) Mang, T.; Dresel, Wilfried, Lubricants and Lubrication, 3rd ed. John Wiley & Sons, 2017.

(5) Nassar, A. M. The behavior of polymers as viscosity index improvers. Pet. Sci. Technol. 2008, 26 (5), 514-522.

(6) Mohamad, S. A.; Ahmed, H. S.; Hassanein, S. M.; Rashad, A. M. Investigation of polyacrylate copolymers as lube oil viscosity index improvers. J. Petrol. Sci. Eng. 2012, 100, 173-177.

(7) Covitch, M. J.; Trickett, K. J. How polymers behave as viscosity index improvers in lubricating oils. Adv. Chem. Eng. Sci. 2015, 5, 134.

(8) Jordan Jr., E. F.; Smith Jr., S.; Koos, R. E.; Parker, W. E.; Artymyshyn, B.; Wrigley, A. N.; Viscosity index. I. Evaluation of selected copolymers incorporating n-octadecyl acrylate as viscosity index improvers. J. Appl. Polym. Sci. 1978, 22, 1509-1528.

(9) Bhattacharya, P.; Ramasamy, U. S.; Krueger, S.; Robinson, J. W.; Tarasevich, B. J.; Martini, A.; Cosimbescu, L. Trends in thermoresponsive behavior of lipophilic polymers. Ind. Eng. Chem. Res. 2016, 55, 12983-12990.

(10) Van Horne, W. L. Polymethacrylates as viscosity index improvers and pour point depressants. Ind. Eng. Chem. 1949, 41, 952-959.

(11) Xue, L.; Agarwal, U. S.; Lemstra, P. J. Shear degradation resistance of star polymers during elongational flow. Macromolecules 2005, 38, 8825-8832.

(12) Odell, J. A.; Keller, A.; Rabin, Y. Flow-induced scission of isolated macromolecules. J. Chem. Phys. 1988, 88, 4022.

(13) Jabbarzadeh, A.; Atkinson, J. D.; Tanner, R. I. Effect of molecular shape on rheological properties in molecular dynamics simulation of star, H, comb, and linear polymer melts. Macromolecules 2003, 36, 5020-5031.

(14) Chen, W.; Zhang, K.; Liu, L.; Chen, J.; Li, Y.; An, L. Conformation and dynamics of individual star in shear flow and comparison with linear and ring polymers. Macromolecules 2017, 50, 1236-1244.

(15) Wang, J.; Ye, Z.; Zhu, S. Topology-engineered hyperbranched high-molecular-weight polyethylenes as lubricant viscosity-index improvers of high shear stability. Ind. Eng. Chem. Res. 2007, 46, 1174-1178.

(16) Robinson, J. W.; Zhou, Y.; Qu, J.; Erck, R.; Cosimbescu, L. Effects of star-shaped poly(alkyl methacrylate) arm uniformity on lubricant properties. J. Appl. Polym. Sci. 2016, 133, 43611.

(17) Spikes, H. The history and mechanisms of ZDDP. Tribol. Lett. 2004, 17, 469-489.

(18) Graham, J.; Spikes, H.; Jensen, R. The friction reducing properties of molybdenum dialkyldithiocarbamate additives: Part II—durability of friction reducing capability. Tribol. Trans. 2001, 44, 637-647.

(19) Yamamoto, Y.; Gondo, S. Friction and wear characteristics of molybdenum dithiocarbamate and molybdenum dithiophosphate. Tribol. Trans. 1989, 32, 251-257.

(20) Smeeth, M.; Spikes, H.; Gunsel, S. Boundary film formation by viscosity index improvers. Tribol. Trans. 1996, 39, 726-734.

(21) Cosimbescu, L.; Robinson, J. W.; Zhou, Y.; Qu, J. Dual function star polymers for lubricants. RSC Adv. 2016, 6, 86259-86268.

(22) Robinson, J. W.; Zhou, Y.; Qu, J.; Bays, J. T.; Cosimbescu, L. Highly branched polyethylene as lubricant viscosity and friction modifiers. Reac. Func. Polym. 2016, 109, 52-55.

(23) Yamada, S.; Nakamura, G.-I.; Amiya, T. Shear properties for thin films of star and linear polymer melts. Langmuir 2001, 17, 1693-1699.

(24) McGuiggan, P. M.; Wallace, J. S.; Smith, D. T.; Sridhar, I.; Zheng, Z. W.; Johnson, K. L. Contact mechanics of layered elastic materials: experiment and theory. J. Phys. D 2007, 40 (19), 5984.

(25) Israelachvili, J. N. Intermolecular and Surface Forces, 3rd ed.; Academic Press: New York, 2011.

(26) Gao, J.; Mao, S.; Liu, J.; Feng, D. Tribochemical effects of some polymers/stainless steel. Wear 1997, 212, 238-243.

(27) Robinson, J. W.; Zhou, Y. Bhattacharya, P.; Erck, R.; Qu, J.; Bays, J. T.; Cosimbescu, L. Probing the molecular design of hyper-branched aryl polyesters toward lubricant applications. Sci. Rep. 2016, 6, 18624.

(28) Yamago, S.; Yahata, Y.; Nakanishi, K.; Konishi, S.; Kayahara, E.; Goto, A.; Tsujii, Y. Synthesis of concentrated polymer brushes via surface initiated organotellurium-mediated living radical polymerization (SI-TERP). Macromolecules 2013, 46, 6777-6785.

(29) Meister, T. K.; Riener, K.; Gigler, P.; Stohrer, J.; Herrmann, W. A.; Kuhn, F. E. Platinum catalysis revisited—unraveling principles of catalytic olefin hydrosilylation. ACS Catal. 2016, 6,1274-1284.

(30) Lu, D.; Hossain, M. D.; Jia, Z.; Monteiro, M. J. One-pot orthogonal copper-catalyzed synthesis and self-assembly of L-Lysine-decorated polymeric dendrimers. Macromolecules 2015, 48, 1688-1702.

(31) Zhang, Z.; Hughes, T. C.; Gurr, P. A.; Blencowe, A.; Uddin, H.; Hao. X; Qiao, G. G. The behavior of honeycomb film formation from star polymers with various fluorine content. Polymer 2013, 54, 4446-4454.

(32) Chen, B.; van der Poll, D. G; Jerger, K.; Floyd., W. C.; Fréchet, J. M. J.; Szoka, F. C. Synthesis and properties of star-comb polymers and their doxorubicin conjugates. Bioconjugate Chem. 2011, 22, 617-624.

(33) Ma, Q.; Wooley K. L. The preparation of t-butyl acrylate, methyl acrylate, and styrene block copolymers by atom transfer radical polymerization: precursors to amphiphilic and hydrophilic block copolymers and conversion to complex nanostructured materials. J. Polym. Sci. A: Polym. Chem. 2000, 38, 4805-4820.

(34) Waldron, C.; Anastasaki, A.; McHale, R.; Wilson, P.; Li, Z.; Smith, T.; Haddleton, D. M. Copper-mediated living radical polymerization (SET-LRP) of lipophilic monomers from multifunctional initiators: reducing star-star coupling at high molecular weights and high monomer conversions. Polym. Chem. 2014, 5, 892-898.

(35) Anastasaki, A.; Waldron, C.; Nikolaou, V.; Wilson, P.; McHale, R.; Smith, T.; Haddleton, D. M. Polymerization of long chain [meth]acrylates by Cu(0)-mediated and catalytic chain transfer polymerization (CCTP): high fidelity end group incorporation and modification. Polym. Chem. 2013, 4, 4113-4119.

(36) Kotani, Y.; Kato, M.; Kamigaito, M.; Sawamoto, M. Living radical polymerization of alkyl methacrylates with ruthenium complex and synthesis of their block copolymers. Macromolecules 1996, 29, 6979-6982.

(37) Ando, T.; Kamigaito, M.; Sawamoto, M. Catalytic activities of ruthenium(ii) complexes in transition-metal-mediated living radical polymerization: Polymerization, model reaction, and cyclic voltammetry, Macromolecules 2000, 33, 5825-5829.

(38) Abe, A.; Bloch, D. R. Polymer Handbook. In Polymer Handbook, 4th Ed.; Brandrup, J., Immergut, E. H., Gurlke, E. A., Eds.; Wiley: New York, NY, 1999.

(39) Jukié, A.; Rogosić, M.; Vidović, E.; Janović, Z. Alginate fibers: An overview of the production processes and applications in wound management. Polym. Int 2007, 56, 112-120.

(40) Soldi, R. A.; Oliveira, A. R. S.; Barbosa, R. V.; César-Oliveira, M. A. F. Polymethacrylates: Pour point depressants in diesel oil. Eur. Polym. J. 2007, 43 (8), 3671-3678.

(41) Guo, C.; Zhou, L.; Lv, J. Effects of expandable graphite and modified ammonium polyphosphate on the flame-retardant and mechanical properties of wood flour-polypropylene composites. J. Appl. Polym. Sci. 2013, 21 (7), 449-456.

(42) Ren, J. M.; McKenzie, T. G.; Fu, Q.; Wong, E. H. H.; Xu, J.; An, Z.; Shanmugam, S.; Davis, T. P.; Boyer, C.; Qiao, G. G. Star polymers. Chem. Rev. 2016, 116 (12), 6743-6836.

(43) Heo, J.; Kang, T.; Jang, S. (I.; Hwang, D. S.; Spruell, J. M.; Killops, K. L.; Waite, J. H.; Hawker, C. J. Improved performance of protected catecholic polysiloxanes for bioinspired wet adhesion to surface oxides. J. Am. Chem, Soc. 2012, 134, 20139-20145.

(44) Blackwell, J. M.; Foster, K. L.; Beck, V. H.; Piers, W. E. B(C₆F₅)₃-Catalyzed silation of alcohols: a mild, general method for synthesis of silyl ethers. J. Org. Chem. 1999, 64, 4887-4892.

(45) Hoyle, C. E.; Bowman, C. N. Thiol-ene click chemistry. Angew. Chem. Int. Ed. 2010, 49, 1540-1573.

(46) Chabanne, L.; Pfirrmann, S.; Lunn, D. J.; Manners, I. Controlled thiol-ene post-polymerization reactions on polyferrocenylsilane homopolymers and block copolymers. Polym. Chem. 2013, 4, 2353-2360.

(47) Boott, C. E.; Lunn, D. J.; Manners, I. Versatile and controlled functionalization of polyferrocenylsilane-b-poly vinylsiloxane block copolymers using N-hydroxysuccinimidyl ester strategy. J. Polym. Sci. Part A: Polym. Chem. 2016, 54, 245-252,

(48) Beers, K. L.; Matyjaszewski, K. The atom transfer radical polymerization of lauryl acrylate. J. Macromol. Sci.—Pure Appl. Chem., A 2001, 38 (7), 731-739.

(49) Lee, J. W.; Park, J. K.; Lee, K. H. Thermosensitive permeation from side-chain crystalline ionomers. J. Polym. Sci. Polym. Phys. 2000, 38, 823-830.

(50) Yoo, H.; Yun, B.; Hill, L. J.; Griebel, J. J. Polyoctadecyl methacrylate brushes via surface-initiated atom transfer radical polymerization. Appl. Organometal. Chem. 2013, 27, 678-682.

(51) Jordan, E. F.; Feldeisen, D. W.; Wrigley, N. Side-chain crystallinity. I. heats of fusion and melting transitions on selected homopolymers having long side chains. J. Polym. Sci. Polym. Chem. 1971, 9, 1835-1852.

(52) Rubinstein, M.; Colby, R. H. In Polymer Physics. 1^{st} ed.; Oxford University Press Inc., New York, N.Y., 2003.

(53) R. Pamies, R.; Cifre, J. G. H.; Martínez, M .C. L.; de la Torre, J. G. Determination of intrinsic viscosities of macromolecules and nanoparticles. Comparison of single-point and dilution procedures. Colloid Polym. Sci. 2008, 286, 1223-1231.

(54) Birshtein, T. M.; Zhulina, E. B. Conformations of star-branched macromolecules. Polymer 1984, 25, 1453-1461.

(55) Daoud, M.; Cotton, J. P. Star shaped polymers: A model for the conformation and its concentration dependence, J. Phys. 1982, 43, 531-538.

(56) Taylor, G. I. Stability of a viscous liquid contained between two rotating cylinders. Phil. Trans. R. Soc. B 1923, 223, 289-343.

(57) ASTM D 2270-04, Standard Practice for calculating viscosity index from kinematic viscosity at 40 and 100° C., 2004, 1-6.

(58) Gunier, A.; Fournet, G. Small-angle scattering of X-rays, John Wiley & Sons. Inc., New York, N.Y., 1955.

(59) Dozier, W. D.; Huang, J. S.; Fetters, L. J. Colloidal nature of star polymer dilute and semidilute solutions. Macromolecules, 1991, 24, 2810-2814.

(60) Haas, T. W.; Maxwell, B. Effects of shear stress on the crystallization of linear polyethylene and polybutene-1. Polym. Eng. Sci. 1969, 9, 225-241.

(61) Hawker, C. J.; Farrington, P. J.; Mackay, M. E.; Wooley, K. L.; Fréchet, J. M. J. Molecular ball bearings: The unusual melt viscosity behavior of dendritic macromolecules. J. Am. Chem. Soc., 1995, 117, 4409-4410.

(62) Chen, W.; Zhang, K.; Liu, L.; Chen, J.; Li, Y.; An, L. Conformation and dynamics of individual star in shear flow and comparison with linear and ring polymers. Macromolecules 2017, 50, 1236-1244.

(63) Israelachvili, J.; Min, Y.; Akbulut, M.; Alig, A.; Carver, G.; Greene, W.; Kristiansen, K.; Meyer, E.; Pesika, N.; Rosenberg, K. Recent advances in the surface forces apparatus (SFA) technique. Rep. Prog. Phys 2010, 73, 036601.

(64) Sauerbrey, G. Verwendung von Schwingquarzen zur Wägung dünner Schichten and zur Mikrowägung. Z. Phys. 1959, 155, 206-222.

(65) Zimm, B. H. The scattering of light and the radial distribution function of high polymer solutions. J. Chem. Phys. 1948, 16, 1093.

(66) Carpick, R. W.; Agraït, N; Ogletree, D. F.; Salmeron, M. Measurement of interfacial shear (friction) with an ultrahigh vacuum atomic force microscope. J. Vac. Sci. Technol. B.: Microelectron. Nanometer Struct. Process. Meas. Phenom. 1996, 14, 1289-1295.

(67) Carpick, R. W.; Agraït, N.; Ogletree, D. F.; Salmeron, M. Variation of the Interfacial Shear Strength and Adhesion of a Nanometer-Sized Contact. Langmuir 1996, 12, 3334-3340.

(68) Homola, A. M.; Israelachvili, J. N.; McGuiggan, P. M.; Gee, M. L. Fundamental experimental studies in tribology: The transition from “interfacial” friction of undamaged molecularly smooth surfaces to “normal” friction with wear. Wear 1990, 136, 65-83.

(67) U.S. Pat. No. 4,707,531 by Akihiko Shirahata.

(68) U.S. Pat. No. 9,796,880 by Wills et. al.

### CONCLUSION

This concludes the description of the preferred embodiment of the present invention. The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A composition of matter, comprising:
A star-shaped polymer comprising polymer chains grafted to or from a densely cross-linked silicon-containing hyperbranched core, wherein the densely cross-linked silicon-containing hyperbranched core comprises a silicate functionalized with one or more organic groups.

2. The composition of matter of claim 1, wherein the polymer chains each comprise at least one compound selected from an acrylate and a methacrylate.

3. The composition of matter of claim 1, wherein a number of the polymer chains is in a range of 6-12.

4. The composition of matter of claim 1, wherein each polymer chain includes between 25-200 monomer units.

5. The composition of matter of claim 1, wherein each polymer chain is a copolymer.

6. The composition of matter of claim 5, wherein the copolymer comprises a first alkyl acrylate or alkyl methacrylate having a first pendant C8-C18 alkyl chain and a second alkyl acrylate or alkyl methacrylate having a second pendant C1-C4 alkyl chain.

7. A lubricant comprising the composition of matter of claim 6 combined with a lubrication oil.

8. A lubricant comprising the composition of matter of claim 6 combined with Yubase-4.

9. The lubricant of claim 8 comprising between 1-3 wt % of the composition of matter.

10. The composition of matter of claim 6, wherein the composition of matter performs simultaneously as a bulk viscosity modifier, a friction reducer, and a wear protectant.

11. The composition of matter of claim 5, wherein the copolymer comprises a first alkyl acrylate or alkyl methacrylate having a first pendant C4-C12 alkyl chain and a second alkyl acrylate or alkyl methacrylate having a second pendant C1-C4 alkyl chain.

12. The composition of matter of claim 1, wherein the polymer chains are each a homopolymer.

13. The composition of matter of claim 12, wherein the homopolymer comprises an alkyl acrylate having a pendant C8-C18 alkyl chain.

14. A lubricant comprising the composition of matter of claim 13 combined with a lubrication oil.

15. A lubricant comprising the composition of matter of claim 13 combined with Nexbase-3043.

16. A lubricant comprising the composition of matter of claim 1, wherein the lubricant is petroleum derived and the composition of matter forms coils.

17. The composition of matter of claim 1, wherein the star-shaped polymer has improved shear stability as compared to a linear or a branched polymer.

18. A method of making a silicon-containing hyperbranched star-shaped polymer, comprising: Grafting polymer chains to or from a densely cross-linked silicon-containing hyperbranched polymer core, wherein the densely cross-linked silicon-containing hyperbranched core comprises a silicate functionalized with one or more organic groups.

19. The method of claim 17, wherein the polymer chains each have an arm length, the method further comprising efficiently controlling a ratio of the arm length with respect to a size of the silicon-containing hyperbranched polymer core.

20. The method of claim 18, wherein the polymer chains are attached to the silicon-containing hyperbranched polymer core at arm attachment points, the method further comprising controlling or tuning a density of the arm attachment points depending on a composition of the silicon-containing hyperbranched polymer core.

21. The method of claim 17, wherein the core comprises at least one material selected from −H, vinyl, and OMe on its surface.

22. A composition of matter, comprising:
a star-shaped polymer comprising polymer chains grafted to or from an organic core, wherein the polymer chains each comprise at least one compound selected from an acrylate and a methacrylate.

23. The composition of matter of claim 22, wherein a number of the polymer chains is in a range of 4-16, and the polymer chains each include an alkyl acrylate or alkyl methacrylate having a first pendant C8-C18 alkyl chain and a second alkyl acrylate or alkyl methacrylate having a second pendant C1-C4 alkyl chain.
